(19) United States
(12) Patent Application Publication
(10) Pub. No.: US 2014/0274729 A1
(43) Pub. Date: Sep. 18, 2014

(54) METHODS, COMPOSITIONS AND KITS FOR GENERATION OF STRANDED RNA OR DNA LIBRARIES

(71) Applicant: NuGEN Technologies, Inc., San Carlos, CA (US)

(72) Inventors: Nurith Kurn, Palo Alto, CA (US); Bin Li, Palo Alto, CA (US)

(73) Assignee: NuGEN Technologies, Inc., San Carlos, CA (US)

(21) Appl. No.: 14/030,761

(22) Filed: Sep. 18, 2013

Related U.S. Application Data
(60) Provisional application No. 61/801,510, filed on Mar. 15, 2013.

(51) Int. Cl. B01J 19/00

(52) U.S. Cl. CPC B01J 19/0046
USPC 506/2; 506/26

(57) ABSTRACT

The invention provides methods and compositions, including kits, for the construction of directional nucleic acid libraries. The invention further provides methods and compositions for the amplification and sequencing of directional cDNA libraries.

### CROSS-REFERENCE

This application claims the benefit of U.S. Provisional Application No. 61/801,510 filed Mar. 15, 2013, which application is incorporated herein by reference in its entirety.

### BACKGROUND

Rapid developments in massively parallel sequencing technologies in recent years have enabled whole genome and whole transcriptome sequencing and analysis, opening new approaches to functional genomics. One of these next generation sequencing methods involves direct sequencing of complementary DNA (cDNA) generated from messenger and structural RNAs (RNA-Seq). RNA-Seq can provide several key advantages over traditional sequencing methods. RNA-Seq can allow for high resolution study of all expressed coding and non-coding transcripts, annotating the 5′ and 3′ ends and splice junctions of each transcript, quantification of the relative number of transcripts in each cell can provide a way to measure and characterize RNA splicing by measuring the levels of each splice variant. Similarly, massively parallel sequencing technologies can enable whole genome sequencing or sequencing of multiplex targeted genomic sequences of interests at high resolution.

One potential drawback of performing standard RNA-Seq is the lack of information on the direction of transcription. Standard cDNA libraries constructed for RNA-Seq consist of randomly primed double-stranded cDNA. Non-directional ligation of adaptors containing universal priming sites prior to sequencing can lead to a loss of information as to which strand was present in the original RNA template. Although strand information can be inferred in some cases by subsequent analysis, for example, by using open reading frame (ORF) information in transcripts that encode for a protein or by assessing splice site information in eukaryotic genomes, direct information on the originating strand can be desirable. For example, direct information on which strand was present in the original RNA sample can be used to assign the sense strand to a non-coding RNA, and when resolving overlapping transcripts.

Several methods have recently been developed for strand-specific RNA-Seq. These methods can be divided into two main classes. The first class can utilize distinct adaptors in a known orientation relative to the 5′ and 3′ end of the RNA transcript. The end result can be a cDNA library where the 5′ and 3′ end of the original RNA are flanked by two distinct adaptors. A disadvantage of this method can be that only the ends of the cloned molecules preserve directional information. This situation can be problematic for strand-specific manipulations of long clones, and can lead to loss of directional information when there is fragmentation.

The second class of strand-specific RNA-Seq methods can mark one strand of either the original RNA (for example, by bisulfite treatment) or the transcribed cDNA (for example, by incorporation of modified nucleotides), followed by degradation of the unmarked strand. Strand marking by bisulfite treatment of RNA can be labor intensive and can require alignment of the sequencing reads to reference genomes that have all the cytosine bases converted to thymines on one of the two strands. The analysis can further be complicated due to the fact that base conversion efficiency during bisulfite treatment can be imperfect, i.e. less than 100%.

Strand marking by modification of the second strand of cDNA has become the preferred approach for directional cDNA cloning and sequencing (see e.g., Levin et al., 2010). However, cDNA second strand marking approaches can be insufficient to preserve directionality information when using conventional blunt-end ligation and cDNA library construction strategies with duplex adaptors, where two universal sequencing sites are introduced by two separate adapters.

A major drawback of the current directional transcriptome or genome sequencing can be the requirement of generating first and second strand copies of the desired input strand, or the RNA transcripts, to generate dsDNA prior to fragmentation and attachment of directional or non-directional adaptors, in so far as random second strand synthesis may introduce unknown distortion to the desired library and add complexity to the sequencing library generation.

There is a need for improved and simplified methods for directional cDNA libraries for transcriptome or genome sequencing. The methods, compositions, and kits described herein can fulfill this need.

Provided herein are methods, compositions and kits for the generation of directional sequencing libraries from RNA and dsDNA. The methods, compositions and kits can be used for generation of directional libraries of whole transcriptome, whole genome, targeted or selected transcripts, and can also be applied for the generation of non-directional whole genome sequencing libraries.

### SUMMARY

In one aspect, a method provided herein is the synthesis of complementary DNA strands comprising a non-canonical nucleotide at a defined density to enable fragmentation of the cDNA to a desired size range using an enzyme can that cleave the base portion of the non-canonical nucleotide to generate an abasic site, and further cleavage of the backbone at the abasic site by either enzymatic or chemical or thermal (e.g. heat) means. The DNA fragments produced can comprise a blocked 3′-end. Enzymatic cleavage at the abasic site can produce a 5′-phosphate end, which can be used in a further manipulation for adaptor ligation.

In another aspect, provided herein is a method of priming second strand synthesis using primers designed to anneal to the 3′-ends of all the fragments of the first strand complementary DNA generated as above.

First strand complementary DNA synthesis from RNA templates, such as total RNA, can be performed using various priming schemes. First strand primers useful for the performance of the methods provided herein can be random primers, such as random hexamer, which can be capable of priming at multiple sites on the target RNA. In another embodiment, first strand primers can comprise sequences specific for hybridization to targeted transcripts, or part thereof. In yet another embodiment, the first strand primers can comprise sequences designed to prime on all transcripts other than groups of transcripts which are not desired. For example, the first strand cDNA primers can comprise sequences designed to preferentially prime on all transcripts and not prime on structural RNA, such as all rRNAs.

Regardless of the design of first strand cDNA primers, first strand synthesis can be carried out by reverse transcriptase in reaction mixtures comprising one or more non-canonical nucleotides in a mixture of the corresponding nucleotides, wherein the ratio of a canonical to non-canonical nucleotide can be selected to result in incorporation of the non-canonical nucleotide at a density that will enable fragmentation to generate fragments within a desired fragment size range. The desired size range of the fragmented products can be selected to fit the desired size range of the inserts in the sequencing libraries, so as to accommodate use on various sequencing platforms of choice, or any other downstream manipulations.

Generating single stranded cDNA fragments of the desired size range can be beneficial for a fully automated process for the generation of sequencing and other libraries. In some cases, generation of the first strand cDNA fragments does not require any physical methods of fragmentation such as sonication, which can result in loss of product, and can be useful for generation of library from minute amount of template input, such as single cell analysis or analysis of templates from a very small sample.

The non-canonical nucleotide dUTP can be used in combination with treatment with UNG to generate abasic sites. The fragmentation of the backbone at the abasic site can be carried out in the same reaction mixture by polyamine such as DMED, or combination of enzymes, such as in USER (combination of UNG and endonuclease VIII from NEB). Alternatively, cleavage at the abasic site can be carried out by heating the reaction mixture or by various chemical methods

Methods provided herein do not require second strand synthesis at random sites, as is commonly used in various library preparation methods. Thus the methods provided herein provide reduce bias of selective priming to generate second strand cDNA.

The appending of defined and different sequences at the two ends of the cDNA product can be used for generation of stranded libraries, or libraries, which retain strand specificity. The process of appending a defined sequence to the 3′-end of all the fragments generated by a procedure provided herein can be carried out by priming of all fragments with a partial duplex comprising a single stranded DNA at the 3′-end, wherein the single stranded DNA portion comprises a random sequence. The length of the single strand overhang can vary from at least 6 to at least 7, 8, or nine nucleotides. The single strand overhang can hybridize to the 3′-ends of all the generated fragments and can be extended along the fragments by a DNA polymerase. Various structures of the partial duplex primer are anticipated. Some examples are shown in FIG. 2. The two strands forming the dsDNA portion can be two oligonucleotides which can further be connected by a loop. The loop, or linker, can comprise an oligonucleotide or can comprise a non-nucleotide linker, or combination thereof. It can also comprise nucleotide analogs.

Following elongation of the hybridized single stranded DNA portion of the said partial duplex along the fragments by DNA polymerase, the end of the newly synthesized dsDNA can be repaired to generate a blunt end. The second defined sequence at the other end of the synthesized second strand cDNA can be appended by ligation. Various ligation modes are anticipated. Two examples of the ligation of a second adapter are shown in FIGS. 1A and 1B. A/T dependent ligation is also possible. The product of the process described thus far can be a second strand cDNA with defined ends at the two ends, which can be suitable for further manipulation, such as amplification, addition of desired sequences suitable for analysis on desired platforms, cloning and the like. The added sequences can comprise one or more barcodes, and/or sequences useful for attachment to a solid surface such as the Illumina sequencing flow cells, and the like. The appended sequences can also comprise random sequences useful for marking all fragments with unique sequence which can enable absolute quantification.

A workflow of a process for generation of directional sequencing libraries from RNA using methods and compositions described herein is depicted in FIG. 3.

Also provided herein are methods and compositions for generation of libraries from dsDNA templates, such as genomic DNA templates. The libraries can be useful for whole genome amplification and sequencing and can also be useful for library generation from very small samples, without the need for physical fragmentation of the template dsDNA. As shown in FIG. 4, initiation of complementary strand synthesis can be carried out without primer annealing to denatured dsDNA templates. DNA synthesis along the template DNA strands can be initiated from a nicked site. The use of various nicking enzymes is well known in the art. Nicking enzymes that are either strand specific or not, can be useful for the methods described herein. Random fragmentation of the complementary DNA generated by extension from the nicking site can be achieved by the random insertion of the non-canonical nucleotide, rather than random nicking. Thus, it is possible to use any desired nicking enzyme regardless of the sequence dependence of the chosen nicking enzyme. Enzymes that nick the dsDNA template to generate large distances between the nicking sites can be desired for maximal coverage and random fragmentation by the methods described herein.

The process for generation of libraries from dsDNA templates can comprise further steps which are similar to that described for the generation of stranded cDNA sequencing libraries, as is schematically depicted in FIG. 4.

FIG. 5 describes a process for amplification of fragmented and appended products by Single Primer Isothermal Amplification (SPIA) employing chimeric DNA/RNA primers. The amplification products generated by this process can comprise defined sequences at the 3′- and 5′-portions, thus providing strand retention with respect to the input template.

In one aspect, described herein is a method for generating a directional cDNA library, the method comprising: a) annealing one or more primers to a template RNA; b) extending the one or more primers in the presence of a reaction mixture comprising dATP, dCTP, dGTP, dTTP, and dUTP, wherein the reaction mixture comprises a ratio of dUTP to dTTP, wherein the ratio permits incorporation of dUTP at a desired density, thereby generating a one or more first strand complementary DNAs (cDNAs) comprising dUTP incorporated at a desired density; c) selectively cleaving the one or more first strand cDNAs comprising dUTPs incorporated at a desired density with uracil-N-glycosylase (UNG) and an agent capable of cleaving a phosphodiester backbone at an abasic site created by the UNG, wherein the cleaving generates a plurality of first strand cDNA fragments of a desired size comprising a blocked 3′ end; d) annealing a first adapter comprising a partial duplex and a 3′ overhang to a 3′ end of one or more of the plurality of first strand cDNA fragments comprising a blocked 3′ end, wherein the first adapter comprises a sequence A, and wherein the annealing comprises hybridizing a random sequence at the 3′ overhang to a complementary sequence present at the 3′ end of the one or more of the plurality of first strand cDNA fragments comprising a blocked 3′ end; e) extending the 3′ overhang hybridized to the complementary sequence with a DNA polymerase, wherein one or more double stranded cDNA fragments comprising the sequence A at one end is generated; and f) ligating a second adapter comprising a sequence B to the one or more double stranded cDNA fragments comprising the sequence A at one end, wherein the ligating generates one or more double stranded cDNA fragments comprising the sequence A at one end and the sequence B at an opposite end, thereby generating the directional polynucleotide library. In some embodiments, the one or more primers comprise a random primer. In some embodiments, the one or more primers comprise a sequence specific to a target template RNA or group of RNAs. In some embodiments, the group of RNAs comprises substantially all transcripts. In some embodiments, the group of RNAs does not comprise structural RNA, wherein the structural RNA comprises ribosomal RNA (rRNA). In some embodiments, the method further comprises amplifying the directional cDNA library, thereby generating amplified products. In some embodiments, the method further comprises an additional step of sequencing the amplified products. In some embodiments, the amplification comprises SPIA. In some embodiments, the amplification comprises a use of primers, wherein one or more of the primers comprises one or more barcode sequences. In some embodiments, the sequencing comprises next generation sequencing. In some embodiments, the method further comprises degrading the template RNA following step b.). In some embodiments, the cleaving comprises exposing the template RNA sample to an RNase. In some embodiments, the agent capable of cleaving a phosphodiester backbone comprises an enzyme, chemical agent, and/or heat. In some embodiments, the chemical agent is a polyamine. In some embodiments, the polyamine is N,N-dimethylethylenediamine (DMED). In some embodiments, the enzyme is an endonuclease. In some embodiments, the endonuclease is endonuclease VIII. In some embodiments, the partial duplex comprises a long strand and a short strand, wherein the long strand comprises the sequence A that forms a duplex with the short strand and a 3′ overhang. In some embodiments, the short strand further comprises a block at a 3′ and/or a 5′ end. In some embodiments, the first adapter further comprises a block at a 5′ end of the long strand. In some embodiments, the first adapter comprises a plurality of first adapters, wherein the random sequence on each of the plurality of first adapters is different than the random sequence on another of the plurality of first adapters, and wherein each of the plurality of first adapters comprises the sequence A. In some embodiments, step d) results in substantially all of the plurality of first strand cDNA fragments of a desired size comprising a blocked 3′ end generated in step c) further comprising one of the plurality of first adapters annealed the 3′ end. In some embodiments, the first adapter further comprises a block at a 5′ end of the short strand. In some embodiments, the first adapter further comprises a stem loop, wherein the stem loop links a 5′ end of a long strand of the partial duplex with a 3′ end of a short strand of the partial duplex, and wherein the long strand comprises the sequence A and the 3′ overhang. TIn some embodiments, the 3′ overhang comprises at least 6, 7, 8, or 9 nucleotides. In some embodiments, the second adapter comprises a partial duplex, wherein the partial duplex comprises a long strand hybridized to a short strand, wherein the long strand comprises the sequence B and an overhang. TIn some embodiments, the long strand comprises the sequence B and a 3′ overhang, and wherein the short strand comprises a block at a 3′ end. In some embodiments, the ligating generates the one or more double stranded cDNA fragments comprising the sequence A at one end and the sequence B at an opposite end, wherein the sequence A is at a 5′ end on one end and the sequence B is at a 3′ end on the opposite end. In some embodiments, the long strand comprises the sequence B and a 5′ overhang, and wherein the short strand comprises a block at a 5′ end. In some embodiments, the ligating generates the one or more double stranded cDNA fragments comprising the sequence A at one end and the sequence B at an opposite end, wherein the sequence A is at a 5′ end on one end and the sequence B is at a 5′ end on the opposite end. In some embodiments, a 3′ end of the opposite end is extended using the sequence B as a template, thereby generating one or more double stranded cDNA fragments comprising the sequence A at a 5′ end on one end and a sequence complementary to the sequence B, B′, at a 3′ end on the opposite end. In some embodiments, the ligating comprises blunt end ligation, wherein the one or more double stranded cDNA fragments comprising the sequence A at one end generated in step e) are end repaired prior to step f). In some embodiments, the first and/or second adapter further comprises one or more barcodes.

In one aspect, described herein is a method for whole transcriptome directional sequencing, the method comprising: a) annealing one or more primers to a template RNA; b) extending the primer in the presence of a reaction mixture comprising dATP, dCTP, dGTP, dTTP, and dUTP, wherein the reaction mixture comprises a ratio of dUTP to dTTP, wherein the ratio permits incorporation of dUTP at a desired density, thereby generating one or more first strand complementary DNAs (cDNAs) comprising dUTP incorporated at a desired density; c) selectively cleaving the one or more first strand cDNAs comprising dUTPs incorporated at a desired density with uracil-N-glycosylase (UNG) and an agent capable of cleaving a phosphodiester backbone at an abasic site created by the UNG, wherein the cleaving generates a plurality of first strand cDNA fragments of a desired size comprising a blocked 3′ end; d) annealing a first adapter comprising a partial duplex and a 3′ overhang to a 3′ end of one or more of the plurality of first strand cDNA fragments comprising a blocked 3′ end, wherein the first adapter comprises a sequence A, and wherein the annealing comprises hybridizing a random sequence at the 3′ overhang to a complementary sequence present at the 3′ end of the one or more of the plurality of first strand cDNA fragments comprising a blocked 3′ end; e) extending the 3′ overhang hybridized to the complementary sequence with a DNA polymerase, wherein one or more double stranded cDNA fragments comprising the sequence A at one end is generated; f) ligating a second adapter comprising a sequence B to the one or more double stranded cDNA fragments comprising the sequence A at one end, wherein the ligating generates one or more double stranded cDNA fragments comprising the sequence A at one end and the sequence B at an opposite end thereby generating a directional cDNA library; and g) amplifying and/or sequencing the directional cDNA library. 5In some embodiments, the one or more primers comprise a random primer. In some embodiments, the one or more primers comprise a sequence specific to a target template RNA or group of RNAs. In some embodiments, the group of RNAs comprises substantially all transcripts. In some embodiments, the group of RNAs does not comprise structural RNA, wherein the structural RNA comprises ribosomal RNA (rRNA). In some embodiments, the amplification comprises SPIA. In some embodiments, the amplification comprises a use of primers, wherein one or more of the primers comprises a barcode sequence. In some embodiments, the sequencing comprises next generation sequencing. In some embodiments, the method further comprises degrading the template RNA following step b.). In some embodiments, the cleaving comprises exposing the template RNA sample to an RNase. In some embodiments, the agent capable of cleaving a phosphodiester backbone comprises an enzyme, chemical agent, and/or heat. In some embodiments, the chemical agent is a polyamine. In some embodiments, the polyamine is N,N-dimethylethylenediamine (DMED). In some embodiments, the enzyme is an endonuclease. In some embodiments, the endonuclease is endonuclease VIII. In some embodiments, the partial duplex comprises a long strand and a short strand, wherein the long strand comprises the sequence A that forms a duplex with the short strand and a 3′ overhang. In some embodiments, the short strand further comprises a block at a 3′ and/or a 5′ end. In some embodiments, the first adapter further comprises a block at a 5′ end of the long strand. In some embodiments, the first adapter comprises a plurality of first adapters, wherein the random sequence on each of the plurality of first adapters is different than the random sequence on another of the plurality of first adapters, and wherein each of the plurality of first adapters comprises the sequence A. In some embodiments, step d) results in substantially all of the plurality of first strand cDNA fragments of a desired size comprising a blocked 3′ end generated in step c) further comprising one of the plurality of first adapters annealed the 3′ end. In some embodiments, the first adapter further comprises a block at a 5′ end of the short strand. In some embodiments, the first adapter further comprises a stem loop, wherein the stem loop links a 5′ end of a long strand of the partial duplex with a 3′ end of a short strand of the partial duplex, and wherein the long strand comprises the sequence A and the 3′ overhang. In some embodiments, the 3′ overhang comprises at least 6, 7, 8, or 9 nucleotides. In some embodiments, the second adapter comprises a partial duplex, wherein the partial duplex comprises a long strand hybridized to a short strand, wherein the long strand comprises the sequence B and an overhang. In some embodiments, the long strand comprises the sequence B and a 3′ overhang, and wherein the short strand comprises a block at a 3′ end. In some embodiments, the ligating generates the one or more double stranded cDNA fragments comprising the sequence A at one end and the sequence B at an opposite end, wherein the sequence A is at a 5′ end on one end and the sequence B is at a 3′ end on the opposite end. In some embodiments, the long strand comprises the sequence B and a 5′ overhang, and wherein the short strand comprises a block at a 5′ end. In some embodiments, the ligating generates the one or more double stranded cDNA fragments comprising the sequence A at one end and the sequence B at an opposite end, wherein the sequence A is at a 5′ end on one end and the sequence B is at a 5′ end on the opposite end. In some embodiments, a 3′ end of the opposite end is extended using the sequence B as a template, thereby generating one or more double stranded cDNA fragments comprising the sequence A at a 5′ end on one end and a sequence complementary to the sequence B, B′, at a 3′ end on the opposite end. In some embodiments, the ligating comprises blunt end ligation, wherein the one or more double stranded cDNA fragments comprising the sequence A at one end generated in step e) are end repaired prior to step f). In some embodiments, the first and/or second adapter further comprises one or more barcodes.

In one aspect, described herein is a method for generating a directional cDNA library, the method comprising: a) treating a template dsDNA with a nicking enzyme, wherein the treating generates one or more breaks in a phosphodiester backbone of one strand of the template dsDNA, wherein the break produces one or more 3′ hydroxyls in the one strand; b) extending the one or more 3′ hydroxyls, wherein the extending is performed in the presence of a reaction mixture comprising dATP, dCTP, dGTP, dTTP, and dUTP, wherein the reaction mixture comprises a ratio of dUTP to dTTP, wherein the ratio permits incorporation of dUTP at a desired density, thereby generating one or more first strand complementary DNAs (cDNAs) comprising dUTP incorporated at a desired density; c) selectively cleaving the one or more first strand cDNAs comprising dUTPs incorporated at a desired density with uracil-N-glycosylase (UNG) and an agent capable of cleaving a phosphodiester backbone at an abasic site created by the UNG, wherein the cleaving generates a plurality of first strand cDNA fragments of a desired size comprising a blocked 3′ end; d) annealing a first adapter comprising a partial duplex and a 3′ overhang to a 3′ end of one or more of the plurality of first strand cDNA fragments comprising a blocked 3′ end, wherein the first adapter comprises a sequence A, and wherein the annealing comprises hybridizing a random sequence at the 3′ overhang to a complementary sequence present at the 3′ end of the one or more of the plurality of first strand cDNA fragments comprising a blocked 3′ end; e) extending the 3′ overhang hybridized to the complementary sequence with a DNA polymerase, wherein one or more double stranded cDNA fragments comprising the sequence A at one end is generated; and f) ligating a second adapter comprising a sequence B to the one or more double stranded cDNA fragments comprising the sequence A at one end, wherein the ligating generates one or more double stranded cDNA fragments comprising the sequence A at one end and the sequence B at an opposite end thereby generating a directional cDNA library. In some embodiments, the method further comprises amplifying the directional cDNA library, thereby generating amplified products. In some embodiments, the method further comprises an additional step of sequencing the amplified products. In some embodiments, the amplification comprises SPIA. In some embodiments, the amplification comprises a use of primers, wherein one or more of the primers comprises one or more barcode sequences. In some embodiments, the sequencing comprises next generation sequencing. In some embodiments, the nicking enzyme comprises a strand specific nicking enzyme. In some embodiments, the extending the one or more 3′ hydroxyls in step b) is performed with a DNA polymerase comprising strand displacement activity. In some embodiments, the agent capable of cleaving a phosphodiester backbone comprises an enzyme, chemical agent, and/or heat. In some embodiments, the chemical agent is a polyamine. In some embodiments, the polyamine is N,N-dimethylethylenediamine (DMED). In some embodiments, the enzyme is an endonuclease. In some embodiments, the endonuclease is endonuclease VIII. In some embodiments, the partial duplex comprises a long strand and a short strand, wherein the long strand comprises the sequence A that forms a duplex with the short strand and a 3′ overhang. In some embodiments, the short strand further comprises a block at a 3′ and/or a 5′ end. In some embodiments, the first adapter further comprises a block at a 5′ end of the long strand. In some embodiments, the first adapter comprises a plurality of first adapters, wherein the random sequence on each of the plurality of first adapters is different than the random sequence on another of the plurality of first adapters, and wherein each of the plurality of first adapters comprises the sequence A. In some embodiments, step d) results in substantially all of the plurality of first strand cDNA fragments of a desired size comprising a blocked 3′ end generated in step c) further comprising one of the plurality of first adapters annealed the 3′ end. In some embodiments, the first adapter further comprises a block at a 5′ end of the short strand. In some embodiments, the first adapter further comprises a stem loop, wherein the stem loop links a 5′ end of a long strand of the partial duplex with a 3′ end of a short strand of the partial duplex, and wherein the long strand comprises the sequence A and the 3′ overhang. In some embodiments, the 3′ overhang comprises at least 6, 7, 8, or 9 nucleotides. In some embodiments, the second adapter comprises a partial duplex, wherein the partial duplex comprises a long strand hybridized to a short strand, wherein the long strand comprises the sequence B and an overhang. In some embodiments, the long strand comprises the sequence B and a 3′ overhang, and wherein the short strand comprises a block at a 3′ end. TIn some embodiments, the ligating generates the one or more double stranded cDNA fragments comprising the sequence A at one end and the sequence B at an opposite end, wherein the sequence A is at a 5′ end on one end and the sequence B is at a 3′ end on the opposite end. In some embodiments, the long strand comprises the sequence B and a 5′ overhang, and wherein the short strand comprises a block at a 5′ end. In some embodiments, the ligating generates the one or more double stranded cDNA fragments comprising the sequence A at one end and the sequence B at an opposite end, wherein the sequence A is at a 5′ end on one end and the sequence B is at a 5′ end on the opposite end. In some embodiments, a 3′ end of the opposite end is extended using the sequence B as a template, thereby generating one or more double stranded cDNA fragments comprising the sequence A at a 5′ end on one end and a sequence complementary to the sequence B, B′, at a 3′ end on the opposite end. In some embodiments, the ligating comprises blunt end ligation, wherein the one or more double stranded cDNA fragments comprising the sequence A at one end generated in step e) are end repaired prior to step f). In some embodiments, the first and/or second adapter further comprises one or more barcodes.

In one aspect, described herein is a method for whole genome sequencing, the method comprising: a) treating genomic DNA with a nicking enzyme, wherein the treating generates one or more breaks in a phosphodiester backbone of a one strand of the genomic DNA, wherein the breaks produce one or more 3′ hydroxyls in the one strand; b) extending the one or more 3′ hydroxyls, wherein the extending is performed in the presence of a reaction mixture comprising dATP, dCTP, dGTP, dTTP, and dUTP, wherein the reaction mixture comprises a ratio of dUTP to dTTP, wherein the ratio permits incorporation of dUTP at a desired density, thereby generating one or more first strand complementary DNAs (cDNAs) comprising dUTP incorporated at a defined frequency; c) selectively cleaving the one or more first strand cDNA comprising dUTPs incorporated at a desired density with uracil-N-glycosylase (UNG) and an agent capable of cleaving a phosphodiester backbone at an abasic site created by the UNG, wherein the cleaving generates a plurality of first strand cDNA fragments of a desired size comprising a blocked 3′ end; d) annealing a first adapter comprising a partial duplex and a 3′ overhang to a 3′ end of one or more of the plurality of first strand cDNA fragments comprising a blocked 3′ end, wherein the first adapter comprises a sequence A, and wherein the annealing comprises hybridizing a random sequence at the 3′ overhang to a complementary sequence present at the 3′ end of the one or more of the plurality of first strand cDNA fragments comprising a blocked 3′ end; e) extending the 3′ overhang hybridized to the complementary sequence with a DNA polymerase, wherein one or more double stranded cDNA fragments comprising the sequence A at one end is generated; f) ligating a second adapter comprising a sequence B to the one or more double stranded cDNA fragments comprising the sequence A at one end, wherein the ligating generates one or more double stranded cDNA fragments comprising the sequence A at one end and the sequence B at an opposite end thereby generating a directional cDNA library; and g) amplifying and/or sequencing the directional cDNA library. In some embodiments, the amplification comprises SPIA. In some embodiments, the amplification comprises a use of primers, wherein one or more of the primers comprises a barcode sequence. In some embodiments, the sequencing comprises next generation sequencing. In some embodiments, the nicking enzyme comprises a strand specific nicking enzyme. In some embodiments, the extending the one or more 3′ hydroxyls in step b) is performed with a DNA polymerase comprising strand displacement activity. In some embodiments, the agent capable of cleaving a phosphodiester backbone comprises an enzyme, chemical agent, and/or heat. In some embodiments, the chemical agent is a polyamine. In some embodiments, the polyamine is N,N-dimethylethylenediamine (DMED). In some embodiments, the enzyme is an endonuclease. In some embodiments, the endonuclease is endonuclease VIII. In some embodiments, the partial duplex comprises a long strand and a short strand, wherein the long strand comprises the sequence A that forms a duplex with the short strand and a 3′ overhang. In some embodiments, the short strand further comprises a block at a 3′ and/or a 5′ end. In some embodiments, the first adapter further comprises a block at a 5′ end of the long strand. In some embodiments, the first adapter comprises a plurality of first adapters, wherein the random sequence on each of the plurality of first adapters is different than the random sequence on another of the plurality of first adapters, and wherein each of the plurality of first adapters comprises the sequence A. In some embodiments, step d) results in substantially all of the plurality of first strand cDNA fragments of a desired size comprising a blocked 3′ end generated in step c) further comprising one of the plurality of first adapters annealed the 3′ end. In some embodiments, the first adapter further comprises a block at a 5′ end of the short strand. In some embodiments, the first adapter further comprises a stem loop, wherein the stem loop links a 5′ end of a long strand of the partial duplex with a 3′ end of a short strand of the partial duplex, and wherein the long strand comprises the sequence A and the 3′ overhang. In some embodiments, the 3′ overhang comprises at least 6, 7, 8, or 9 nucleotides. In some embodiments, the second adapter comprises a partial duplex, wherein the partial duplex comprises a long strand hybridized to a short strand, wherein the long strand comprises the sequence B and an overhang. In some embodiments, the long strand comprises the sequence B and a 3′ overhang, and wherein the short strand comprises a block at a 3′ end. In some embodiments, the ligating generates the one or more double stranded cDNA fragments comprising the sequence A at one end and the sequence B at an opposite end, wherein the sequence A is at a 5′ end on one end and the sequence B is at a 3′ end on the opposite end. In some embodiments, the long strand comprises the sequence B and a 5′ overhang, and wherein the short strand comprises a block at a 5′ end. In some embodiments, the ligating generates the one or more double stranded cDNA fragments comprising the sequence A at one end and the sequence B at an opposite end, wherein the sequence A is at a 5′ end on one end and the sequence B is at a 5′ end on the opposite end. In some embodiments, a 3′ end of the opposite end is extended using the sequence B as a template, thereby generating one or more double stranded cDNA fragments comprising the sequence A at a 5′ end on one end and a sequence complementary to the sequence B, B′, at a 3′ end on the opposite end. In some embodiments, the ligating comprises blunt end ligation, wherein the one or more double stranded cDNA fragments comprising the sequence A at one end generated in step e) are end repaired prior to step f). In some embodiments, the first and/or second adapter further comprises one or more barcodes.

In one aspect, described herein is a method for generating a directional polynucleotide library, the method comprising: a) reverse transcribing a template RNA in the presence of one or more primers, reverse transcriptase, and a reaction mixture comprising a non-canonical nucleotide, wherein the reaction mixture comprises a ratio of the non-canonical nucleotide suitable to permit incorporation of the non-canonical nucleotide at a desired density, thereby generating a one or more first strand complementary DNAs (cDNAs) comprising the non-canonical nucleotide incorporated at a desired density; b) selectively cleaving the one or more first strand cDNAs comprising the non-canonical nucleotide incorporated at a desired density with a cleavage agent, wherein the cleaving with the cleavage agent generates a plurality of first strand cDNA fragments of a desired size comprising a blocked 3′ end; c) annealing a first adapter comprising a partial duplex and a 3′ overhang to a 3′ end of one or more of the plurality of first strand cDNA fragments comprising a blocked 3′ end, wherein the first adapter comprises a sequence A, and wherein the annealing comprises hybridizing a random sequence at the 3′ overhang to a complementary sequence present at the 3′ end of the one or more of the plurality of first strand cDNA fragments comprising a blocked 3′ end; d) extending the 3′ overhang hybridized to the complementary sequence with a DNA polymerase, wherein one or more double stranded cDNA fragments comprising the sequence A at one end is generated; and e) ligating a second adapter comprising a sequence B to the one or more double stranded cDNA fragments comprising the sequence A at one end, wherein the ligating generates one or more double stranded cDNA fragments comprising the sequence A at one end and the sequence B at an opposite end thereby generating the directional polynucleotide library. In some embodiments, the template RNA comprises mRNA. In some embodiments, the one or more primers comprise a random primer. In some embodiments, the one or more primers comprise a sequence specific to a target RNA or group of RNAs. In some embodiments, the group of RNAs comprises substantially all transcripts. In some embodiments, the group of RNAs does not comprise structural RNA, wherein the structural RNA comprises ribosomal RNA (rRNA). In some embodiments, the method further comprises degrading the template RNA following step a). In some embodiments, the non-canonical dNTP comprises dUTP. In some embodiments, the cleavage agent comprises a glycosylase and a polyamine, heat, or an enzyme. In some embodiments, the glycoslyase is uracil-N-glycosylase (UNG). In some embodiments, the polyamine is N,N-dimethylethylenediamine (DMED). In some embodiments, the enzyme comprises an endonuclease. In some embodiments, the endonuclease is endonuclease VIII. In some embodiments, the first adapter comprises a plurality of first adapters, wherein the random sequence on each of the plurality of first adapters is different than the random sequence on another of the plurality of first adapters, and wherein each of the plurality of first adapters comprises the sequence A. In some embodiments, the annealing results in substantially all of the plurality of first strand cDNA fragments of a desired size comprising a blocked 3′ end further comprising one of the plurality of first adapters annealed the 3′ end. In some embodiments, the partial duplex comprises a long strand and a short strand, wherein the long strand comprises the sequence A that forms a duplex with the short strand and a 3′ overhang. In some embodiments, the short strand further comprises a block at a 3′ and/or a 5′ end. In some embodiments, the first adapter further comprises a stem loop, wherein the stem loop links a 5′ end of a long strand of the partial duplex with a 3′ end of a short strand of the partial duplex, and wherein the long strand comprises the sequence A and the 3′ overhang. In some embodiments, the first adapter further comprises a block at a 5′ end of the long strand. In some embodiments, the first adapter further comprises a block at a 5′ end of the short strand. In some embodiments, the 3′ overhang comprises at least 6, 7, 8, or 9 nucleotides. In some embodiments, the second adapter comprises a duplex, partial duplex, or single strand comprising a duplex portion connected by a stem loop. In some embodiments, the first and/or second adapter further comprises one or more barcodes. In some embodiments, the second adapter comprises a partial duplex, wherein the partial duplex comprises a long strand hybridized to a short strand, wherein the long strand comprises the sequence B and an overhang. In some embodiments, the long strand comprises the sequence B and a 3′ overhang, and wherein the short strand comprises a block at a 3′ end. In some embodiments, the ligating generates the one or more double stranded cDNA fragments comprising the sequence A at one end and the sequence B at an opposite end, wherein the sequence A is at a 5′ end on one end and the sequence B is at a 3′ end on the opposite end. In some embodiments, the long strand comprises the sequence B and a 5′ overhang, and wherein the short strand comprises a block at a 5′ end. In some embodiments, the ligating generates the one or more double stranded cDNA fragments comprising the sequence A at one end and the sequence B at an opposite end, wherein the sequence A is at a 5′ end on one end and the sequence B is at a 5′ end on the opposite end. In some embodiments, a 3′ end of the opposite end is extended using the sequence B as a template, thereby generating one or more double stranded cDNA fragments comprising the sequence A at a 5′ end on one end and a sequence complementary to the sequence B, B′, at a 3′ end on the opposite end. In some embodiments, the method further comprises amplifying the directional cDNA library, thereby generating amplified products. further comprising an additional step of sequencing the amplified products. In some embodiments, the amplification comprises SPIA. In some embodiments, the amplification comprises a use of primers, wherein one or more of the primers comprises a barcode sequence. In some embodiments, the sequencing comprises next generation sequencing. In some embodiments, the ligating comprises blunt end ligation, wherein the one or more double stranded cDNA fragments comprising the sequence A at one end generated in step e) are end repaired prior to step f).

In one aspect, described herein is a method for generating a directional polynucleotide library, the method comprising: a) treating a template DNA with a nicking enzyme, wherein the treating generates one or more breaks in a phosphodiester backbone of one strand of the template DNA, wherein the one or more breaks produce one or more 3′ hydroxyls in the one strand; b) extending the one or more 3′ hydroxyls, wherein the extending is performed in the presence of a reaction mixture comprising a non-canonical nucleotide, wherein the reaction mixture comprises a ratio of the non-canonical nucleotide suitable to permit incorporation of the non-canonical nucleotide at a desired density, thereby generating a one or more first strand complementary DNAs (cDNAs) comprising the non-canonical nucleotide incorporated at a desired density; c) selectively cleaving the one or more first strand cDNAs comprising the non-canonical nucleotide incorporated at a desired density with a cleavage agent, wherein the cleaving with the cleavage agent generates a plurality of first strand cDNA fragments of a desired size comprising a blocked 3′ end; d) annealing a first adapter comprising a partial duplex and a 3′ overhang to a 3′ end of one or more of the plurality of first strand cDNA fragments comprising a blocked 3′ end, wherein the first adapter comprises a sequence A, and wherein the annealing comprises hybridizing a random sequence at the 3′ overhang to a complementary sequence present at the 3′ end of the one or more of the plurality of first strand cDNA fragments comprising a blocked 3′ end; e) extending the 3′ overhang hybridized to the complementary sequence with a DNA polymerase, wherein one or more double stranded cDNA fragments comprising the sequence A at one end is generated; and f) ligating a second adapter comprising a sequence B to the one or more double stranded cDNA fragments comprising the sequence A at one end, wherein the ligating generates one or more double stranded cDNA fragments comprising the sequence A at one end and the sequence B at an opposite end thereby generating the directional polynucleotide library. In some embodiments, the template DNA comprises double stranded DNA (dsDNA). In some embodiments, the template DNA comprises genomic DNA. In some embodiments, the nicking enzyme comprises a strand specific nicking enzyme. In some embodiments, the extending the 3′ hydroxyl in step b) is performed with a DNA polymerase comprising strand displacement activity. In some embodiments, the non-canonical dNTP comprises dUTP. In some embodiments, the cleavage agent comprises a glycosylase and a polyamine, heat, or an enzyme. In some embodiments, the glycoslyase is uracil-N-glycosylase (UNG). In some embodiments, the polyamine is N,N-dimethylethylenediamine (DMED). In some embodiments, the enzyme comprises an endonuclease. In some embodiments, the endonuclease is endonuclease VIII. In some embodiments, the first adapter comprises a plurality of first adapters, wherein the random sequence on each of the plurality of first adapters is different than the random sequence on another of the plurality of first adapters, and wherein each of the plurality of first adapters comprises the sequence A. In some embodiments, the annealing results in substantially all of the plurality of first strand cDNA fragments of a desired size comprising a blocked 3′ end further comprising one of the plurality of first adapters annealed the 3′ end. In some embodiments, the partial duplex comprises a long strand and a short strand, wherein the long strand comprises the sequence A that forms a duplex with the short strand and a 3′ overhang. In some embodiments, the short strand further comprises a block at a 3′ and/or a 5′ end. In some embodiments, the first adapter further comprises a stem loop, wherein the stem loop links a 5′ end of a long strand of the partial duplex with a 3′ end of a short strand of the partial duplex, and wherein the long strand comprises the sequence A and the 3′ overhang. In some embodiments, the first adapter further comprises a block at a 5′ end of the long strand. In some embodiments, the first adapter further comprises a block at a 5′ end of the short strand. In some embodiments, the 3′ overhang comprises at least 6, 7, 8, or 9 nucleotides. In some embodiments, the second adapter comprises a duplex, partial duplex, or single strand comprising a duplex portion connected by a stem loop. In some embodiments, the first and/or second adapter further comprises one or more barcodes. In some embodiments, the second adapter comprises a partial duplex, wherein the partial duplex comprises a long strand hybridized to a short strand, wherein the long strand comprises the sequence B and an overhang. In some embodiments, the long strand comprises the sequence B and a 3′ overhang, and wherein the short strand comprises a block at a 3′ end. In some embodiments, the ligating generates the one or more double stranded cDNA fragments comprising the sequence A at one end and the sequence B at an opposite end, wherein the sequence A is at a 5′ end on one end and the sequence B is at a 3′ end on the opposite end. In some embodiments, the long strand comprises the sequence B and a 5′ overhang, and wherein the short strand comprises a block at a 5′ end. In some embodiments, the ligating generates the one or more double stranded cDNA fragments comprising the sequence A at one end and the sequence B at an opposite end, wherein the sequence A is at a 5′ end on one end and the sequence B is at a 5′ end on the opposite end. In some embodiments, a 3′ end of the opposite end is extended using the sequence B as a template, thereby generating one or more double stranded cDNA fragments comprising the sequence A at a 5′ end on one end and a sequence complementary to the sequence B, B′, at a 3′ end on the opposite end. In some embodiments, the method further comprises amplifying the directional cDNA library, thereby generating amplified products. In some embodiments, the method further comprises an additional step of sequencing the amplified products. In some embodiments, the amplification comprises SPIA. In some embodiments, the amplification comprises a use of primers, wherein one or more of the primers comprise a barcode sequence. In some embodiments, the sequencing comprises next generation sequencing. In some embodiments, the ligating comprises blunt end ligation, wherein the one or more double stranded cDNA fragments comprising the sequence A at one end generated in step e) are end repaired prior to step f).

In one aspect, described herein is a method for generating a directional polynucleotide library, the method comprising: a) chemically cleaving a phosphodiester backbone of one or more polynucleotides comprising one or more abasic sites at the one or more abasic sites, whereby one or more polynucleotides within a desired size range and comprising a blocked 3′ end are generated; b) appending a first adapter to a 3′ end of the one or more polynucleotides comprising a blocked 3′ end, wherein the first adapter comprises a sequence A, wherein the sequence A is non-hybridizable to the one or more polynucleotides comprising a blocked 3′ end; c) extending a 3′ end of the first adapter appended to the 3′ end of the one or more polynucleotides comprising a blocked 3′ end using the one or more polynucleotides comprising a blocked 3′ end as template, wherein one or more double stranded polynucleotides comprising the sequence A at one end is generated; and d) appending a second adapter comprising a sequence B to the one or more double stranded polynucleotide comprising the sequence A at one end, wherein the sequence B is different than the sequence A and the appending generates one or more double stranded polynucleotides comprising the sequence A at one end and the sequence B at an opposite end, thereby generating the directional polynucleotide library. In some embodiments, the phosphodiester backbone is cleaved with a polyamine to generate one or more polynucleotides within a desired size range and with a blocked 3′ end. In some embodiments, the polyamine is N,N′-dimethylethylenediamine (DMED). In some embodiments, the one or more polynucleotides comprising one or more abasic sites are generated by cleaving a base portion of a non-canonical nucleotide in one or more polynucleotides with an enzyme capable of cleaving the base portion of the non-canonical nucleotide, whereby an abasic site is generated. In some embodiments, the non-canonical nucleotide is selected from the group consisting of dUTP, dITP, and 5-OH-Me-dCTP. In some embodiments, the enzyme capable of cleaving the base portion of the non-canonical nucleotide is an N-glycosylase. In some embodiments, the N-glycosylase is selected from the group consisting of Uracil N-Glycosylase (UNG), hypoxanthine-N-Glycosylase, and hydroxy-methyl cytosine-N-glycosylase. In some embodiments, the non-canonical nucleotide is dUTP and the enzyme capable of cleaving the base portion of the non-canonical nucleotide is UNG. In some embodiments, the non-canonical nucleotide is dUTP, the enzyme capable of cleaving the base portion of the non-canonical nucleotide is UNG, and the phosphodiester backbone is cleaved with DMED. In some embodiments, the one or more polynucleotides comprising one or more non-canonical nucleotides are synthesized in the presence of two or more different non-canonical nucleotides, whereby one or more polynucleotides comprising two or more different non-canonical nucleotides are synthesized. In some embodiments, the one or more polynucleotides comprising one or more abasic sites are synthesized from a template nucleic acid comprising DNA or RNA. In some embodiments, the template nucleic acid is selected from the group consisting of mRNA, cDNA, and genomic DNA. TIn some embodiments, the one or more polynucleotides comprising one or more abasic sites are single stranded or double stranded. In some embodiments, the one or more polynucleotides comprising one or more abasic sites are synthesized by an amplification method selected from the group consisting of polymerase chain reaction (PCR), strand displacement amplification (SDA), multiple displacement amplification (MDA), rolling circle amplification (RCA), single primer isothermal amplification (SPIA), and Ribo-SPIA. In some embodiments, the one or more polynucleotide comprising one or more abasic sites are synthesized by a method selected from the group consisting of reverse transcription, primer extension, limited primer extension, replication, and nick translation. In some embodiments, the first adapter further comprises a partial duplex and a 3′ overhang. In some embodiments, the first adapter comprises a plurality of first adapters, wherein the random sequence on each of the plurality of first adapters is different than the random sequence on another of the plurality of first adapters, and wherein each of the plurality of first adapters comprises the sequence A. In some embodiments, the annealing results in substantially all of the plurality of first strand cDNA fragments of a desired size comprising a blocked 3′ end further comprising one of the plurality of first adapters annealed the 3′ end. In some embodiments, the appending comprises annealing the 3′ overhang of the first adapter to the 3′ end of the polynucleotide comprising a blocked 3′ end, wherein the annealing comprises hybridizing a random sequence at the 3′ overhang to a complementary sequence present at the 3′ end of the polynucleotide comprising a blocked 3′ end. In some embodiments, the partial duplex comprises a long strand and a short strand, wherein the long strand comprises the sequence A that forms a duplex with the short strand and the 3′ overhang. In some embodiments, the short strand further comprises a block at a 3′ and/or a 5′ end of the short strand. In some embodiments, the first adapter further comprises a stem loop, wherein the stem loop links a 5′ end of a long strand of the partial duplex with a 3′ end of a short strand of the partial duplex, and wherein the long strand comprises the sequence A and the 3′ overhang. In some embodiments, the first adapter further comprises a block at a 5′ end of the long strand. In some embodiments, the first adapter further comprises a block at a 5′ end of the short strand. In some embodiments, the 3′ overhang comprises at least 6, 7, 8, or 9 nucleotides. In some embodiments, step d) comprises ligating the second adapter. In some embodiments, the ligating comprises blunt end ligation. In some embodiments, the polynucleotide comprising the sequence A at one end generated in step c) is end repaired prior to step d). In some embodiments, the second adapter comprises a duplex, partial duplex, or single strand comprising a duplex portion connected by a stem loop. In some embodiments, the first and/or second adapter further comprises one or more barcodes. In some embodiments, the second adapter comprises a partial duplex, wherein the partial duplex comprises a long strand hybridized to a short strand, wherein the long strand comprises the sequence B and an overhang. In some embodiments, the long strand comprises the sequence B and a 3′ overhang, and wherein the short strand comprises a block at a 3′ end. In some embodiments, the appending of the second adapter generates the one or more double stranded polynucleotides comprising the sequence A at one end and the sequence B at an opposite end, wherein the sequence A is at a 5′ end on one end and the sequence B is at a 3′ end on the opposite end. In some embodiments, the long strand comprises the sequence B and a 5′ overhang, and wherein the short strand comprises a block at a 5′ end. In some embodiments, the appending of the second adapter generates the one or more double stranded polynucleotides comprising the sequence A at one end and the sequence B at an opposite end, wherein the sequence A is at a 5′ end on one end and the sequence B is at a 5′ end on the opposite end. In some embodiments, a 3′ end of the opposite end is extended using the sequence B as a template, thereby generating one or more double stranded polynucleotides comprising the sequence A at a 5′ end on one end and a sequence complementary to the sequence B, B′, at a 3′ end on the opposite end. In some embodiments, the method further comprises amplifying the directional cDNA library, thereby generating amplified products. In some embodiments, the method further comprises an additional step of sequencing the amplified products. In some embodiments, the amplification comprises SPIA. In some embodiments, the amplification comprises a use of primers, wherein one or more of the primers comprises a barcode sequence. In some embodiments, the sequencing comprises next generation sequencing.

In one aspect, described herein is a method for generating a directional polynucleotide library, the method comprising: a) synthesizing one or more polynucleotides from a template nucleic acid in the presence of a non-canonical nucleotide, whereby one or more polynucleotides comprising the non-canonical nucleotide are generated; b) cleaving a base portion of the non-canonical nucleotide from the one or more synthesized polynucleotides with an enzyme capable of cleaving the base portion of the non-canonical nucleotide, whereby an abasic site is generated; c) cleaving a phosphodiester backbone of the one or more polynucleotides comprising the abasic site at the abasic site, whereby one or more polynucleotides within a desired size range comprising a blocked 3′ end are generated; d) appending a first adapter to a 3′ end of the one or more polynucleotides comprising a blocked 3′ end, wherein the first adapter comprises a sequence A, wherein the sequence A is non-hybridizable to the one or more polynucleotides comprising a blocked 3′ end; e) extending a 3′ end of the first adapter appended to the 3′ end of the one or more polynucleotides comprising a blocked 3′ end using the one or more polynucleotides comprising a blocked 3′ end as template, wherein one or more double stranded polynucleotides comprising the sequence A at one end are generated; and f) appending a second adapter comprising a sequence B to the one or more double stranded polynucleotides comprising the sequence A at one end, wherein the sequence B is different than the sequence A and the appending generates one or more double stranded polynucleotides comprising the sequence A at one end and the sequence B at an opposite end, thereby generating the directional polynucleotide library. In some embodiments, steps (b) and (c) are performed simultaneously in the same reaction mixture. In some embodiments, the method comprises synthesizing the one or more polynucleotides from the template nucleic acid in the presence of all four canonical nucleotides and a non-canonical nucleotide, wherein the non-canonical nucleotide is provided at a ratio suitable for generating fragments within the desired size range. In some embodiments, the one or more polynucleotides comprising the non-canonical nucleotide are synthesized by an amplification method selected from the group consisting of polymerase chain reaction (PCR), strand displacement amplification (SDA), multiple displacement amplification (MDA), rolling circle amplification (RCA), single primer isothermal amplification (SPIA), and Ribo-SPIA. In some embodiments, the one or more polynucleotides comprising the non-canonical nucleotide are synthesized by a method selected from the group consisting of reverse transcription, primer extension, limited primer extension, replication, and nick translation. In some embodiments, the first adapter further comprises a partial duplex and a 3′ overhang. In some embodiments, the first adapter comprises a plurality of first adapters, wherein the random sequence on each of the plurality of first adapters is different than the random sequence on another of the plurality of first adapters, and wherein each of the plurality of first adapters comprises the sequence A. In some embodiments, the annealing results in substantially all of the plurality of first strand cDNA fragments of a desired size comprising a blocked 3′ end further comprising one of the plurality of first adapters annealed the 3′ end. In some embodiments, the appending comprises annealing the 3′ overhang of the first adapter to the 3′ end of the one or more polynucleotides comprising a blocked 3′ end, wherein the annealing comprises hybridizing a random sequence at the 3′ overhang to a complementary sequence present at the 3′ end of the one or more polynucleotides comprising a blocked 3′ end. In some embodiments, the partial duplex comprises a long strand and a short strand, wherein the long strand comprises the sequence A that forms a duplex with the short strand and the 3′ overhang. In some embodiments, the short strand further comprises a block at a 3′ and/or a 5′ end. In some embodiments, the long strand further comprises a block at the 5′ end. In some embodiments, the first adapter further comprises a stem loop, wherein the stem loop links a 5′ end of a long strand of the partial duplex with a 3′ end of a short strand of the partial duplex, and wherein the long strand comprises the sequence A and the 3′ overhang. In some embodiments, the first adapter further comprises a block at a 5′ end of the short strand. In some embodiments, the 3′ overhang comprises at least 6, 7, 8, or 9 nucleotides. In some embodiments, step f) comprises ligating the second adapter. In some embodiments, the ligating comprises blunt end ligation. In some embodiments, the one or more polynucleotides comprising the sequence A at one end generated in step e) are end repaired prior to step f). In some embodiments, the second adapter comprises a duplex, partial duplex, or single strand comprising a duplex portion connected by a stem loop. In some embodiments, the first and/or second adapter further comprises one or more barcodes. In some embodiments, the second adapter comprises a partial duplex, wherein the partial duplex comprises a long strand hybridized to a short strand, wherein the long strand comprises the sequence B and an overhang. In some embodiments, the long strand comprises the sequence B and a 3′ overhang, and wherein the short strand comprises a block at a 3′ end. In some embodiments, the appending of the second adapter generates the one or more double stranded polynucleotides comprising the sequence A at one end and the sequence B at an opposite end, wherein the sequence A is at a 5′ end on one end and the sequence B is at a 3′ end on the opposite end. In some embodiments, the long strand comprises the sequence B and a 5′ overhang, and wherein the short strand comprises a block at a 5′ end. In some embodiments, the appending of the second adapter generates the one or more double stranded polynucleotides comprising the sequence A at one end and the sequence B at an opposite end, wherein the sequence A is at a 5′ end on one end and the sequence B is at a 5′ end on the opposite end. In some embodiments, a 3′ end of the opposite end is extended using the sequence B as a template, thereby generating one or more double stranded polynucleotides comprising the sequence A at a 5′ end on one end and a sequence complementary to the sequence B, B′, at a 3′ end on the opposite end. In some embodiments, the method further comprises amplifying the directional polynucleotide library, thereby generating amplified products. In some embodiments, the method further comprises an additional step of sequencing the amplified products. In some embodiments, the amplification comprises SPIA. In some embodiments, the amplification comprises a use of primers, wherein one or more of the primers comprise a barcode sequence. In some embodiments, the sequencing comprises next generation sequencing.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features are set forth with particularity in the appended claims. A better understanding of features and advantages will be obtained by reference to the following detailed description that sets forth illustrative embodiments, in which the principles of methods, compositions, and kits provided herein are utilized, and the accompanying drawings of which:

FIGS. 1A and 1B depicts methods for the generation of directional cDNA libraries from RNA templates. FIG. 1A depicts the generation of a directional cDNA library from an RNA template comprising strand specific products with defined sequences A and B at the 5′ and 3′ ends of the product, respectively. FIG. 1B depicts the generation of a directional cDNA library from an RNA template comprising strand specific products with defined sequences A and B′ at the 5′ and 3′ ends of the product, respectively.

FIG. 2 depicts first adapters comprising a 3′ overhang comprising random sequence for use in the methods depicted in FIGS. 1A and 1B. I depicts a first adapter comprising a 3′ overhang comprising a long strand and a short single strand complementary to the 5′ portion of the longer strand with blocking groups (x) at both ends. A block can also be present at the 5′ end of the long strand. Any or all of the blocking groups can be optional. The ends of the oligonucleotides can be furthered protected by phosphothioate bonds. II depicts a first adapter comprising a 3′ overhang and a stem loop oligonucleotide. The loop portion of the stem loop can comprise DNA or RNA or combinations thereof, nonnucleotide linker, nucleotide analogs, or a mixture thereof. The 5′ end can also comprise a blocking group. The ends can be furthered protected by phosphothioate bonds.

FIG. 3 depicts a workflow for generation of stranded cDNA library from an RNA template.

FIG. 4 depicts library generation from a double stranded DNA (e.g., genomic DNA) template employing nicking enzyme(s) and a DNA polymerase in combination with the methods depicted in FIGS. 1A and 1B.

FIG. 5 depicts single primer isothermal amplification of a cDNA product generated by the methods depicted in FIGS. 1A and 1B.

FIG. 6 depicts a Bioanalyzer (Agilent) trace of a size distribution of a directional sequencing library produced from 100 ng Universal Human Reference (UHR) total RNA, as described in Example 1.

FIG. 7 depicts transcriptome sequencing data of directional sequencing libraries (s4_L2DR14; s4_L2DR15) from UHR total RNA (100 ng) generated as described in Example 1.

FIG. 8 depicts the correlation of reads per kilobase of transcript per million (RPKM) value of the transcriptome sequencing data of two directional sequencing libraries (s4_L2DR14; s4_L2DR15) from UHR total RNA (100 ng) generated as described in Example 1.

FIG. 9 depicts a summary of sequencing data obtained from three directional sequencing library generated from UHR total RNA as described in Examples 1 and 2.

FIG. 10 depicts transcriptome sequencing data from directional sequencing libraries from UHR total RNA (1 ng) generated as described in Example 2.

### DETAILED DESCRIPTION

### I. Overview

Provided herein are methods, compositions, and kits for the construction of directional nucleic acid sequencing libraries from nucleic acid (e.g., RNA and DNA) templates. In one aspect, provided herein are methods, compositions, and kits for generating nucleic acid libraries from RNA and DNA templates that are compatible with high throughput sequencing methods and simultaneously maintain the directional (strandedness) information of the original nucleic acid sample. The methods can be used to generate libraries representing the whole transcriptome as well as the whole genome without the need for physical fragmentation of the template genomic dsDNA. The methods can also be used to generate libraries from very small samples, including single cells.

### II. Strand-Specific Selection

The compositions, methods, and kits provided herein can be used for retaining directional information for a template nucleic acid. The template nucleic acid can be a RNA or DNA. The template nucleic acid can be single-stranded or double-stranded. The terms “strand specific,” “directional,” or “strandedness” can refer to the ability to differentiate in a double-stranded polynucleotide between the two strands that are complementary to one another. The terms “stranded library”, “stranded cDNA library”, “directional library” or “directional cDNA library” can be used interchangeably. The term “strand marking” can refer to any method for distinguishing between the two strands of a double-stranded polynucleotide. The term “selection” can refer to any method for selecting between the two strands of a double-stranded polynucleotide.

Based on the methods described herein, the retention of the directionality and strand information of the nucleic acid template can be determined with greater than 50% efficiency. The efficiency of retention of directionality and strand orientation using the methods described herein can be >50%, >55%, >60%, >65%, >70%, >75%, >80%, >85%, >90%, or >95%. The efficiency of retention of directionality and strand orientation can be >70%, >80%, >90% or >99%. The methods described herein can be used to generate directional polynucleotide libraries wherein greater than 50% of the polynucleotides in the polynucleotide library comprise a specific strand orientation. The retention of a specific strand orientation using the methods described herein can be >50%, >55%, >60%, >65%, >70%, >75%, >80%, >85%, >90%, or >95%. The retention of specific strand orientation of polynucleotides in the directional polynucleotide library can be >99%.

### III. Polynucleotides, Samples, and Nucleotides

The directional nucleic acid library can be generated from a nucleic acid template obtained from any source of nucleic acid. The nucleic acid can be RNA or DNA. The nucleic acid can be single-stranded or double stranded. In some cases, the nucleic acid is DNA. The DNA can be obtained and purified using standard techniques in the art and include DNA in purified or unpurified form. The DNA can be mitochondrial DNA, cell-free DNA, complementary DNA (cDNA), or genomic DNA. In some cases, the nucleic acid is genomic DNA. The DNA can be plasmid DNA, cosmid DNA, bacterial artificial chromosome (BAC), or yeast artificial chromosome (YAC). The DNA can be derived from one or more chromosomes. For example, if the DNA is from a human, the DNA can derived from one or more of chromosome 1, 2, 3, 4, 5, 6, 7, 8, 9, 10, 11, 12, 13, 14, 15, 16, 17, 18, 19, 20, 21, 22, X, or Y. In some cases, the DNA is double-stranded DNA. In some cases, the double-stranded DNA is genomic DNA. In some cases, the DNA is cDNA. In some cases, the cDNA is double-stranded cDNA. In some cases, the cDNA is derived from RNA, wherein the RNA is subjected to first strand synthesis followed by second strand synthesis. The RNA can be obtained and purified using standard techniques in the art and include RNAs in purified or unpurified form, which include, but are not limited to, mRNAs, tRNAs, snRNAs, rRNAs, retroviruses, small non-coding RNAs, microRNAs, polysomal RNAs, pre-mRNAs, intronic RNA, viral RNA, cell free RNA and fragments thereof. The non-coding RNA, or ncRNA can include snoRNAs, microRNAs, siRNAs, piRNAs and long nc RNAs.

The source of nucleic acid for use in the methods described herein can be a sample comprising the nucleic acid. The nucleic acid can be isolated from the sample and purified by any of the methods known in the art for purifying the nucleic acid from the sample. The sample can be derived from a non-cellular entity comprising polynucleotides (e.g., a virus) or from a cell-based organism (e.g., member of archaea, bacteria, or eukarya domains). In some cases, the sample is obtained from a swab of a surface, such as a door or bench top.

The sample can be from a subject, e.g., a plant, fungi, eubacteria, archeabacteria, protest, or animal. The subject can be an organism, either a single-celled or multi-cellular organism. The subject can be cultured cells, which can be primary cells or cells from an established cell line, among others. The sample can be isolated initially from a multi-cellular organism in any suitable form. The animal can be a fish, e.g., a zebrafish. The animal can be a mammal. The mammal can be, e.g., a dog, cat, horse, cow, mouse, rat, or pig. The mammal can be a primate, e.g., a human, chimpanzee, orangutan, or gorilla. The human can be a male or female. The sample can be from a human embryo or human fetus. The human can be an infant, child, teenager, adult, or elderly person. The female can be pregnant, suspected of being pregnant, or planning to become pregnant. In some cases, the sample is a single or individual cell from a subject and the polynucleotides are derived from the single or individual cell. In some cases, the sample is an individual micro-organism, or a population of micro-organisms, or a mixture of micro-organisms and host cellular or cell free nucleic acids.

The sample can be from a subject (e.g., human subject) who is healthy. In some cases, the sample is taken from a subject (e.g., an expectant mother) at at least 4, 5, 6, 7, 8, 9, 10, 11, 12, 13, 14, 15, 16, 17, 18, 19, 20, 21, 22, 23, 24, 25, or 26 weeks of gestation. In some cases, the subject is affected by a genetic disease, a carrier for a genetic disease or at risk for developing or passing down a genetic disease, where a genetic disease is any disease that can be linked to a genetic variation such as mutations, insertions, additions, deletions, translocation, point mutation, trinucleotide repeat disorders and/or single nucleotide polymorphisms (SNPs).

The sample can be from a subject who has a specific disease, disorder, or condition, or is suspected of having (or at risk of having) a specific disease, disorder or condition. For example, the sample can be from a cancer patient, a patient suspected of having cancer, or a patient at risk of having cancer. The cancer can be, e.g., acute lymphoblastic leukemia (ALL), acute myeloid leukemia (AML), adrenocortical carcinoma, Kaposi Sarcoma, anal cancer, basal cell carcinoma, bile duct cancer, bladder cancer, bone cancer, osteosarcoma, malignant fibrous histiocytoma, brain stem glioma, brain cancer, craniopharyngioma, ependymoblastoma, ependymoma, medulloblastoma, medulloeptithelioma, pineal parenchymal tumor, breast cancer, bronchial tumor, Burkitt lymphoma, Non-Hodgkin lymphoma, carcinoid tumor, cervical cancer, chordoma, chronic lymphocytic leukemia (CLL), chromic myelogenous leukemia (CML), colon cancer, colorectal cancer, cutaneous T-cell lymphoma, ductal carcinoma in situ, endometrial cancer, esophageal cancer, Ewing Sarcoma, eye cancer, intraocular melanoma, retinoblastoma, fibrous histiocytoma, gallbladder cancer, gastric cancer, glioma, hairy cell leukemia, head and neck cancer, heart cancer, hepatocellular (liver) cancer, Hodgkin lymphoma, hypopharyngeal cancer, kidney cancer, laryngeal cancer, lip cancer, oral cavity cancer, lung cancer, non-small cell carcinoma, small cell carcinoma, melanoma, mouth cancer, myelodysplastic syndromes, multiple myeloma, medulloblastoma, nasal cavity cancer, paranasal sinus cancer, neuroblastoma, nasopharyngeal cancer, oral cancer, oropharyngeal cancer, osteosarcoma, ovarian cancer, pancreatic cancer, papillomatosis, paraganglioma, parathyroid cancer, penile cancer, pharyngeal cancer, pituitary tumor, plasma cell neoplasm, prostate cancer, rectal cancer, renal cell cancer, rhabdomyosarcoma, salivary gland cancer, Sezary syndrome, skin cancer, nonmelanoma, small intestine cancer, soft tissue sarcoma, squamous cell carcinoma, testicular cancer, throat cancer, thymoma, thyroid cancer, urethral cancer, uterine cancer, uterine sarcoma, vaginal cancer, vulvar cancer, Waldenstrom Macroglobulinemia, or Wilms Tumor. The sample can be from the cancer and/or normal tissue from the cancer patient.

The sample can be aqueous humour, vitreous humour, bile, whole blood, blood serum, blood plasma, breast milk, cerebrospinal fluid, cerumen, enolymph, perilymph, gastric juice, mucus, peritoneal fluid, saliva, sebum, semen, sweat, tears, vaginal secretion, vomit, feces, or urine. The sample can be obtained from a hospital, laboratory, clinical or medical laboratory. The sample can be taken from a subject.

The sample can be an environmental sample comprising medium such as water, soil, air, and the like. The sample can be a forensic sample (e.g., hair, blood, semen, saliva, etc.). The sample can comprise an agent used in a bioterrorist attack (e.g., influenza, anthrax, smallpox).

The sample can comprise nucleic acid. The nucleic acid can be, e.g., mitochondrial DNA, genomic DNA, mRNA, siRNA, miRNA, cRNA, single-stranded DNA, double-stranded DNA, single-stranded RNA, double-stranded RNA, tRNA, rRNA, or cDNA. The sample can comprise cell-free nucleic acid. The sample can be a cell line, genomic DNA, cell-free plasma, formalin fixed paraffin embedded (FFPE) sample, or flash frozen sample. A formalin fixed paraffin embedded sample can be deparaffinized before nucleic acid is extracted. The sample can be from an organ, e.g., heart, skin, liver, lung, breast, stomach, pancreas, bladder, colon, gall bladder, brain, etc. Nucleic acids can be extracted from a sample by means available to one of ordinary skill in the art.

The sample can be processed to render it competent for fragmentation, ligation, denaturation, and/or amplification or any of the methods provided herein. Exemplary sample processing can include lysing cells of the sample to release nucleic acid, purifying the sample (e.g., to isolate nucleic acid from other sample components, which can inhibit enzymatic reactions), diluting/concentrating the sample, and/or combining the sample with reagents for further nucleic acid processing. In some examples, the sample can be combined with a restriction enzyme, reverse transcriptase, or any other enzyme of nucleic acid processing.

The methods described herein can be used for analyzing or detecting one or more target nucleic acids. The term polynucleotide, or grammatical equivalents, can refer to at least two nucleotides covalently linked together. A polynucleotide described herein can contain phosphodiester bonds, although in some cases, as outlined below (for example in the construction of primers and probes such as label probes), nucleic acid analogs are included that can have alternate backbones, comprising, for example, phosphoramide (Beaucage et al., Tetrahedron 49(10):1925 (1993) and references therein; Letsinger, J. Org. Chem. 35:3800 (1970); Sprinzl et al., Eur. J. Biochem. 81:579 (1977); Letsinger et al., Nucl. Acids Res. 14:3487 (1986); Sawai et al, Chem. Lett. 805 (1984), Letsinger et al., J. Am. Chem. Soc. 110:4470 (1988); and Pauwels et al., Chemica Scripta 26:141 91986)), phosphorothioate (Mag et al., Nucleic Acids Res. 19:1437 (1991); and U.S. Pat. No. 5,644,048), phosphorodithioate (Briu et al., J. Am. Chem. Soc. 111:2321 (1989), O-methylphosphoroamidite linkages (see Eckstein, Oligonucleotides and Analogues: A Practical Approach, Oxford University Press), and peptide nucleic acid (also referred to herein as “PNA”) backbones and linkages (see Egholm, J. Am. Chem. Soc. 114:1895 (1992); Meier et al., Chem. Int. Ed. Engl. 31:1008 (1992); Nielsen, Nature, 365:566 (1993); Carlsson et al., Nature 380:207 (1996), all of which are incorporated by reference). Other analog nucleic acids include those with bicyclic structures including locked nucleic acids (also referred to herein as “LNA”), Koshkin et al., J. Am. Chem. Soc. 120.13252 3 (1998); positive backbones (Denpcy et al., Proc. Natl. Acad. Sci. USA 92:6097 (1995); non-ionic backbones (U.S. Pat. Nos. 5,386,023, 5,637,684, 5,602,240, 5,216,141 and 4,469,863; Kiedrowshi et al., Angew. Chem. Intl. Ed. English 30:423 (1991); Letsinger et al., J. Am. Chem. Soc. 110:4470 (1988); Letsinger et al., Nucleoside & Nucleotide 13:1597 (1994); Chapters 2 and 3, ASC Symposium Series 580, “Carbohydrate Modifications in Antisense Research”, Ed. Y. S. Sanghui and P. Dan Cook; Mesmaeker et al., Bioorganic & Medicinal Chem. Lett. 4:395 (1994); Jeffs et al., J. Biomolecular NMR 34:17 (1994); Tetrahedron Lett. 37:743 (1996)) and non-ribose backbones, including those described in U.S. Pat. Nos. 5,235,033 and 5,034,506, and Chapters 6 and 7, ASC Symposium Series 580, “Carbohydrate Modifications in Antisense Research”, Ed. Y. S. Sanghui and P. Dan Cook. Nucleic acids containing one or more carbocyclic sugars are also included within the definition of nucleic acids (see Jenkins et al., Chem. Soc. Rev. (1995) pp 169 176). Several nucleic acid analogs are described in Rawls, C & E News Jun. 2, 1997 page 35. “Locked nucleic acids” are also included within the definition of nucleic acid analogs. LNAs are a class of nucleic acid analogues in which the ribose ring is “locked” by a methylene bridge connecting the 2′-O atom with the 4′-C atom. All of these references are hereby expressly incorporated by reference. These modifications of the ribose-phosphate backbone can be done to increase the stability and half-life of such molecules in physiological environments. For example, PNA:DNA and LNA-DNA hybrids can exhibit higher stability and thus can be used in some cases. The nucleic acids can be single stranded or double stranded, as specified, or contain portions of both double stranded or single stranded sequence. Depending on the application, the nucleic acids can be DNA (including, e.g., genomic DNA, mitochondrial DNA, and cDNA), RNA (including, e.g., mRNA and rRNA) or a hybrid, where the nucleic acid contains any combination of deoxyribo- and ribo-nucleotides, and any combination of bases, including uracil, adenine, thymine, cytosine, guanine, inosine, xathanine hypoxathanine, isocytosine, isoguanine, etc.

The term “unmodified nucleotide” or “unmodified dNTP” or “classic dNTP” can refer to the four deoxyribonucleotide triphosphates dATP (deoxyadenosine triphosphate), dCTP (deoxycytidine triphosphate), dGTP (deoxyguanosine triphosphate) and dTTP (deoxythymidine triphosphate) that can normally used as building blocks in the synthesis of DNA.

The term “canonical dNTP” or “canonical nucleotide” can be used to refer to the four deoxyribonucleotide triphosphates dATP, dCTP, dGTP and dTTP that are normally found in DNA.

The term “modified nucleotide,” “modified dNTP,” or “nucleotide analog,” can refer to any molecule suitable for substituting one corresponding unmodified nucleotide or classic dNTP. Such modified nucleotides must be able to undergo a base pair matching identical or similar to the classic or unmodified dNTP it replaces. The modified nucleotide or dNTP must be suitable for specific degradation or cleavage in which it is selectively degraded or cleaved by a suitable degrading or cleavage agent. The modified nucleotide must mark the DNA strand containing the modified nucleotide eligible for selective removal or cleavage or facilitate separation of the polynucleotide strands. Such a removal or cleavage or separation can be achieved by molecules, particles or enzymes interacting selectively with the modified nucleotide, thus selectively removing or marking for removal or cleaving only one polynucleotide strand.

The term “non-canonical” can refer to nucleic acid bases in DNA other than the four canonical bases in DNA, or their deoxyribonucleotide or deoxyribonucleoside analogs. Although uracil is a common nucleic acid base in RNA, uracil is a non-canonical base in DNA. In some cases, the non-canonical dNTP is dUTP.

The term “barcode” can refer to a known nucleic acid sequence that allows some feature of a nucleic acid with which the barcode is associated to be identified. In some cases, the feature of the nucleic acid to be identified is the sample from which the nucleic acid is derived. In some cases, barcodes are at least 3, 4, 5, 6, 7, 8, 9, 10, 11, 12, 13, 14, 15, or more nucleotides in length. In some cases, barcodes are shorter than 10, 9, 8, 7, 6, 5, or 4 nucleotides in length. An oligonucleotide (e.g., primer or adapter) can comprise about, more than, less than, or at least 1, 2, 3, 4, 5, 6, 7, 8, 9, or 10 different barcodes. Barcodes can be associated (e.g., via annealing or ligation) with template nucleic acids derived from a sample comprising the template nucleic acids. In some cases, barcodes associated with template nucleic acids derived from one sample are different than barcodes associated with template nucleic acids derived from another sample. The barcodes associated with template nucleic acids derived from a first sample can be of different length than barcodes associated with template nucleic acids derived from a second sample. Barcodes can be of sufficient length and comprise sequences that can be sufficiently different to allow the identification of samples based on barcodes with which they are associated. In some cases, a barcode, and the sample source with which it is associated, can be identified accurately after the mutation, insertion, or deletion of one or more nucleotides in the barcode sequence, such as the mutation, insertion, or deletion of 1, 2, 3, 4, 5, 6, 7, 8, 9, 10, or more nucleotides. In some cases, each barcode in a plurality of barcodes differ from every other barcode in the plurality at at least three nucleotide positions, such as at least 3, 4, 5, 6, 7, 8, 9, 10, or more positions. In some cases, an adapter comprises at least one of a plurality of barcode sequences. In some cases, barcodes for a second adapter oligonucleotide are selected independently from barcodes for a first adapter/primer oligonucleotide. In some cases, first adapter/primer oligonucleotides and second adapter oligonucleotides having barcodes are paired, such that adapters of the pair comprise the same or different one or more barcodes. In some cases, the methods described herein further comprise identifying the sample from which a template nucleic acid is derived based on a barcode sequence to which the target nucleic acid is joined. A barcode can comprise a polynucleotide sequence that when joined to a template nucleic acid serves as an identifier of the sample from which the template nucleic acid was derived.

In some cases, the barcodes comprise a random sequence that is useful for uniquely marking each individual fragment within a sample comprising a plurality of nucleic acid fragments. The uniquely appended barcode provides a means of quantification of the unique fragments during downstream quantification procedures such as massively parallel next generation sequencing. The barcodes can be part of any adapter and/or primer useful in the methods described herein and thereby be appended to an individual fragment or plurality of fragments by the methods provided herein. In these cases, the barcodes are appended at random and are unique for the fragments to which they are appended rather than the sample. These barcodes can be combined with barcodes that are specific for the sample, or the source of the nucleic acid.

Conditions that “allow” or “permit” an event to occur or conditions that are “suitable” for an event to occur, such as polynucleotide synthesis, cleavage of a base portion of a non-canonical nucleotide, cleavage of a phosphodiester backbone at an abasic site, and the like, or “suitable” conditions are conditions that do not prevent such events from occurring. Thus, these conditions permit, enhance, facilitate, and/or are conducive to the event. Such conditions, known in the art and described herein, depend upon, for example, the nature of the polynucleotide sequence, temperature, and buffer conditions. These conditions also depend on what event is desired, such as polynucleotide synthesis, cleavage of a base portion of a non-canonical nucleotide, cleavage of a phosphodiester backbone at an abasic site, etc.

### IV. Synthesis of Polynucleotides Comprising a Non-Canonical Nucleotide

A polynucleotide comprising a non-canonical nucleotide can be produced by synthesizing a polynucleotide from a template nucleic acid in the presence of at least one non-canonical nucleotide, whereby a polynucleotide comprising a non-canonical nucleotide is generated. The frequency of incorporation of non-canonical nucleotides into the polynucleotide (e.g., first strand cDNA) relates to the size of fragment produced using the methods provided herein because the spacing between non-canonical nucleotides in the polynucleotide comprising a non-canonical nucleotide, along with the reaction conditions used, can determine the approximate size of the fragments resulting from generation of an abasic site from the non-canonical nucleotide and cleavage of the backbone at the abasic site, as described herein. The desired size range of the fragments can be varied according to the requirements of downstream applications, such as generation of sequencing library suitable for massively parallel sequencing.

The polynucleotides generated by the methods provided herein can be DNA or complementary DNA (cDNA), wherein the cDNA is complementary to a template nucleic acid, though, as noted herein, a polynucleotide can comprise altered and/or modified nucleotides, internucleotide linkages, ribonucleotides, etc.

Methods for synthesizing polynucleotides (e.g., single and double stranded DNA) from a template nucleic acid are well known in the art, and include, but is not limited to, single primer isothermal amplification (SPIA™), Ribo-SPIA™, PCR, reverse transcription, primer extension, limited primer extension, replication (including rolling circle replication), strand displacement amplification (SDA), nick translation, multiple displacement amplification (MDA), rolling circle amplification (RCA) and, e.g., any method that results in synthesis of the complement of a template nucleic acid sequence such that at least one non-canonical nucleotide can be incorporated into a polynucleotide. See, e.g., Kurn, U.S. Pat. No. 6,251,639; Kurn, WO 02/00938; Kurn, U.S. Pat. No. 6,946,251, Kurn, U.S. Pat. No. 6,692,918; Mullis, U.S. Pat. No. 4,582,877; Wallace, U.S. Pat. No. 6,027,923; U.S. Pat. Nos. 5,508,178; 5,888,819; 6,004,744; 5,882,867; 5,710,028; 6,027,889; 6,004,745; 5,763,178; 5,011,769; see also Sambrook (1989) “Molecular Cloning: A Laboratory Manual”, second edition; Ausebel (1987, and updates) “Current Protocols in Molecular Biology”, Mullis, (1994) “PCR: The Polymerase Chain Reaction”. One or more methods known in the art can be used to generate a polynucleotide comprising a non-canonical nucleotide. It is understood that the polynucleotide comprising a non-canonical nucleotide can be single stranded or double stranded or partially double stranded, and that one or both strands of a double stranded polynucleotide can comprise a non-canonical nucleotide. For convenience, “DNA” can be used herein to describe (and exemplify) a polynucleotide. A DNA, and, thus, a polynucleotide can be a complementary DNA (cDNA) generated by producing a nucleotide strand complementary to a template nucleic acid (e.g., a cDNA produced by first and/or second strand synthesis from an RNA template or a cDNA produced from an extension or replication reaction using a template DNA). Suitable methods include methods that result in one single- or double-stranded polynucleotide comprising a non-canonical nucleotide (for example, reverse transcription, production of double stranded cDNA, a single round of DNA replication), as well as methods that result in multiple single stranded or double stranded copies or copies of the complement of a template (for example, single primer isothermal amplification or Ribo-SPIA™ or PCR). In some cases, a single-stranded polynucleotide comprising a non-canonical nucleotide is synthesized using single primer isothermal amplification. See Kurn, U.S. Pat. Nos. 6,251,639 and 6,692,918.

A polynucleotide comprising a non-canonical nucleotide can be generated from a template in the presence of all four canonical nucleotides and at least one non-canonical nucleotide under reaction conditions suitable for synthesis of polynucleotides, including suitable enzymes and primers, if necessary. Reaction conditions and reagents, including primers, for synthesizing a polynucleotide comprising a non-canonical nucleotide are known in the art, and further discussed herein. Suitable non-canonical nucleotides are well-known in the art, and include: deoxyuridine triphosphate (dUTP), deoxyinosine triphosphate (dITP), 5-hydroxymethyl deoxycytidine triphosphate (5-OH-Me-dCTP). See, e.g., Jendrisak, U.S. Pat. No. 6,190,865 B1; Mol. Cell. Probes (1992) 251-6. Two or more different non-canonical nucleotides can be incorporated into the polynucleotide synthesized from the template nucleic acid by a DNA polymerase as provided herein, whereby a polynucleotide comprising at least two different non-canonical nucleotides can be generated.

In some cases, a polynucleotide comprising a non-canonical nucleotide is generated by reverse transcription from a template nucleic acid or a plurality of template nucleic acids in the presence of a non-canonical nucleotide as provide herein, wherein the template nucleic acid is RNA. In some cases, a polynucleotide comprising a non-canonical nucleotide is generated by a second strand synthesis reaction in the presence of a non-canonical nucleotide as provide herein using a first strand cDNA generated by reverse transcription from a template nucleic acid, wherein the template nucleic acid is RNA. In some cases, a primer used for reverse transcription comprises a random primer, wherein the random primer comprises random sequence directed against one or more RNA templates. In some cases, a primer used for reverse transcription comprises a sequence specific to a target RNA or group of RNAs. The group of RNAs can comprise substantially all transcripts. The group of RNAs targeted can be all RNAs except structural RNA, e.g. ribosomal RNA (rRNA). In some cases, a primer used for second strand synthesis comprises a random primer, wherein the random primer comprises random sequence directed against one or more RNA templates used for first strand cDNA synthesis. In some cases, a primer used for second strand synthesis comprises a sequence specific to a target RNA or group of RNAs used for first strand cDNA synthesis. The group of RNAs can comprise substantially all transcripts. The group of RNAs targeted can be all RNAs except structural RNA, e.g., ribosomal RNA (rRNA). In some cases, the primer or primers used for synthesis of either first or second strand cDNA, or both, can be designed to hybridize to specific targets on the polynucleotide template or templates.

In some cases, a polynucleotide comprising a non-canonical nucleotide is generated by a primer extension reaction from a template nucleic acid in the presence of a non-canonical nucleotide as provided herein, wherein the template nucleic acid is DNA. The DNA can be a dsDNA. The dsDNA can be denatured by any method known in the art prior to the primer extension reaction. The primer can comprise random sequence or sequence directed against a specific target sequence or groups of sequences. In some cases, the polynucleotide comprising a non canonical nucleotide is generated by extension from a nick or break in the phosphodiester backbone of one strand in a dsDNA. It is understood that while a single template nucleic acid is used for simplicity, the primer extension reaction can be performed on one or more template nucleic acids or a mixture thereof, thereby generating a one or more products from the primer extension reaction.

In some cases, a polynucleotide comprising a non-canonical nucleotide is generated by a strand displacement amplification reaction from a template nucleic acid, or a plurality of template nucleic acids, in the presence of non-canonical nucleotides as provide herein, wherein the template nucleic acid is DNA. The DNA can be a dsDNA generated by any of the methods described herein or genomic DNA. The dsDNA can be treated with a nicking enzyme or endonuclease. The nicking enzyme can produce a break in the phosphodiester backbone of one strand in a dsDNA template (e.g. genomic DNA), thereby generating a free 3′ hydroxyl (OH). The free 3′ OH can be extended using a DNA dependent DNA polymerase comprising strand displacement activity as provided herein, wherein the other strand of the dsDNA template can be used as template. The nicking enzyme can be strand specific or non-strand specific. The nicking enzyme or endonuclease for use in the methods provided herein can include any nicking enzyme known in the art, including those provided by New England Biolabs. Examples of nicking endonucleases include, but are not limited to, top strand cleaving Nt.AlwI, Nt.BbvCI, Nt.BstNBI, Nt.SapI, or Nt.CviPII, or bottom strand cleaving Nb.BbvCI, Nb.BsmI, or Nb.BsrDI. A nicking endonuclease can be, e.g., Nt.BspQI, Nt.BsmAI, or Nb.Mva1269I.

FIG. 4 depicts an exemplary method using strand displacement amplification to generate a polynucleotide comprising a non-canonical nucleotide from a genomic DNA template. Double stranded DNA (genomic DNA) is treated with a nicking enzyme to produce nicks (e.g., one or more) in one strand of the dsDNA template. The nicks in the one strand of the dsDNA following treatment with a nicking enzyme can thereby produce one or more 3′ hydroxyls (OHs). Optionally, the nicking enzyme can be sense selective, thereby maintaining the strandedness of the template DNA. The dsDNA comprising nicks (e.g. one or more) in one strand can then be treated with a DNA polymerase comprising strand displacement activity in the presence of a reaction mixture comprising all four dNTPs (e.g. dATP, dTTP, dCTP, and dGTP), and a non-canonical nucleotide (e.g., dUTP), wherein the DNA polymerase can use the one or more 3′ OHs produced by the nicking enzyme to perform an extension reaction using the other, or non-nicked, strand of the dsDNA as template, thereby generating single stranded products or polynucleotides (e.g., one or more or a plurality) comprising uracil bases. The single stranded products or polynucleotides comprising uracil bases can then be treated with UDG in combination with heat or a polyamine (DMED) as provided herein to generate multiple or a plurality of single stranded polynucleotides comprising a block at the 3′ end. The frequency of incorporation of dUTP into the single stranded products comprising uracil bases can be controlled as provided herein in order that multiple fragments comprising 3′ end blocks are generated following treatment with a cleavage agent (e.g., UDG and heat or DMED).

Conditions for limited and/or controlled incorporation of a non-canonical nucleotide are known in the art. See, e.g., Jendrisak, U.S. Pat. No. 6,190,865 B1; Mol. Cell. Probes (1992) 251-6; Anal. Biochem. (1993) 211:164-9; see also Sambrook (1989) “Molecular Cloning: A Laboratory Manual”, second edition; Ausebel (1987, and updates) “Current Protocols in Molecular Biology”. The frequency (or spacing) of non-canonical nucleotides in the resulting polynucleotide comprising a non-canonical nucleotide, and thus the average size of fragments generated using the methods provided herein (i.e., following cleavage of a base portion of a non-canonical nucleotide, and cleavage of a phosphodiester backbone at a non-canonical nucleotide), can be controlled by variables known in the art, including: frequency of nucleotide(s) corresponding to the non-canonical nucleotide(s) in the template (or other measures of nucleotide content of a sequence, such as average G-C content), ratio of canonical to non-canonical nucleotide present in the reaction mixture; ability of the polymerase to incorporate the non-canonical nucleotide, relative efficiency of incorporation of non-canonical nucleotide verses canonical nucleotide, and the like. The average fragmentation size can also relate to the reaction conditions used during fragmentation, as provided herein. The reaction conditions can be empirically determined, for example, by assessing average fragment size generated using the methods provided herein.

The methods for generating polynucleotides comprising a non-canonical nucleotide as provided herein can be used to incorporate a non-canonical nucleotide exactly, more than, less than, at least, at most, or about every 5, 10, 15, 20, 25, 30, 40, 50, 65, 75, 85, 100, 123, 150, 175, 200, 225, 250, 300, 350, 400, 450, 500, 550, 600, or 650 nucleotides apart in the resulting polynucleotide comprising a non-canonical nucleotide. The non-canonical nucleotide can be incorporated about every 200 nucleotides, about every 100 nucleotide, or about every 50 nucleotides. The non-canonical nucleotide can be incorporated about every 50 to about 200 nucleotides. In some cases, a 1:5 ratio of dUTP and dTTP is used in the reaction mixture. Other exemplary ratios can be exactly, about, more than, less than, at least, or at most 1:1, 1:2, 1:3, 1:4, 1:5, 1:6, 1:7, 1:8, 1:9, 1:10, 1:15, 1:20, or 1:50 dUTP to dTTP.

A template nucleic acid (along which a polynucleotide comprising a non-canonical nucleotide is synthesized) can be any template nucleic acid from any source. A template nucleic acid includes double-stranded, partially double-stranded, and single-stranded nucleic acids from any source in purified or unpurified form, which can be DNA (dsDNA and ssDNA) or RNA, including tRNA, mRNA, rRNA, mitochondrial DNA and RNA, chloroplast DNA and RNA, DNA-RNA hybrids, or mixtures thereof, genes, chromosomes, plasmids, the genomes of biological material such as microorganisms, e.g., bacteria, yeasts, viruses, viroids, molds, fungi, plants, animals, humans, and fragments thereof. Obtaining and purifying nucleic acids use standard techniques in the art. RNAs can be obtained and purified using standard techniques in the art. A DNA template (including genomic DNA template) can be transcribed into RNA form, which can be achieved using methods disclosed in Kurn, U.S. Pat. No. 6,251,639 B1, and by other techniques (such as expression systems) known in the art. RNA copies of genomic DNA would generally include untranscribed sequences generally not found in mRNA, such as introns, regulatory and control elements, etc. DNA copies of an RNA template can be synthesized using methods described in Kurn, U.S. Pat. No. 6,946,251 or other techniques known in the art). Synthesis of polynucleotide comprising a non-canonical nucleotide from a DNA-RNA hybrid can be accomplished by denaturation of the hybrid to obtain a ssDNA and/or RNA, cleavage with an agent capable of cleaving RNA from an RNA/DNA hybrid, and other methods known in the art. In some cases, the template RNA is cleaved simultaneously with the fragmentation of the synthesized polynucleotide comprising the non-canonical nucleotide. The template can be only a minor fraction of a complex mixture such as a biological sample and can be obtained from various biological material by procedures well known in the art. The template can be known or unknown and can contain more than one desired specific nucleic acid sequence of interest, each of which can be the same or different from each other. Therefore, the methods provided herein can be useful not only for producing one specific polynucleotide comprising a non-canonical nucleotide, but also for producing simultaneously a plurality of different specific polynucleotides comprising a non-canonical nucleotide. The template DNA can be a sub-population of nucleic acids, for example, a subtractive hybridization probe, total genomic DNA, restriction fragments, a cDNA library, cDNA prepared from total mRNA, a cloned library, or amplification products of any of the templates described herein. In some cases, the initial step of the synthesis of the complement of a portion of a template nucleic acid sequence is template denaturation. The denaturation step can be thermal denaturation or any other method known in the art, such as alkali treatment. In other cases, the initial step of the synthesis of the complement or a portion of a template nucleic acid sequence is a nicking step. Nicking of a double stranded template can be carried out by an enzymatic reaction or by physical or chemical means.

A polynucleotide, or first strand cDNA, comprising a non-canonical nucleotide (e.g., dUTP) is described as a single nucleic acid. It is understood that the polynucleotide can be a single polynucleotide, or a population of polynucleotides (from a few to a multiplicity to a very large multiplicity of polynucleotides). It is further understood that a polynucleotide comprising a non-canonical nucleotide can be a multiplicity or plurality (from small to very large) of different polynucleotide molecules. Such populations can be related in sequence (e.g., member of a gene family or superfamily) or extremely diverse in sequence (e.g., generated from all mRNA, generated from all genomic DNA, etc.). Polynucleotides can also correspond to a single sequence (which can be part or all of a known gene, for example a coding region, genomic portion, etc.). Methods, reagents, and reaction conditions for generating specific polynucleotide sequences and multiplicities or pluralities of polynucleotide sequences are known in the art.

Suitable methods of synthesis of a polynucleotide comprising a non-canonical nucleotide can be template-dependent (in the sense that polynucleotide comprising a non-canonical nucleotide is synthesized along a nucleic acid template, as generally described herein). It is understood that non-canonical nucleotides can be incorporated into a polynucleotide as a result of template-independent methods. For example, one or more primer(s) can be designed to comprise one or more non-canonical nucleotides. See, e.g., Richards, U.S. Pat. Nos. 6,037,152, 5,427,929, and 5,876,976. Inclusion of a non-canonical nucleotide in a primer may be particularly suitable for methods such as single primer isothermal amplification. See Kurn, U.S. Pat. No. 6,251,639 B1; Kurn, WO 02/00938; Kurn, U.S. Patent Publication No. 2003/0087251 A1. Non-canonical nucleotide(s) can also be added to a polynucleotide by template-independent methods such as tailing or ligation of a second polynucleotide comprising a non-canonical nucleotide. Methods for tailing and ligation are well-known in the art.

### V. Generating Directional Libraries from First Strand cDNA

### Cleaving a Base Portion of a Non-Canonical Nucleotide to Create an Abasic Site

In some cases, a polynucleotide comprising a non-canonical nucleotide is treated with an agent, such as an enzyme, capable of generally, specifically, or selectively cleaving a base portion of the non-canonical nucleotide to create an abasic site. As used herein, “abasic site” encompasses any chemical structure remaining following removal of a base portion (including the entire base) with an agent capable of cleaving a base portion of a nucleotide, e.g., by treatment of a non-canonical nucleotide (present in a polynucleotide chain) with an agent (e.g., an enzyme, acidic conditions, or a chemical reagent) capable of effecting cleavage of a base portion of a non-canonical nucleotide. In some embodiments, the agent (such as an enzyme) catalyzes hydrolysis of the bond between the base portion of the non-canonical nucleotide and a sugar in the non-canonical nucleotide to generate an abasic site comprising a hemiacetal ring and lacking the base (interchangeably called “AP” site), though other cleavage products are contemplated for use in the methods provided herein. Suitable agents and reaction conditions for cleavage of base portions of non-canonical nucleotides are known in the art, and include: N-glycosylases (also called “DNA glycosylases” or “glycosidases”) including Uracil N-Glycosylase (“UNG”; specifically cleaves dUTP) (interchangeably termed “uracil DNA glyosylase”), hypoxanthine-N-Glycosylase, and hydroxy-methyl cytosine-N-glycosylase; 3-methyladenine DNA glycosylase, 3- or 7-methylguanine DNA glycosylase, hydroxymethyluracil DNA glycosylase; T4 endonuclease V. See, e.g., Lindahl, PNAS (1974) 71(9):3649-3653; Jendrisak, U.S. Pat. No. 6,190,865 B1. In some cases, UNG is used to cleave a base portion of the dUTP incorporation in polynucleotides generated by the methods provided herein.

The cleavage of base portions of non-canonical nucleotides present in polynucleotides comprising non-canonical nucleotides generated by the methods provided herein can be general, specific or selective cleavage, in the sense that the agent (such as an enzyme) capable of cleaving a base portion of a non-canonical nucleotide generally, specifically or selectively cleaves the base portion of a particular non-canonical nucleotide, whereby greater than about 98%, about 95%, about 90%, about 85%, or about 80% of the base portions cleaved are base portions of non-canonical nucleotides. However, the extent of cleavage can be less. Thus, reference to specific cleavage is exemplary. The general, specific or selective cleavage can be desirable for control of the fragment size in the methods provided herein for generating polynucleotide fragments comprising a block at the 3′ end (i.e., the fragments generated by cleavage of the backbone at an abasic site). The reaction conditions can be selected such that the reaction in which the abasic site(s) are created can run to completion.

A polynucleotide comprising a non-canonical nucleotide as generated by the methods provided herein can be purified following synthesis of the polynucleotide with the non-canonical nucleotide (to eliminate, for example, residual free non-canonical nucleotides that can be present in the reaction mixture). In some cases, there is no intermediate purification between the synthesis of the polynucleotide comprising the non-canonical nucleotide and subsequent steps (such as cleavage of a base portion of the non-canonical nucleotide and cleavage of a phosphodiester backbone at the abasic site).

As noted herein, for convenience, cleavage of a base portion of a non-canonical nucleotide (whereby an abasic site is generated) has been described as a separate step. It is understood that this step can be performed simultaneously with synthesis of the polynucleotide comprising a non-canonical nucleotide (as provided herein), and cleavage of the backbone at an abasic site (fragmentation). It is further understood that the step of synthesis of a polynucleotide comprising a non-canonical nucleotide and the cleavage of the non-canonical nucleotide to generate an abasic site can be done simultaneously, while the cleavage of the backbone at the abasic site can be performed in a follow-up step. The cleavage of the backbone at the abasic site can be performed simultaneously with a step comprising degradation of the template nucleic acid or the two steps can be carried out sequentially.

It is understood that the choice of non-canonical nucleotide can dictate the choice of enzyme to be used to cleave the base portion of that non-canonical nucleotide, to the extent that particular non-canonical nucleotides are recognized by particular enzymes that are capable of cleaving a base portion of the non-canonical nucleotide. The choice of the at least one non-canonical nucleotide can be further dictated by the efficiency of incorporation into the synthesized polynucleotide comprising the non-canonical nucleotide by the DNA polymerase used.

### Cleaving the Backbone at or Near the Abasic Site to Generate a Polynucleotide Fragment

The backbone of the polynucleotide comprising an abasic site as generated by the methods provided herein can be cleaved at or near the abasic site with an agent that generates a polynucleotide fragment with a blocked 3′ end. It is understood that cleavage of the base portion of a nucleotide to create an abasic site and cleavage of the polynucleotide backbone can be performed simultaneously. For convenience, however, these reactions are described as separate steps.

Following generation of an abasic site by cleavage of the base portion of a nucleotide, for example, a non-canonical nucleotide present in the polynucleotide as generated herein, the backbone of the polynucleotide can be cleaved at or near the abasic site, for example, the site of incorporation of a non-canonical nucleotide (also termed the abasic site, following cleavage of the base portion of the non-canonical nucleotide), with an agent capable of effecting cleavage of the backbone at the abasic site to generate a polynucleotide fragment comprising a blocked 3′ end. Cleavage of the polynucleotide backbone (also termed “fragmentation”) can result in at least two fragments (depending on the number of abasic sites present in the polynucleotide comprising an abasic site, and the extent of cleavage), one of which does not comprise a blocked 3′ end.

Suitable agents (for example, an enzyme, a chemical and/or reaction conditions such as heat) capable of cleavage of the backbone at an abasic site to generate a polynucleotide fragment with a blocked 3′ end are well known in the art, and include: heat treatment and/or chemical treatment (including basic conditions, acidic conditions, alkylating conditions, or amine mediated cleavage of abasic sites, (see e.g., McHugh and Knowland, Nucl. Acids Res. (1995) 23(10):1664-1670; Bioorgan. Med. Chem. (1991) 7:2351; Sugiyama, Chem. Res. Toxicol. (1994) 7: 673-83; Horn, Nucl. Acids. Res., (1988) 16:11559-71). As used herein, “agent” or “cleavage agent” encompasses reaction conditions such as heat. In some cases, cleavage is with a polyamine, such as N,N′-dimethylethylenediamine (DMED). See, e.g. McHugh and Knowland, supra. In some cases cleavage is with a combination of enzymes. An example of a combination of enzymes for use in the methods provided herein is USER (combination of UNG and endonuclease VIII from New England Biolabs).

The cleavage can be between the nucleotide immediately 3′ to the abasic residue and the abasic residue. As is well known in the art, cleavage can be 3′ to the abasic site (e.g., cleavage between the deoxyribose ring and 3′-phosphate group of the abasic residue and the deoxyribose ring of the adjacent nucleotide, generating a free 5′ phosphate group on the deoxyribose ring of the adjacent nucleotide), such that an abasic site is located at the 3′ end of the resulting fragment. Treatment under basic conditions or with amines (such as N,N′-dimethylethylenediamine) can result in cleavage of the phosphodiester backbone immediately 3′ to the abasic site to produce a polynucleotide fragment with a blocked 3′ end. In addition, more complex forms of cleavage are also possible, for example, cleavage such that cleavage of the phosphodiester backbone and cleavage of (a portion of) the abasic nucleotide results. For example, under certain conditions, cleavage using chemical treatment and/or thermal treatment can comprise a β-elimination step which results in cleavage of a bond between the abasic site deoxyribose ring and its 3′ phosphate, generating a reactive α,β-unsaturated aldehyde which can be labeled or can undergo further cleavage and cyclization reactions. See, e.g. Sugiyama, Chem. Res. Toxicol. (1994) 7: 673-83; Horn, Nuci. Acids. Res., (1988) 16:11559-71. It is understood that more than one method of cleavage can be used, including two or more different methods which result in multiple, different types of cleavage products comprising blocked 3′ ends.

The cleavage of the backbone at an abasic site can be general, specific or selective cleavage, whereby greater than about 98%, about 95%, about 90%, about 85%, or about 80% of the cleavage is at an abasic site. However, extent of cleavage can be less. Thus, reference to specific cleavage is exemplary. General, specific or selective cleavage can be desirable for control of the fragment size in the methods of generating polynucleotide fragments comprising blocked 3′ ends for the generation of directional polynucleotide libraries as provided herein. The reaction conditions can be selected such that the cleavage reaction is performed in the presence of a large excess of reagents and allowed to run to completion with minimal concern about excessive cleavage of the polynucleotide (i.e., while retaining a desired fragment size, which can be determined by spacing of incorporated non-canonical nucleotides, during the synthesis step, above). The extent of cleavage can be less, such that polynucleotide fragments can be generated comprising an abasic site at an end and an abasic site(s) within or internal to the polynucleotide fragment (i.e., not at an end).

As noted herein, in embodiments in which an abasic site is generated by cleavage of a base portion of a non-canonical nucleotide in a polynucleotide synthesized in the presence of a non-canonical nucleotide, the frequency of incorporation of non-canonical nucleotides into the polynucleotide relates to the size of fragment produced using the methods provided herein because the spacing between non-canonical nucleotides in the polynucleotide comprising a non-canonical nucleotide, as well as the reaction conditions selected, determines the approximate size of the resulting fragments (following cleavage of a base portion of a non-canonical nucleotide, whereby an abasic site is generated, and cleavage of the backbone at the abasic site as described herein). It is generally desired to affect complete cleavage of the backbone at the abasic site(s) so as to generate fragments that are devoid of abasic sites when the fragments serve as a template for second strand synthesis so as to enable polymerase activity along the entire fragment target with high efficiency and fidelity.

For the methods provided herein for generating directional polynucleotide libraries, suitable fragment sizes can be exactly, greater than, less than, at least, at most, or about 5, 10, 15, 20, 25, 30, 40, 50, 65, 75, 85, 100, 123, 150, 175, 200, 225, 250, 300, 350, 400, 450, 500, 550, 600, 650 nucleotides in length. In some cases, the fragment can be about 200 nucleotides, about 100 nucleotides, or about 50 nucleotides in length. In other cases, the size of a population of fragments can be about 50 to 200 nucleotides. It is understood that the fragment size is approximate, particularly when populations of fragments are generated, because the incorporation of a non-canonical nucleotide (which relates to the fragment size following cleavage) can vary from template to template, and also between copies of the same template. Thus, fragments generated from same starting material (such as a single polynucleotide template) may have different (and/or overlapping) sequence, while still having the same approximate size or size range.

Following cleavage of the polynucleotide backbone at the abasic site, every fragment can comprise one abasic site (if cleavage is completely efficient), except for the 3′-most fragment, which can lack an abasic site. All other fragments can comprise a 3′ abasic site (a blocked 3′ end). In some cases, fragmentation of the backbone of the first strand cDNA or polynucleotide at the abasic site as generated by the methods provided herein can generate fragments comprising a blocked 3′-end, and a phosphate at the 5′-end.

### Polymerase Extension of an Adapter Appended to a Polynucleotide Fragment.

In some cases, an oligonucleotide is appended to a 3′ end of a polynucleotide comprising a blocked 3′ end, and optionally a 5′ phosphate, prepared by the methods provided herein. The oligonucleotide can be appended by annealing single stranded DNA present at a 3′ end of the oligonucleotide to the 3′ end of the polynucleotide comprising a blocked 3′ end. In some cases, a polynucleotide with a blocked 3′ end, and optionally a 5′ phosphate, prepared by the methods provided herein is hybridized to an oligonucleotide comprising an overhang with a 3′ hydroxyl (OH) group and extended from the 3′ OH group of the oligonucleotide with a template dependent polymerase, wherein the overhang with a 3′ OH anneals to the 3′ end of the polynucleotide fragments. The oligonucleotide can be an adapter or primer. The oligonucleotide can comprise DNA, RNA, or a combination thereof. The oligonucleotide can be about, less than about, or more than about 10, 15, 20, 25, 30, 35, 40, 45, 50, 55, 60, 65, 70, 75, 80, 90, 100, or 200 nucleotides in length. The oligonucleotide can comprise a partial duplex or be single stranded. In some cases, the oligonucleotide comprises a partial duplex adapter, wherein the partial duplex comprises a long strand and a short strand. In some cases, the oligonucleotide comprising a partial duplex adapter has overhangs of about, more than, less than, or at least 1, 2, 3, 4, 5, 6, 7, 8, 9, 10, 11, 12, 13, 14, 15, 16, 17, 18, 19, or 20 nucleotides. The overhang can be a 3′ overhang. In some cases, the overhang is a 3′ overhang, wherein the overhang comprises at least 6, 7, 8, or 9 nucleotides. In some cases, a 3′ overhang of the oligonucleotide hybridizes to sequence present at the 3′ end of a polynucleotide comprising a blocked 3′ end as generated by the methods described herein. In some cases, the oligonucleotide comprises duplexed sequence. In some cases, the oligonucleotide comprises about, more than, less than, or at least 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 90, 100, 200, or more of base paired or duplexed sequence. In some cases, a partial duplex present in an oligonucleotide comprising the partial duplex and a 3′ overhang serves to prevent hybridization of the oligonucleotide to an internal sequence present in a polynucleotide comprising a 3′ end block as generated by the methods provided herein. The duplex portion of a oligonucleotide comprising a partial duplex and a 3′ overhang as described herein can permit preferential hybridization of the 3′ overhang of the oligonucleotide to a 3′ end of a polynucleotide comprising a block at the 3′ end rather than hybridization to internal sequences present in the polynucleotide comprising a block at the 3′ end. The preferential hybridization can be due to steric hindrance and stacking effects caused by the duplex portion of the oligonucleotide. In some cases, the oligonucleotide is single stranded. In some cases, a single-stranded adapter comprises about, more than, less than, or at least 10, 15, 20, 25, 30, 35, 40, 45, 50, 55, 60, 65, 70, 75, 80, 90, 100, or 200 nucleotides in length. In some cases, the oligonucleotide is a single stranded tailed primer comprising a 3′ portion that is hybridizable to a sequence at the 3′ end of a polynucleotide comprising a blocked 3′ end as generated by the methods provided herein, and a 5′ portion that is non-hybridizable. The non-hybridizable portion can further comprise an identifier sequence (e.g., barcode, TruSeq sequence, etc.). In some cases, the single-stranded oligonucleotide forms a stem-loop or hairpin structure comprising a 3′ overhang, wherein the 3′ overhang hybridizes to sequence present at the 3′ end of a polynucleotide comprising a blocked 3′ end as generated by the methods described herein. In some cases, the stem of the hairpin is about, less than about, or more than about 1, 2, 3, 4, 5, 6, 7, 8, 9, 10, 11, 12, 13, 14, 15, 20, 25, 30, 35, 40, 45, 50, 75, 100, or more nucleotides in length. In some cases, the loop sequence of a hairpin is about, less than about, or more than about 5, 10, 15, 20, 25, 30, 35, 40, 45, 50, or more nucleotides in length. In some cases, the oligonucleotide comprising a stem loop structure has a 3′ overhang of about, more than, less than, or at least 1, 2, 3, 4, 5, 6, 7, 8, 9, 10, 11, 12, 13, 14, 15, 16, 17, 18, 19, or 20 nucleotides. In some cases, the oligonucleotide comprises one or more barcodes. In some cases, one or more barcodes are in a stem and/or a loop of the oligonucleotide. An oligonucleotide comprising a stem loop can further comprise a restriction endonuclease site within the loop. An oligonucleotide comprising a stem loop can further comprise a restriction endonuclease site within the stem. The oligonucleotide comprising a 3′ overhang directed against sequence present at the 3′ end of a polynucleotide comprising a block at the 3′ end can further comprise a block at any and/or all other ends except the 3′ end of the 3′ overhang. The oligonucleotide can further comprise known or universal sequence (e.g., sequence A) and, thus, allow generation and/or use of sequence specific primers for the universal or known sequence. Some examples of adapters or primers for this step are shown in FIG. 2. The two strands forming the dsDNA portion can be two oligonucleotides which can further be connected by a loop. The loop, or linker, can comprise an oligonucleotide, a non-nucleotide linker, or combination thereof. It can also comprise nucleotide analogs. In some cases, an oligonucleotide comprises a partial duplex comprising a first end comprising a blunt end and a second end comprising a 3′ overhang, wherein the partial duplex is formed between a long strand and a short strand, wherein the long strand comprises a known or universal sequence (e.g. sequence A) that forms a duplex with the short strand and a 3′ overhang. The short strand can have a block at the 3′ and/or 5′ end. The long strand can have a block at the 5′ end. The 3′ or 5′ blocks can comprise any block or blocking group provided herein. The 3′ overhang can comprise sequence complementary to sequence present at the 3′ blocked end of a polynucleotide comprising a non-canonical nucleotide as generated by the methods provided herein. The single stranded 3′ overhang can comprise a random sequence. In some cases, a pool or plurality of oligonucleotides comprising 3′ overhangs comprising random sequence are annealed to a 3′ end of a plurality of polynucleotides comprising a blocked 3′ end as generated by any of the methods provided herein. In some cases, the random sequence of each of the pool or plurality of oligonucleotides comprises a different random sequence. In some cases, the random sequence of each of the pool or plurality of oligonucleotides comprises a same random sequence. In some cases, the pool or plurality of oligonucleotides comprises a same universal or known sequence (e.g., sequence A). In some cases, the pool or plurality of oligonucleotides comprises a different universal or known sequence. In some cases, a single strand 3′ overhang of an oligonucleotide (e.g., first adapter) hybridizes to the 3′-ends of substantially all the polynucleotides comprising a 3′ blocked end as generated by the methods provide herein. In some cases, a pool or plurality of single strand 3′ overhangs provided by a pool or plurality of oligonucleotides (e.g., first adapters), wherein each oligonucleotide (e.g., first adapter) of the pool or plurality of oligonucleotides (e.g., first adapters) comprises a 3′ overhang comprising a different random sequence, hybridize to the 3′-ends of substantially all the polynucleotides comprising a 3′ blocked end as generated by any of the methods provide herein. A single strand 3′ overhang of an oligonucleotide (e.g., first adapter) can hybridize to more than, less than, at least, at most, or about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 99.5% or 100% of the polynucleotides comprising a 3′ blocked end as generated by the methods provide herein. In some cases, the single strand 3′ overhang hybridizes to the 3′-ends of between 1-10%, 10-20%, 20-30%, 30-40%, 40-50%, 50-60%, 60-70%, 70-80%, 80-90%, 90-95%, 95-99% or 90-100% of the polynucleotides comprising a 3′ blocked end as generated by the methods provide herein. In some cases, the single strand 3′ overhang hybridizes to the 3′-ends of about 1 to about 10%, about 10 to about 20%, about 20 to about 30%, about 30 to about 40%, about 40 to about 50%, about 50 to about 60%, about 60 to about 70%, about 70 to about 80%, about 80 to about 90%, or about 90 to about 100% of the polynucleotides comprising a 3′ blocked end as generated by the methods provide herein. A pool or plurality of single strand 3′ overhangs provided by a pool or plurality of oligonucleotides (e.g., first adapters), wherein each oligonucleotide (e.g., first adapter) of the pool or plurality of oligonucleotides (e.g., first adapters) comprises a 3′ overhang comprising a different random sequence, can hybridize to more than, less than, at least, at most, or about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 99.5% or 100% of the polynucleotides comprising a 3′ blocked end as generated by the methods provide herein. In some cases, the pool or plurality of single strand 3′ overhangs provided by a pool or plurality of oligonucleotides (e.g., first adapters), wherein each oligonucleotide (e.g., first adapter) of the pool or plurality of oligonucleotides (e.g., first adapters) comprises a 3′ overhang comprising a different random sequence, hybridizes to the 3′-ends of between 1-10%, 10-20%, 20-30%, 30-40%, 40-50%, 50-60%, 60-70%, 70-80%, 80-90%, 90-95%, 95-99% or 90-100% of the polynucleotides comprising a 3′ blocked end as generated by the methods provide herein. In some cases, the pool or plurality of single strand 3′ overhangs provided by a pool or plurality of oligonucleotides (e.g., first adapters), wherein each oligonucleotide (e.g., first adapter) of the pool or plurality of oligonucleotides (e.g., first adapters) comprises a 3′ overhang comprising a different random sequence, hybridizes to the 3′-ends of about 1 to about 10%, about 10 to about 20%, about 20 to about 30%, about 30 to about 40%, about 40 to about 50%, about 50 to about 60%, about 60 to about 70%, about 70 to about 80%, about 80 to about 90%, or about 90 to about 100% of the polynucleotides comprising a 3′ blocked end as generated by the methods provide herein. In some cases, the oligonucleotide comprises one or more barcodes. In some cases, the one or more barcodes are in a stem and/or a loop. In some cases the barcodes comprise a random sequence that is useful for uniquely marking an individual polynucleotide generated by the methods described herein to which the barcode is appended. In some cases, the barcodes are appended at random and are unique for the fragment to which it was appended. These barcodes can be combined with barcodes that are specific for a sample of a template nucleic acid.

In some cases, the method can further comprise performing an extension reaction. The extension reaction can be performed using any number of methods known in the art including, but not limited to, the use of a DNA dependent DNA polymerase with strand displacement activity and all four dNTPs (i.e. dATP, dTTP, dCTP, and dGTP), wherein the dNTPs are unmodified. In some cases, the extension reaction is performed with a DNA polymerase and unmodified dNTPs (i.e. dATP, dTTP, dCTP, and dGTP). In some cases, the extension reaction extends the 3′ overhang annealed to the complementary sequence found at the 3′ blocked end of the polynucleotide comprising a blocked 3′ end, thereby generating a double stranded polynucleotide comprising non complementary ends, wherein the polynucleotide comprising the 3′ block serves as the template polynucleotide. The double stranded polynucleotide comprising non-complementary ends can comprise a known or universal sequence (e.g., sequence A) from the oligonucleotide at one end and a sequence complementary to the 5′ end of the polynucleotide comprising a blocked 3′ end that served as template for the extension reaction at the opposite end of the polynucleotide. The double stranded polynucleotide generated by the extension reaction can comprise a first strand comprising a fragment of the template polynucleotide, and a second strand comprising sequence complementary to the fragment of the template polynucleotide and the known or universal sequence (e.g., sequence A), wherein the known sequence is present at the 5′ end of the second strand, and wherein the 3′ end of the first strand comprises a gap in the phosphodiester backbone between the sequence complementary to the known or universal sequence (e.g., sequence A), and the 3′ block from the template polynucleotide. The known or universal sequence (e.g., sequence A) can serve to mark the strand comprising the known or universal sequence (e.g., sequence A). In cases where the non-canonical nucleotide is incorporated during first strand cDNA synthesis, generation of the marked strand by the methods provided herein produces a marked strand representing the sequence of the template nucleic acid. In cases where the non-canonical nucleotide is incorporated during second strand cDNA synthesis, generation of the marked strand by the methods provided herein produces a marked strand representing the sequence complementary to the template nucleic acid.

In some cases, a double stranded polynucleotide comprising non-complementary ends wherein one end comprises a known or universal sequence (e.g., sequence A) at one end is end repaired following an extension reaction. End repair can include the generation of blunt ends, non-blunt ends (i.e. sticky or cohesive ends), or single base overhangs such as the addition of a single dA nucleotide to the 3′-end of the double-stranded nucleic acid product by a polymerase lacking 3′-exonuclease activity. In some cases, end repair is performed on the double stranded polynucleotide comprising known or universal sequence (e.g., sequence A) at one end to produce a blunt end on the end opposite the one end comprising the known sequence, wherein one end comprises a known or universal sequence (e.g., sequence A) and an opposite end comprises a blunt end with a 3′ OH. End repair can be performed using any number of enzymes and/or methods known in the art. An overhang can comprise about, more than, less than, or at least 1, 2, 3, 4, 5, 6, 7, 8, 9, 10, 11, 12, 13, 14, 15, 16, 17, 18, 19, or 20 nucleotides.

The method can further comprise appending an adapter to the double-stranded polynucleotide comprising sequence A at one end and a 3′ OH at the opposite end. In some cases, the adapter annealed to polynucleotide comprising a 3′ block as generated by the methods provided herein is a first adapter, while the adapter appended to an opposite end of the double-stranded polynucleotide comprising first adapter sequence at one end is a second adapter. Ligation can be blunt end ligation or sticky or cohesive end ligation. Appending the second adapter can be through ligation. The ligation can be performed with any of the enzymes known in the art for performing ligation (e.g., T4 DNA ligase). The second adapter can be any type of adapter known in the art including, but not limited to, a conventional duplex or double stranded adapter. The adapter can comprise DNA, RNA, or a combination thereof. The second adapter can be about, less than about, or more than about 10, 15, 20, 25, 30, 35, 40, 45, 50, 55, 60, 65, 70, 75, 80, 90, 100, or 200 nucleotides in length. The second adapter can be a duplex adapter, partial duplex adapter, or single stranded adapter. In some cases, the second adapter is a duplex adapter. In some cases, the duplex adapter can be about, less than about, or more than about 10, 15, 20, 25, 30, 35, 40, 45, 50, 55, 60, 65, 70, 75, 80, 90, 100, or 200 nucleotides in length. In some cases, the second adapter is a partial duplex adapter, wherein the adapter comprises a long strand and a short strand. In some cases, the second adapter comprising a partial duplex adapter has overhangs of about, more than, less than, or at least 1, 2, 3, 4, 5, 6, 7, 8, 9, 10, 11, 12, 13, 14, 15, 16, 17, 18, 19, or 20 nucleotides. In some cases, the overhang is a 5′ overhang. In some cases, the overhang is a 3′ overhang. In some cases, the partial duplex of the second adapter comprises about, more than, less than, or at least 5, 6, 7, 8, 9, 10, 12, 12, 13, 14, 15, 16, 17, 18, 19, 20, 21, 22, 23, 24, 25, 30, 35, 40, 45, 50, 55, 60, 65, 70, 75, 80, 90, 100, 200, or more of base paired or duplexed sequence. In some cases, the adapter comprises a single stranded adapter. In some cases, a single-stranded adapter comprises about, more than, less than, or at least 10, 15, 20, 25, 30, 35, 40, 45, 50, 55, 60, 65, 70, 75, 80, 90, 100, or 200 nucleotides in length. In some cases, the single-stranded adapter forms a stem-loop or hairpin structure. In some cases, the stem of the hairpin adapter is about, less than about, or more than about 1, 2, 3, 4, 5, 6, 7, 8, 9, 10, 11, 12, 13, 14, 15, 20, 25, 30, 35, 40, 45, 50, 75, 100, or more nucleotides in length. In some cases, the loop sequence of a hairpin adapter is about, less than about, or more than about 5, 10, 15, 20, 25, 30, 35, 40, 45, 50, or more nucleotides in length. The second adapter can further comprise known or universal sequence (e.g., sequence B) and, thus, allow generation and/or use of sequence specific primers for the universal or known sequence. A second adapter comprising a stem loop can further comprise a restriction endonuclease site within the loop. A second adapter comprising a stem loop can further comprise a restriction endonuclease site within the stem. In the methods provided herein, a known or universal sequence of a second adapter as provided herein can be the same or different from a known or universal sequence of a first adapter as provided herein. In some cases, a first adapter comprises sequence A and a second adapter comprises sequence B, wherein sequence B is different or non-complementary to sequence A. In some cases, a second adapter comprises one or more barcodes. In some cases, one or more barcodes are in a stem and/or a loop.

In some cases, appending of the second adapter to the double-stranded polynucleotide comprising known or universal sequence (e.g., sequence A) at one end and a 3′ OH at the opposite end is by blunt end ligation. In some cases, appending of the second adapter is by cohesive or sticky end ligation, wherein an overhang in the second adapter hybridizes to an overhang in the double stranded polynucleotide comprising complementary sequence to the overhang. In some cases, the second adapter comprises a ligation strand or first strand capable of ligation to a 5′ end of the double-stranded polynucleotide comprising known or universal sequence (e.g., sequence A) at one end and a 3′ OH at the opposite end and a non-ligation strand or second strand incapable of ligation to either end of the double-stranded polynucleotide comprising known or universal sequence (e.g., sequence A) at one end and a 3′ OH at the opposite end. In some cases, the second adapter comprises a ligation strand or first strand capable of ligation to a 3′ end of the double-stranded polynucleotide comprising known or universal sequence (e.g., sequence A) at one end and a 3′ OH at the opposite end and a non-ligation strand or second strand incapable of ligation to either end of the double-stranded polynucleotide comprising known or universal sequence (e.g., sequence A) at one end and a 3′ OH at the opposite end. In some cases, the second adapter is a partial duplex adapter, wherein the adapter comprises a long strand and a short strand, and wherein the long strand is the ligation strand or first strand, while the short strand is the non-ligation strand or second strand. The short strand can have a block at the 3′ and/or 5′ end. The long strand can have a block at the 3′ or 5′ end. The 3′ or 5′ blocks can comprise any block or blocking group provided herein. In some cases, the partial duplex has strands of unequal length. In some cases, the partial duplex comprises an overhang at one end of the adapter and a blunt end at another end of the adapter. The overhang can be at the 3′ end or the 5′ end. In some cases, the partial duplex comprises an overhang at each end of the adapter. The overhang can be of equal length or unequal length. In some cases, the 5′ end of the ligation strand does not comprise a 5′ phosphate group. In some cases, the 5′ end of the ligation strand does comprise a 5′ phosphate, wherein the 3′ end of the polynucleotide lacks a free 3′ hydroxyl. In some cases, the second adapter comprises a long strand comprising a 3′ overhang and a known sequence (e.g., sequence B) that forms a partial duplex with a short strand, wherein the short strand comprises a block at a 3′ end, and wherein the long strand is ligated to the 3′ OH at the opposite end of the double-stranded polynucleotide comprising known or universal sequence (e.g., sequence A) at one end and a 3′ OH at the opposite end, thereby generating a double stranded polynucleotide comprising known or universal sequence at both ends. Further to these cases, the double stranded polynucleotide comprising known or universal sequence at both ends comprises one strand comprising known or universal sequence derived from the oligonucleotide annealed to the polynucleotide comprising a blocked 3′ end and extended as described herein at the 5′ end and the known or universal sequence derived from ligation of the second adapter. In some cases, the one strand comprises sequence A at a 5′ end and sequence B at a 3′ end. In some cases, the second adapter comprises a long strand comprising a 5′ overhang and a known sequence (e.g., sequence B) that forms a partial duplex with a short strand, wherein the short strand comprises a block at a 5′ end, and wherein the long strand is ligated to the 5′ phosphate at the opposite end of the double-stranded polynucleotide comprising known or universal sequence (e.g., sequence A) at one end and a 3′ OH at the opposite end, thereby generating a double stranded polynucleotide comprising known or universal sequence at both ends. Further to these cases, the ligating of the second adapter to the double-stranded polynucleotide comprising known or universal sequence (e.g., sequence A) at one end and a 3′ OH at the opposite end generates a double stranded polynucleotide comprising known or universal sequence (e.g., sequence A) derived from the oligonucleotide annealed to the polynucleotide comprising a blocked 3′ end and extended as described herein at one end and the known or universal sequence (e.g., sequence B) derived from the second adapter at an opposite end, wherein the known or universal sequence (e.g., sequence A) derived from the oligonucleotide annealed to the polynucleotide comprising a blocked 3′ end and extended as described herein is at a 5′ end on one end and the known or universal sequence (e.g., sequence B) derived from the second adapter is at a 5′ end on the opposite end. In some cases, the one strand comprises sequence A at a 5′ end of one strand and sequence B at a 5′ end on another strand, wherein the 3′ end of the strand comprising sequence A is extended using the sequence B as a template, thereby generating one or more double stranded polynucleotides comprising the sequence A at a 5′ end on one end and a sequence complementary to sequence B, B′, at a 3′ end on the opposite end.

In some cases, the method further comprises a denaturing step, a double stranded polynucleotide comprising non complementary known or universal sequences on opposite ends generated by the methods provided herein are denatured. Denaturation can be achieved using any of the methods known in the art which can include, but are not limited to, heat denaturation, and/or chemical denaturation. Heat dentauration can be performed by raising the temperature of the reaction mixture to be above the melting temperature of the polynucleotide comprising non complementary known or universal sequences on opposite ends generated by the methods provided herein. The melting temperature can be about, more than, less than, or at least 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 81, 82, 83, 84, 85, 86, 87, 88, 89, 90, 91, 92, 93, 94, or 95 degrees C. The temperature can be raised above the melting temperature by about, more than, less than, or at least 1, 2, 3, 4, 5, 6, 7, 8, 9, or 10 degrees C. Chemical denaturation can be performed using bases (i.e. NaOH), and/or competitive denaturants (i.e. urea, or formaldehyde). In some cases, denaturation generates single stranded polynucleotides comprising non-complementary known or universal sequences on opposite ends generated by the methods provided herein.

Following denaturation, a single stranded polynucleotide comprising non complementary known or universal sequences on opposite ends generated by the methods provided herein are amplified, thereby generating directional polynucleotide libraries. The known or universal sequence on one or a first end can be derived from the first adapter, while the known or universal sequence on the other or a second end can be derived from the second adapter as described herein. The amplification can be performed using primer pairs directed against the non-complementary known or universal sequences present on the opposite ends. The amplification can be performed using amplification method known in the art, which can include, but is not limited to, PCR or single primer isothermal amplification (SPIA). In some cases, a single-stranded polynucleotide comprising sequence A at a 5′ end and sequence B at a 3′ end is amplified using a primer pair, wherein a first primer of the primer pair comprises sequence complementary to a portion of sequence B and a second primer of the primer pair comprising sequence complementary to a portion of the complement of sequence A, sequence A′. In some cases, single stranded polynucleotide comprising sequence A at a 5′ end of a one strand and sequence B′ at a 3′ end is amplified using a primer pair, wherein a first primer of the primer pair comprises sequence complementary to a portion of sequence B′ and a second primer of the primer pair comprising sequence complementary to a portion of the complement of sequence A, sequence A′. In some cases, the first and/or second primer further comprises one or more identifier sequences. In some cases, the identifier sequences comprise a non-hybridizable tail on the first and/or second primer. The identifier sequence can be a barcode sequence, a flow cell sequence, an index sequence, or a combination thereof. In some cases, the index sequence is a Truseq primer sequence compatible with the next generation sequencing platform produced by Illumina. In some cases, the first and/or second primer can bind to a solid surface. The solid surface can be a planar surface or a bead. The planar surface can be the surface of a chip, microarray, well, or flow cell. In some cases, the first and/or second primer comprises one or more sequence elements products of the amplification reaction (i.e. amplification products) to a solid surface, wherein the one or more sequences are complementary to one or more capture probes attached to a solid surface. Other sequence elements known in the art that can be compatible with other massively parallel next generation sequencing platforms can be incorporated in the tail sequences.

Sequencing can be any method of sequencing, including any of the next generation sequencing (NGS) methods described herein. In some cases, the NGS method comprises sequencing by synthesis. In some embodiments, sequencing is performed with primers directed against known or universal sequence introduced into the polynucleotides generated by the methods provided herein by the adapters appended to the polynucleotides. In some cases, sequencing is performed with primers directed against identifier sequence introduced into the polynucleotides by the first and/or second primer used to amplify the single-stranded polynucleotide comprising non-complementary known or universal sequence at opposite ends. The identifier sequence can be a barcode sequence, a flow cell sequence, and/or index sequence. In some cases, the index sequence is a Truseq primer sequence compatible with the next generation sequencing platform produced by Illumina.

A schematic depicting an exemplary workflow using the methods described herein for generating a directional polynucleotide library from an RNA sample is shown in FIG. 3. Step I starts with isolating total RNA from a sample and annealing first strand primers to the total RNA. The first strand primers can comprise random sequence or sequence specific to a specific transcript or group of transcripts. The first strand primers can be designed to prime all transcripts except certain transcripts (e.g., rRNA and/or mitochondrial RNA). In step II, first strand cDNA synthesis is performed on the total RNA isolated in step I using the first strand primers from step I. The first strand cDNA synthesis reaction is performed in the presence of a reaction mixture comprising all four dNTPs and the non-canonical dNTP, dUTP. Step III entails cleaving the first strand cDNA comprising dU using UDG to generate abasic sites, and a cleavage agent capable of cleaving the phsophodiester backbone at the abasic site generated by UDG. The cleavage agent can be DMED or heat. Step III generates polynucleotides comprising a block at the 3′ end, and, optionally, a 5′ phosphate. The incorporation of dUTP during step II can be controlled by controlling the amount or a ratio of dUTP to the other dNTPs within the reaction mixture such that step II produces first strand cDNA comprising uracil bases at a desired density, whereby step III generates polynucleotides comprising a block at the 3; end of a desired size. The desired size can be determined by a downstream application, like, for example, a specific next generation sequencing platform. The template total RNA from step I is degraded in step IV and the polynucleotides generated in step III are purified in step V. Degradation of the template RNA can be performed using an RNase (e.g., RNaseH or RNase I) or by heat treatment. Following purification, a first adapter comprising a 3′ overhang comprising random sequence is annealed to sequence present at the 3′ end of the polynucleotides generated in step III. The first adapter can be single stranded and comprise a hairpin structure in addition to the 3′ overhang. The first adapter can be a plurality of first adapters, wherein each of the plurality of first adapters comprises a different random sequence and each of the plurality comprises a same universal sequence. The first adapter can comprise two oligonucleotides that form a partial duplex wherein one strand is longer than the other strand at the 3′ end and thereby comprises a 3′ overhang. The first adapter can further comprise a first universal sequence. Once annealed, the 3′ end of the overhang annealed to the 3′ end of the polynucleotides generated in step III is extended with a DNA polymerase to produce a second strand cDNA. The end of the newly generated second strand can be polished using T4 polymerase in step VIII, and then purified in step IX. Ultimately, a second adapter is ligated to the double stranded polynucleotide product of step VII. The second adapter can comprise a second universal sequence. The product of step X can comprise a double stranded polynucleotide comprising one strand with a first universal sequence on one end and a second universal sequence on a second, opposite end with an insert comprising sequence representing a portion of the original RNA template between the first and second ends. The product of step X is then purified in step XI and subjected to PCR with primers directed against the first and second universal sequences appended to the product of step X in step XII. The primers can be suitable for any of the next generation sequencing platforms known in the art and can further comprise barcodes and/or any other identifier sequence known in the art.

A schematic exemplary of an embodiment of the methods described herein for generating a directional polynucleotide library from an RNA template is shown in FIG. 1A. As illustrated in step I of FIG. 1A, a primer is hybridized to a template RNA. As provided herein, the primer can comprise random sequence, transcript specific sequence, and/or an oligo dT. In step II, the primer is extended in the presence of dUTP to produce a first strand cDNA or polynucleotide extension product. The extension can be performed using an RNA dependent DNA polymerase as provided herein. In step III, following degradation of the template RNA, the polynucleotide comprising uracil bases is degraded using UNG and heat or a polyamine (DMED), thereby producing multiple fragments comprising a 3′ blocked end. The degradation of the template RNA can be performed using an RNase (e.g. RNase H or RNase I). Alternatively, the RNA template polynucleotide can be degraded by other methods that include, but are not limited to, heat or alkaline pH treatment, or combination of various methods. Heat treatment for the degradation of the RNA template can also be used for the cleavage of the backbone of the complementary DNA comprising the abasic sites, thus achieving fragmentation of the complementary DNA and the RNA template in a single step. In step IV, a first adapter is annealed to sequence present at the 3′ blocked end of the polynucleotides generated in step III. The first adapter comprises a 3′ overhang comprising random sequence at the 3′ end, whereby the 3′ overhang binds a complementary sequence at the 3′ blocked end of the polynucleotides generated in step III. The first adapter can be a plurality of first adapters, wherein each of the plurality of first adapters comprises a different random sequence, wherein the random sequence on one of the plurality of first adapters can anneal to complementary sequence present at the 3′ end on one or more of the polynucleotides generated in step III. Each of the plurality can comprise sequence A. The 3′ end of the annealed 3′ overhang of the first adapter is extended along the polynucleotide comprising the blocked 3′ end in step V, thereby generating double stranded polynucleotides with sequence A appended to the 5′ end of one strand of the double stranded polynucleotide. The sequence complementary to sequence A, A′, is not appended to the other strand of the double stranded polynucleotide generated in step V due to the 3′ block generated in step III. In step VI, a second adapter is ligated to the end of the double stranded polynucleotide generated in step V, opposite the end comprising sequence A. The second adapter comprises a partial duplex, formed between a long strand comprising a sequence B and a short strand comprising a portion of the complement of sequence B, B′. The long strand further comprises a 3′ overhang, while the short strand further comprises a block at the 3′ end. The block can be any block or blocking group as provided herein. In step VI, the long strand serves as a ligation strand, while the short strand serves as a non-ligation strand, whereby the 5′ end of the long strand is ligated to the 3′ end of the strand of the double stranded polynucleotide produced in step V comprising sequence A at its 5′ end, thereby generating a double stranded polynucleotide comprising non-complementary ends. The ligation can be performed using any of the methods provided herein including, but not limited to, generating a blunt end at the end of the double stranded polynucleotide generated in step V and performing blunt end ligation. One strand of the double stranded polynucleotide generated in step VI comprises a strand specific polynucleotide comprising sequence A at a 5; end and sequence B at a 3′ end. The strand specific polynucleotide can be amplified using any of the amplification methods provided herein. In some cases, the amplification comprises performed an amplification reaction using a first primer directed against sequence B, and a second primer directed against the complement of sequence A, A′. Either or both of the first or second primer can further comprise a non-hybridizable tail, wherein the tail comprises a reverse flow cell sequence, a TruSeq primer sequence, a barcode sequence and/or any other desired sequence useful for downstream applications as described herein. Following amplification with the first and second primers, an amplification product comprising double stranded polynucleotide sequence appended with non-complementary adapter sequence at each end derived from the ligated adapter and flow cell sequences are generated. The amplification products can be compatible with any of the next generation sequencing platform as provided herein.

FIG. 1B shows a schematic exemplary of an embodiment of the methods described herein for generating a directional polynucleotide library from an RNA template. Steps I through V of FIG. 1B are identical to steps I through V of FIG. 1A. Similar to FIG. 1A, the second adapter of step VI of FIG. 1B comprises a partial duplex, formed between a long strand comprising a sequence B and a short strand comprising a portion of the complement of sequence B, B′. In contrast to FIG. 1A, the long strand of second adapter of step VI of FIG. 1B comprises a 5′ overhang, while the short strand further comprises a block at the 5′ end. The block can be any block or blocking group as provided herein. In step VI, the long strand serves as a ligation strand, while the short strand serves as a non-ligation strand, whereby the 5′ end of the long strand is ligated to the 5′ end of the opposite strand of the double stranded polynucleotide produced in step V comprising sequence A at its 5′ end, thereby generating a double stranded polynucleotide comprising non-complementary ends. The ligation can be performed using any of the methods provided herein including, but not limited to, generating a blunt end at the end of the double stranded polynucleotide generated in step V and performing blunt end ligation. Due to the block at the 5′ end, the short strand is not ligated to the strand of the double stranded polynucleotide generated in step V comprising sequence A at a 5′ end, whereby a gap exists. In step VII, the double stranded polynucleotide generated in step VI is subjected to a fill in reaction, whereby the 3′ end of the strand comprising sequence A at its 5′ end is extended using a DNA polymerase comprising strand displacement activity as provided herein using sequence B as a template. Alternatively, the non ligated strand may be removed by an exonuclease activity of the polymerase. Step VII generates a double stranded polynucleotide comprising one strand of the double stranded polynucleotide comprising a strand specific polynucleotide comprising sequence A at a 5; end and sequence B′ at a 3′ end. In some cases, the second adapter of step IV comprises a double stranded adapter, wherein a first strand comprise sequence B and a second strand comprising sequence B′, wherein the first strand comprises a block at both ends, while the second strand comprises a blocking group at the 3′ end. In these cases, ligation of the second adapter generates a double stranded polynucleotide comprising one strand of the double stranded polynucleotide comprising a strand specific polynucleotide comprising sequence A at a 5; end and sequence B′ at a 3′ end without requiring step VII. The strand specific polynucleotide can be amplified using any of the amplification methods provided herein. In some cases, the amplification comprises an amplification reaction using a first primer directed against sequence B′, and a second primer directed against the complement of sequence A, A′. Either or both of the first or second primer can further comprise a non-hybridizable tail, wherein the tail comprises a reverse flow cell sequence, a TruSeq primer sequence and/or a barcode sequence. Following amplification with the first and second primers, an amplification product comprising double stranded polynucleotide sequence appended with non-complementary adapter sequence at each end derived from the ligated adapter and flow cell sequences are generated. The amplification products can be compatible with the next generation sequencing platform as provided herein.

A schematic exemplary of an embodiment of the methods described herein for amplifying a polynucleotide generated by the methods provided herein using SPIA is shown in FIG. 5. In step I, a chimeric amplification primer is hybridized to a polynucleotide comprising sequence A at the 5′ end and sequence B at the 3′ end generated by the methods provided herein. The chimeric amplification primer can comprise a 3′ DNA portion comprising sequence C and a 5′ RNA portion comprising sequence D, wherein sequence C comprises sequence complementary to a portion of sequence B, and wherein sequence D comprises sequence non-hybridizable to the polynucleotide. In step II, an extension reaction is performed using a DNA polymerase comprising RNA dependent DNA polymerase activity, wherein the 3′ end of sequence C is extended using the polynucleotide as template, and wherein the 3′ end of sequence B of the polynucleotide is extended using sequence D as the template, thereby generating a double stranded polynucleotide comprising sequence A and its complement A′ at one end and a heteroduplex comprising RNA sequence D and its DNA complement D′ at the other end. In step III, sequence D is cleaved using RNaseH, wherein a double stranded polynucleotide comprising sequence A and its complement A′ at one end and a 3′ single stranded DNA overhang comprising sequence C on the other end is generated. In step IV, an amplification chimeric primer comprising a 5′ RNA portion complementary to sequence D′ is annealed to sequence D′ and extended using a strand displacement DNA polymerase, wherein the DNA polymerase displaces a single stranded amplification product comprising sequence A′ at the 3′ end and sequence C at the 5′ end, wherein a double stranded polynucleotide comprising sequence A and its complement A′ at one end and a heteroduplex comprising RNA sequence D and its DNA complement D′ at the other end is newly generated. Steps III and IV is then repeated to generate a pool of amplification products.

### VI. Oligonucleotides

The term “oligonucleotide” can refer to a polynucleotide chain, typically less than 200 residues long, e.g., between 15 and 100 nucleotides long, but also intended to encompass longer polynucleotide chains. Oligonucleotides can be single-or double-stranded. The terms “primer” and “oligonucleotide primer” can refer to an oligonucleotide capable of hybridizing to a complementary nucleotide sequence. The term “oligonucleotide” can be used interchangeably with the terms “primer,” “adapter,” and “probe.”

The term “hybridization”/“hybridizing” and “annealing” can be used interchangeably and can refer to the pairing of complementary nucleic acids.

The term “primer” can refer to an oligonucleotide, generally with a free 3′ hydroxyl group, that is capable of hybridizing with a template (such as a target polynucleotide, target DNA, target RNA or a primer extension product) and is also capable of promoting polymerization of a polynucleotide complementary to the template. A primer can contain a non-hybridizing sequence that constitutes a tail of the primer. A primer can still be hybridizing to a target even though its sequences may not fully complementary to the target.

Primers can be oligonucleotides that can be employed in an extension reaction by a polymerase along a polynucleotide template, such as in PCR or cDNA synthesis, for example. The oligonucleotide primer can be a synthetic polynucleotide that is single stranded, containing a sequence at its 3′-end that is capable of hybridizing with a sequence of the target polynucleotide. Normally, the 3′ region of the primer that hybridizes with the target nucleic acid has at least 80%, 90%, 95%, or 100%, complementarity to a sequence or primer binding site.

Primers can be designed according to known parameters for avoiding secondary structures and self-hybridization. Different primer pairs can anneal and melt at about the same temperatures, for example, within about 1, 2, 3, 4, 5, 6, 7, 8, 9 or 10° C. of another primer pair. In some cases, greater than about 1, 2, 3, 4, 5, 6, 7, 8, 9, 10, 15, 20, 25, 30, 35, 40, 45, 50, 100, 200, 500, 1000, 5000, 10,000 or more primers are initially used. Such primers may be able to hybridize to the genetic targets described herein. In some cases, about 2 to about 10,000, about 2 to about 5,000, about 2 to about 2,500, about 2 to about 1,000, about 2 to about 500, about 2 to about 100, about 2 to about 50, about 2 to about 20, about 2 to about 10, or about 2 to about 6 primers are used.

Primers can be prepared by a variety of methods including but not limited to cloning of appropriate sequences and direct chemical synthesis using methods well known in the art (Narang et al., Methods Enzymol. 68:90 (1979); Brown et al., Methods Enzymol. 68:109 (1979)). Primers can also be obtained from commercial sources such as Integrated DNA Technologies, Operon Technologies, Amersham Pharmacia Biotech, Sigma, and Life Technologies. The primers can have an identical melting temperature. The melting temperature of a primer can be about, more than, less than, or at least 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 81, 82, 83, 84, or 85° C. In some cases, the melting temperature of the primer is about 30 to about 85° C., about 30 to about 80° C., about 30 to about 75° C., about 30 to about 70° C., about 30 to about 65° C., about 30 to about 60° C., about 30 to about 55° C., about 30 to about 50° C., about 40 to about 85° C., about 40 to about 80° C., about 40 to about 75° C., about 40 to about 70° C., about 40 to about 65° C., about 40 to about 60° C., about 40 to about 55° C., about 40 to about 50° C., about 50 to about 85° C., about 50 to about 80° C., about 50 to about 75° C., about 50 to about 70° C., about 50 to about 65° C., about 50 to about 60° C., about 50 to about 55° C., about 52 to about 60° C., about 52 to about 58° C., about 52 to about 56° C., or about 52 to about 54° C.

The lengths of the primers can be extended or shortened at the 5′ end or the 3′ end to produce primers with desired melting temperatures. One of the primers of a primer pair can be longer than the other primer. The 3′ annealing lengths of the primers, within a primer pair, can differ. Also, the annealing position of each primer pair can be designed such that the sequence and length of the primer pairs yield the desired melting temperature. An equation for determining the melting temperature of primers smaller than 25 base pairs is the Wallace Rule (Td=2(A+T)+4(G+C)). Computer programs can also be used to design primers, including but not limited to Array Designer Software (Arrayit Inc.), Oligonucleotide Probe Sequence Design Software for Genetic Analysis (Olympus Optical Co.), NetPrimer, and DNAsis from Hitachi Software Engineering. The T_{M} (melting or annealing temperature) of each primer can be calculated using software programs such as Net Primer (free web based program at http://www.premierbiosoft.com/netprimer/index.html). The annealing temperature of the primers can be recalculated and increased after any cycle of amplification, including but not limited to about cycle 1, 2, 3, 4, 5, about cycle 6 to about cycle 10, about cycle 10 to about cycle 15, about cycle 15 to about cycle 20, about cycle 20 to about cycle 25, about cycle 25 to about cycle 30, about cycle 30 to about cycle 35, or about cycle 35 to about cycle 40. After the initial cycles of amplification, the 5′ half of the primers can be incorporated into the products from each loci of interest; thus the T_{M} can be recalculated based on both the sequences of the 5′ half and the 3′ half of each primer.

The annealing temperature of the primers can be recalculated and increased after any cycle of amplification, including but not limited to about cycle 1, 2, 3, 4, 5, about cycle 6 to about cycle 10, about cycle 10 to about cycle 15, about cycle 15 to about cycle 20, about cycle 20 to about cycle 25, about cycle 25 to about cycle 30, about cycle 30 to about 35, or about cycle 35 to about cycle 40. After the initial cycles of amplification, the 5′ half of the primers can be incorporated into the products from each loci of interest, thus the TM can be recalculated based on both the sequences of the 5′ half and the 3′ half of each primer.

“Complementary” can refer to complementarity to all or only to a portion of a sequence. The number of nucleotides in the hybridizable sequence of a specific oligonucleotide primer should be such that stringency conditions used to hybridize the oligonucleotide primer will prevent excessive random non-specific hybridization. Usually, the number of nucleotides in the hybridizing portion of the oligonucleotide primer will be at least as great as the defined sequence on the target polynucleotide that the oligonucleotide primer hybridizes to, namely, at least 5, at least 6, at least 7, at least 8, at least 9, at least 10, at least 11, at least 12, at least 13, at least 14, at least 15, at least about 20, and generally from about 6 to about 10 or 6 to about 12 of 12 to about 200 nucleotides, usually about 10 to about 50 nucleotides. A target polynucleotide can be larger than an oligonucleotide primer or primers as described previously.

In some cases, the identity of the target polynucleotide sequence is known, and hybridizable primers can be synthesized precisely according to the antisense sequence of the aforesaid target polynucleotide sequence. In other cases, when the target polynucleotide sequence is unknown, the hybridizable sequence of an oligonucleotide primer can be a random sequence. Oligonucleotide primers comprising random sequences can be referred to as “random primers”, as described below. In yet other cases, an oligonucleotide primer such as a first primer or a second primer comprises a set of primers such as for example a set of first primers or a set of second primers. In some cases, the set of first or second primers can comprise a mixture of primers designed to hybridize to a plurality (e.g. about, more than, less than, or at least 2, 3, 4, 6, 8, 10, 20, 40, 80, 100, 125, 150, 200, 250, 300, 400, 500, 600, 800, 1000, 1500, 2000, 2500, 3000, 4000, 5000, 6000, 7000, 8000, 10,000, 20,000, or 25,000) target sequences. In some cases, the plurality of target sequences can comprise a group of related sequences, random sequences, a whole transcriptome or fraction (e.g. substantial fraction) thereof, or any group of sequences such as mRNA. Primers for use in the methods provided herein can be any of the primers listed in Tables 1 and 2, which are directed against the first and second adapter sequences listed in Tables 3 and 4, respectively.

TABLE 1
Primer sequences directed against first adapter listed in Table 3.
Primer (5′-3′)

AAGCAGAAGACGGCATACGAGATGAGGTGGCTGCTGTCTTTCCCTCGTTTTCTCAAGCGACAC-
AAGCAGAAGACGGCATACGAGATGAGGTGGTGATCGGAGTGCAGAATCGTGGACTTCTAGTCT-
AAGCAGAAGACGGCATACGAGATGAGGTGGCCCAATGCGTTCTATATGCGTCTCAGCTGCGGC-
AAGCAGAAGACGGCATACGAGATGAGGTGGCTTGCGTGCACGAGAAGCATCGCCTCTCGAAGC
AAGCAGAAGACGGCATACGAGATGAGGTGGTGACTGGAGTTCAGACGTGTGCTCTTCCGATCT
AAGCAGAAGACGGCATACGAGATGAGGTGGTTAGCACTCGGCCGCAATTCTGAGTAATCTGGC-
AAGCAGAAGACGGCATACGAGATGAGGTGGGGCCTGTCGCGGTCCGAGCGATAAGCACGATCT
AAGCAGAAGACGGCATACGAGATGAGGTGGTGACTGCTCATTGTGCATGTGGAGCGATTACCCAGT
AAGCAGAAGACGGCATACGAGATGAGGTGGGCTTGACTGGAGATGCGTAAAGCTTGACGACGATCT-
AAGCAGAAGACGGCATACGAGATGAGGTGGTGATGATACCCGATTCGCACCTGCGAAACGTGTTCTATG-
AAGCAGAAGACGGCATACGAGATGAGGTGGACTTCATACGCAATTCGAATCTACGCCACGTGTTCTTTGCGA-
AAGCAGAAGACGGCATACGAGATGAGGTGGTACGCAATTCGAATCTACGCCACGTGTTCTTTGCGA-
AAGCAGAAGACGGCATACGAGATGAGGTGGGCTTGACTACTGGAGATGCGTAAAGCTTGACGACGATCT-
AAGCAGAAGACGGCATACGAGATGAGGTGGCTTGCGTGCACGAGATTCAGCATCGCCTCTCGAGGAAGC-
AAGCAGAAGACGGCATACGAGATGAGGTGGCTGCTGTCTTTCCCTCGTTTTCTCAAGTTTGCGCAC-
AAGCAGAAGACGGCATACGAGATGAGGTGGTGATCGTCTTGCAGAATCGTGGACAGCTAGTCTGCT-
AAGCAGAAGACGGCATACGAGATGAGGTGGAGATACCGACGCGATGAAGCACGTTGCACCCTT-
AAGCAGAAGACGGCATACGAGATGAGGTGGTCGGATGAGCGAAGTTGCAATCCCGAACTTTCATGC-
AAGCAGAAGACGGCATACGAGATGAGGTGGAGATCGGAATTCCACACGTCTGAATAACAGTCA-
AAGCAGAAGACGGCATACGAGATGAGGTGGGCCGCAGCTGAGACGCATATAGAACGCATTGGGCGA-
AAGCAGAAGACGGCATACGAGATGAGGTGGCTGCTGTCTTTCCCTCGTTTTCTCAAGCGACAC-
AAGCAGAAGACGGCATACGAGATGAGGTGGTGATCGGAGTGCAGAATCGTGGACTTCTAGTCT-
AAGCAGAAGACGGCATACGAGATGAGGTGGCCCAATGCGTTCTATATGCGTCTCAGCTGCGGC-
AAGCAGAAGACGGCATACGAGATGAGGTGGCTTGCGTGCACGAGAAGCATCGCCTCTCGAAGC-
AAGCAGAAGACGGCATACGAGATGAGGTGGTGACTGGAGTTCAGACGTGTGCTCTTCCGATCT-
AAGCAGAAGACGGCATACGAGATGAGGTGGTTAGCACTCGGCCGCAATTCTGAGTAATCTGGC-
AAGCAGAAGACGGCATACGAGATGAGGTGGGGCCTGTCGCGGTCCGAGCGATAAGCACGATCT-
AAGCAGAAGACGGCATACGAGATGAGGTGGTGACTGCTCATTGTGCATGTGGAGCGATTACCCAGT-
AAGCAGAAGACGGCATACGAGATGAGGTGGGCTTGACTGGAGATGCGTAAAGCTTGACGACGATCT-
AAGCAGAAGACGGCATACGAGATGAGGTGGTGATGATACCCGATTCGCACCTGCGAAACGTGTTCTATG-
AAGCAGAAGACGGCATACGAGATGAGGTGGACTTCATACGCAATTCGAATCTACGCCACGTGTTCTTTGCGA-
AAGCAGAAGACGGCATACGAGATGAGGTGGTACGCAATTCGAATCTACGCCACGTGTTCTTTGCGA-
AAGCAGAAGACGGCATACGAGATGAGGTGGGCTTGACTACTGGAGATGCGTAAAGCTTGACGACGATCT-
AAGCAGAAGACGGCATACGAGATGAGGTGGCTTGCGTGCACGAGATTCAGCATCGCCTCTCGAGGAAGC-
AAGCAGAAGACGGCATACGAGATGAGGTGGCTGCTGTCTTTCCCTCGTTTTCTCAAGTTTGCGCAC-
AAGCAGAAGACGGCATACGAGATGAGGTGGTGATCGTCTTGCAGAATCGTGGACAGCTAGTCTGCT-
AAGCAGAAGACGGCATACGAGATGAGGTGGAGATACCGACGCGATGAAGCACGTTGCACCCTT-
AAGCAGAAGACGGCATACGAGATGAGGTGGTCGGATGAGCGAAGTTGCAATCCCGAACTTTCATGC-
AAGCAGAAGACGGCATACGAGATGAGGTGGAGATCGGAATTCCACACGTCTGAATAACAGTCA-
AAGCAGAAGACGGCATACGAGATGAGGTGGGCCGCAGCTGAGACGCATATAGAACGCATTGGGCGA-

TABLE 2
Primer sequences directed against second adapter listed in
Table 4.
Primer (5′-3′)

AATCTGACGATAACCGATGAGTCATACTCGCTTGGACTATACGACTGCCTTGTTCA
AATCTGACGATAACCGATGAGTCATACTCGCTTGGACTATACGACTGCCTTGTTCA
TTCGCATTACGTCTCGCATCTTACGATGGAGATCGTGCTGCTCTGGATACTGGCGA
AATGATTCCCGTTGCTCAATGGGAAGGCTTCTACACGACTGCGACCGCCG
GCTACTCAGACGGCGACCTGCGCTTTGTGCTCTCGAAGCCGTCACGACCGAGTGGCCCA
CCTGATCCAGCGAGCTCATTGGAGATCTACACTCTGTATGTTGGCATTGACCCAGACTCCTT
AATGATACGGCGACCACCGAGATCTACACTCTTTCCCTACACGACGCTCTTCCGAT
AATCCAACGGCGGCTGGTGAGATCTACACTGAAGGAATGCTACACGACGTTAGACCCTT
TCGGACACGACGACTAGCGTCATGTGCTCTCATTCCCTACACGACCATCTGCACTT
AATGATACATCGACCTACGAGATCTACTGTGACGCTCCACTCGACGTCGTAGCTTA
TTTGATACGACCTCAGTGGAGATCTACACTCTTTCCCTAGATGACGCTGAAACTAG
ATTGTGACGATAACGGATGTGTCATACTCGCTTTGCCTAATCGACACGCTTCTTGA
AATCTGACGATAACCGATGAGTCATACTCGCTTGGACTATACGACTGCGAACTTGTTCA
TTTGATACGACCTCAGTGGAGATCTACACTCTTTCCCTAGATGACGCTTCTCGAGAAACTAG
AATGATACGTTTGCGACCACCGAGATCTACACTCTTTCCCTACACGACAGAGTTCCGATC
TCGGACACGACGACTAGCGTCATGTGCTCTCATTCCCTACACGACTGTCTGCAGCAT
AAGGTTTCCCGTTGCTCGATGGCAAGGCATGTACTCGACCGTGACGGTCCGG
TCGTTCACGACGACTAGCCTCATGTGCTCTCTTTGCCTACGTCTCGAACTGTAGGTAG
TCGTTCACGACGACTAGCCTCATGTGCTCTCTTTGCCTACGTCTCGTCGTCTTCCTCT
TACCTTACGCCGACCACCGACTACTAGACTGTATGCCTACACGACTCAGATGAAGTT
TGAACAAGGCAGTCGTATAGTCCAAGCGAGTATGACTCATCGGTTATCGTCAGATT
TGAACAAGGCAGTCGTATAGTCCAAGCGAGTATGACTCATCGGTTATCGTCAGATT
TCGCCAGTATCCAGAGCAGCACGATCTCCATCGTAAGATGCGAGACGTAATGCGAA
CGGCGGTCGCAGTCGTGTAGAAGCCTTCCCATTGAGCAACGGGAATCATT
TGGGCCACTCGGTCGTGACGGCTTCGAGAGCACAAAGCGCAGGTCGCCGTCTGAGTAGC
AAGGAGTCTGGGTCAATGCCAACATACAGAGTGTAGATCTCCAATGAGCTCGCTGGATCAGG
ATCGGAAGAGCGTCGTGTAGGGAAAGAGTGTAGATCTCGGTGGTCGCCGTATCATT
AAGGGTCTAACGTCGTGTAGCATTCCTTCAGTGTAGATCTCACCAGCCGCCGTTGGATT
AAGTGCAGATGGTCGTGTAGGGAATGAGAGCACATGACGCTAGTCGTCGTGTCCGA
TAAGCTACGACGTCGAGTGGAGCGTCACAGTAGATCTCGTAGGTCGATGTATCATT
CTAGTTTCAGCGTCATCTAGGGAAAGAGTGTAGATCTCCACTGAGGTCGTATCAAA
TCAAGAAGCGTGTCGATTAGGCAAAGCGAGTATGACACATCCGTTATCGTCACAAT
TGAACAAGTTCGCAGTCGTATAGTCCAAGCGAGTATGACTCATCGGTTATCGTCAGATT
CTAGTTTCTCGAGAAGCGTCATCTAGGGAAAGAGTGTAGATCTCCACTGAGGTCGTATCAAA
GATCGGAACTCTGTCGTGTAGGGAAAGAGTGTAGATCTCGGTGGTCGCAAACGTATCATT
ATGCTGCAGACAGTCGTGTAGGGAATGAGAGCACATGACGCTAGTCGTCGTGTCCGA
CCGGACCGTCACGGTCGAGTACATGCCTTGCCATCGAGCAACGGGAAACCTT
CTACCTACAGTTCGAGACGTAGGCAAAGAGAGCACATGAGGCTAGTCGTCGTGAACGA
AGAGGAAGACGACGAGACGTAGGCAAAGAGAGCACATGAGGCTAGTCGTCGTGAACGA
AACTTCATCTGAGTCGTGTAGGCATACAGTCTAGTAGTCGGTGGTCGGCGTAAGGTA

The term “adapter” can refer to an oligonucleotide of known sequence, the ligation of which to a target polynucleotide or a target polynucleotide strand of interest enables the generation of amplification-ready products of the target polynucleotide or the target polynucleotide strand of interest. Various adapter designs can be used. Suitable adapter molecules include single or double stranded nucleic acid (DNA, RNA, or a combination thereof) molecules or derivatives thereof, stem-loop nucleic acid molecules, double stranded molecules comprising one or more single stranded overhangs of 1, 2, 3, 4, 5, 6, 7, 8, 9, 10 bases or longer, proteins, peptides, aptamers, organic molecules, small organic molecules, or any adapter molecules known in the art that can be covalently or non-covalently attached, such as for example by ligation, to the double stranded nucleic acid fragments. The adapters can be designed to comprise a double-stranded portion which can be ligated to double-stranded nucleic acid (or double-stranded nucleic acid with overhang) products.

Adapter oligonucleotides can have any suitable length, at least sufficient to accommodate the one or more sequence elements of which they are comprised. In some cases, adapters are about, less than about, or more than about 10, 15, 20, 25, 30, 35, 40, 45, 50, 55, 60, 65, 70, 75, 80, 90, 100, 200, or more nucleotides in length. In some cases, the adapter is stem-loop or hairpin adapter, wherein the stem of the hairpin adapter is about, less than about, or more than about 1, 2, 3, 4, 5, 6, 7, 8, 9, 10, 11, 12, 13, 14, 15, 20, 25, 30, 35, 40, 45, 50, 75, 100, or more nucleotides in length. Stems can be designed using a variety of different sequences that result in hybridization between the complementary regions on a hairpin adapter, resulting in a local region of double-stranded DNA. For example, stem sequences can be utilized that are from 15 to 18 nucleotides in length with equal representation of G:C and A:T base pairs. Such stem sequences are predicted to form stable dsDNA structures below their predicted melting temperatures of .about.45 degree C. Sequences participating in the stem of the hairpin can be perfectly complementary, such that each base of one region in the stem hybridizes via hydrogen bonding with each base in the other region in the stem according to Watson-Crick base-pairing rules. Alternatively, sequences in the stem can deviate from perfect complementarity. For example, there can be mismatches and or bulges within the stem structure created by opposing bases that do not follow Watson-Crick base pairing rules, and/or one or more nucleotides in one region of the stem that do not have the one or more corresponding base positions in the other region participating in the stem. Mismatched sequences can be cleaved using enzymes that recognize mismatches. The stem of a hairpin can comprise DNA, RNA, or both DNA and RNA. In some cases, the stem and/or loop of a hairpin, or one or both of the hybridizable sequences forming the stem of a hairpin, comprise nucleotides, bonds, or sequences that are substrates for cleavage, such as by an enzyme, including but not limited to endonucleases and glycosylases. The composition of a stem can be such that only one of the hybridizable sequences forming the stem is cleaved. For example, one of the sequences forming the stem can comprise RNA while the other sequence forming the stem consists of DNA, such that cleavage by an enzyme that cleaves RNA in an RNA-DNA duplex, such as RNase H, cleaves only the sequence comprising RNA. One or both strands of a stem and/or loop of a hairpin can comprise about, more than, less than, or at least 1, 2, 3, 4, 5, 6, 7, 8, 9, 10, 11, 12, 13, 14, 15, 16, 17, 18, 19, or 20 non-canonical nucleotides (e.g. uracil), and/or methylated nucleotides. In some cases, the loop sequence of a hairpin adapter is about, less than about, or more than about 5, 10, 15, 20, 25, 30, 35, 40, 45, 50, or more nucleotides in length.

An adapter can comprise at least two nucleotides covalently linked together. An adapter as used herein can contain phosphodiester bonds, although in some cases, as outlined below, nucleic acid analogs are included that can have alternate backbones, comprising, for example, phosphoramide (Beaucage et al., Tetrahedron 49(10):1925 (1993) and references therein; Letsinger, J. Org. Chem. 35:3800 (1970); Sprinzl et al., Eur. J. Biochem. 81:579 (1977); Letsinger et al., Nucl. Acids Res. 14:3487 (1986); Sawai et al, Chem. Lett. 805 (1984), Letsinger et al., J. Am. Chem. Soc. 110:4470 (1988); and Pauwels et al., Chemica Scripta 26:141 91986)), phosphorothioate (Mag et al., Nucleic Acids Res. 19:1437 (1991); and U.S. Pat. No. 5,644,048), phosphorodithioate (Briu et al., J. Am. Chem. Soc. 111:2321 (1989), O-methylphosphoroamidite linkages (see Eckstein, Oligonucleotides and Analogues: A Practical Approach, Oxford University Press), and peptide nucleic acid (also referred to herein as “PNA”) backbones and linkages (see Egholm, J. Am. Chem. Soc. 114:1895 (1992); Meier et al., Chem. Int. Ed. Engl. 31:1008 (1992); Nielsen, Nature, 365:566 (1993); Carlsson et al., Nature 380:207 (1996), all of which are incorporated by reference). Other analog nucleic acids include those with bicyclic structures including locked nucleic acids (also referred to herein as “LNA”), Koshkin et al., J. Am. Chem. Soc. 120.13252 3 (1998); positive backbones (Denpcy et al., Proc. Natl. Acad. Sci. USA 92:6097 (1995); non-ionic backbones (U.S. Pat. Nos. 5,386,023, 5,637,684, 5,602,240, 5,216,141 and 4,469,863; Kiedrowshi et al., Angew. Chem. Intl. Ed. English 30:423 (1991); Letsinger et al., J. Am. Chem. Soc. 110:4470 (1988); Letsinger et al., Nucleoside & Nucleotide 13:1597 (1994); Chapters 2 and 3, ASC Symposium Series 580, “Carbohydrate Modifications in Antisense Research”, Ed. Y. S. Sanghui and P. Dan Cook; Mesmaeker et al., Bioorganic & Medicinal Chem. Lett. 4:395 (1994); Jeffs et al., J. Biomolecular NMR 34:17 (1994); Tetrahedron Lett. 37:743 (1996)) and non-ribose backbones, including those described in U.S. Pat. Nos. 5,235,033 and 5,034,506, and Chapters 6 and 7, ASC Symposium Series 580, “Carbohydrate Modifications in Antisense Research”, Ed. Y. S. Sanghui and P. Dan Cook. Nucleic acids containing one or more carbocyclic sugars are also included within the definition of nucleic acids (see Jenkins et al., Chem. Soc. Rev. (1995) pp 169 176). Several nucleic acid analogs are described in Rawls, C & E News Jun. 2, 1997 page 35. “Locked nucleic acids” are also included within the definition of nucleic acid analogs. LNAs are a class of nucleic acid analogues in which the ribose ring is “locked” by a methylene bridge connecting the 2′-O atom with the 4′-C atom. All of these references are hereby expressly incorporated by reference. These modifications of the ribose-phosphate backbone can be done to increase the stability and half-life of such molecules in physiological environments. For example, PNA:DNA and LNA-DNA hybrids can exhibit higher stability and thus can be used in some cases. Adapters can be single stranded or double stranded, as specified, or contain portions of both double stranded or single stranded sequence. Depending on the application, adapters can be DNA, RNA, or a hybrid, where the adapter contains any combination of deoxyribo- and ribo-nucleotides, and any combination of bases, including uracil, adenine, thymine, cytosine, guanine, inosine, xathanine hypoxathanine, isocytosine, isoguanine, etc.

As illustrated in FIG. 2, the first adapter as provided herein can be a double stranded nucleic acid or single stranded nucleic acid comprising a 3′ overhang. As shown in I of FIG. 2, the first adapter comprises a partial duplex between two oligonucleotides, wherein a first oligonucleotide comprises a long strand comprising a known sequence, A, at the 5′ end and a 3′ overhang and a second oligonucleotide comprises a short strand comprising sequence complementary to sequence A, A′, at the 3′ end. The short strand in I of FIG. 2 further comprises a block at the 3′ and 5′ end, which can serve to inhibit ligation. In some cases, the long strand comprises a block at the 5′ end, thereby inhibiting ligation. As shown in II of FIG. 2, the first adapter comprises a single stranded oligonucleotide, wherein the 5′ end of the oligonucleotide binds to a known sequence, A, located near the 3′ end of the oligonucleotide, wherein the 5′ end comprises sequence complementary to sequence A, A′, and wherein the binding produces a 3′ overhang. The 5′ end and 3′ end of the single stranded oligonucleotide adapter in II of FIG. 2 can be connected through a linker. The linker can be a stem loop, non-nucleotide linker, or a combination thereof. The stem loop can comprise DNA, RNA, nucleotide analogs, or combinations thereof. The 5′ end of the single stranded oligonucleotide adapter in II of FIG. 2 can comprise a 5′ block, which can inhibit ligation. Various constructs for useful second adaptors are anticipated. The second adaptors useful for carrying out the methods for producing directional polynucleotide libraries as provided herein can be dsDNA, partial duplex or stem-loop adaptors with one end suitable for ligation to the end of the dsDNA products produced by the methods provided herein, and the like. In some cases, a second adapter comprises a partial duplex between two oligonucleotides, wherein a first oligonucleotide comprises a long strand comprising a known sequence, B, and a second oligonucleotide comprising a short strand comprising sequence complementary to a portion of sequence B, B′, wherein binding between the long strand and short strand generates a 3′ overhang. The short strand of the second adapter can further comprise a block at the 3′ and/or 5′ end, which can serve to inhibit ligation. The 3′ end of the long strand can comprise a block at the 3′ end. In some cases, a second adapter comprises a partial duplex between two oligonucleotides, wherein a first oligonucleotide comprises a long strand comprising a known sequence, B, and a second oligonucleotide comprising a short strand comprising sequence complementary to a portion of sequence B, B′, wherein binding between the long strand and short strand generates a 5′ overhang. The short strand of the second adapter can further comprise a block at the 5′ end, which can serve to inhibit ligation. The 3′ and/or 5′ end of the long strand can comprise a block, which can inhibit ligation. A block in any of the adapters provided herein can be any of the blocks provided herein. Adapters for use in the methods provided herein can be any of the first and/or second adapters listed in Tables 3 and 4.

TABLE 3
First adapter sequences for use in the methods provided herein.

| Oligo A | Oligo B |
|---|---|
| CTG CTG TCT TTC CCT CGT TTT CTC AAG | /5BioTEG/GTG TCG CTT GAG AAA ACG AGG GAA |
| CGA CAC NNN NNN NNN | AGA CAG CAG/3AmMC6T/ |
| TGA TCG GAG TGC AGA ATC GTG GAC TTC | /5BiodT/AGA CTA GAA GTC CAC GAT TCT GCA CTC |
| TAG TCT NNN NNN | CGA TCA/3AzideN/ |
| CCC AAT GCG TTC TAT ATG CGT CTC AGC | /5Biosg/GCC GCA GCT GAG ACG CAT ATA GAA CGC |
| TGC GGC NNN NNN N | ATT GGG/3AmMC6T/ |
| CTT GCG TGC ACG AGA AGC ATC GCC TCT | /5BioTEG/GCT TCG AGA GGC GAT GCT TCT CGT |
| CGA AGC NNN NNN NN | GCA CGC AAG/3ThiolMCD-6/ |
| TGA CTG GAG TTC AGA CGT GTG CTC TTC | /5Biosg/AGA TCG GAA GAG CAC ACG TCT GAA CTC |
| CGA TCT NNN NNN NN | CAG TCA/3AmMO/ |
| TTA GCA CTC GGC CGC AAT TCT GAG TAA | /5DTPA/GCC AGA TTA CTC AGA ATT GCG GCC |
| TCT GGC NNN NNN NNN | GAGTGC TAA/3AmMC6T/ |
| GGC CTG TCG CGG TCC GAG CGA TAA GCA | /5DPTA/ACT GGG TAA TCG CTC CAC ATG CAC AAT |
| CGA TCT NNN NNN NNN N | GAG CAG TCA/3AmMO/ |
| TGA CTG CTC ATT GTG CAT GTG GAG CGA | /5DPTA/ACT GGG TAA TCG CTC CAC ATG CAC AAT |
| TTA CCC AGT NNN NNN NN | GAG CAG TCA/3AmMO/ |
| GCT TGA CTG GAG ATG CGT AAA GCT TGA | /52-Bio/AGA TCG TCG TCA AGC TTT AGC CAT CTC |
| CGA CGA TCT NNN NNN | CAG TCA AGC/3AmMO/ |
| TGA TGA TAC CCG ATT CGC ACC TGC GAA | /5BioTEG/CAT AGA ACA CGT TTC GCA GGT GCG |
| ACG TGT TCT ATG NNN NNNNN | AAT CGG GTA TCA TCA/33ThiolMC3-D/ |
| ACT TCA TAC GCA ATT CGA ATC TAC GCC | /5BioTEG/TCG CAA AGA ACA CGT GGC GTA GAT |
| ACG TGT TCT TTG CGA NNN NNNNN | TCG AAT TGC GTA TGA AGT/33ThiolMC3-D/ |
| TAC GCA ATT CGA ATC TAC GCC ACG TGT | /5BioTEG/TCG CAA AGA ACA CGT GGC GTA GAT |
| TCT TTG CGA NNN NNNNN | TCG AAT TGC GTA/33ThiolMC3-D/ |
| GCT TGA CTA CTG GAG ATG CGT AAA GCT | /52-Bio/AGA TCG TCG TCA AGC TTT AGC CAT CTC |
| TGA CGA CGA TCT NNN NNN | CAG TAG TCA AGC/3AmMO/ |
| CTT GCG TGC ACG AGA TTC AGC ATC GCC | /5BioTEG/GCT TCC TCG AGA GGC GAT GCT GAA TCT |
| TCT CGA GGA AGC NNN NNN NN | CGT GCA CGC AAG/3ThiolMCD-6/ |
| CTG CTG TCT TTC CCT CGT TTT CTC AAG | /5BioTEG/GTG CGC AAA CTT GAG AAA ACG AGG |
| TTT GCG CAC NNN NNN NNN | GAA AGA CAG CAG/3AmMC6T/ |
| TGA TCG TCT TGC AGA ATC GTG GAC AGC | /5BiodT/AGC AGA CTA GCT GTC CAC GAT TCT GCA |
| TAG TCT GCT NNN NNN | AGA CGA TCA/3AzideN/ |
| AGA TAC CGA CGC GAT GAA GCA CGT TGC | /5BioTEG/AAG GGT GCA ACG TGC TTC ATC GCG |
| ACC CTT-NNN-NNN-NN | TCG GTA TCT/3AmMC6T/ |
| TCG GAT GAG CGA AGT TGC AAT CCC GAA | /5BioTEG/GCA TGA AAG TTC GGG ATT GCA ACT |
| CTT TCA TGC-NNN-NNN | TCG CTC ATC CGA/3ThiolMCD-6/ |
| AGA TCG GAA TTC CAC ACG TCT GAA TAA | /5BioTEG/TGA CTG TTA TTC AGA CGT GTG |
| CAG TCA-NNN-NNN-N | GAA TTC CGA TCT/3ThiolMCD-6/ |
| GCC GCA GCT GAG ACG CAT ATA GAA CGC | /5Biosg/TCG CCC AAT GCG TTC TAT ATG |
| ATT GGG CGA NNN NNN N | CGT CTC AGC TGC GGC/3AmMC6T/ |
| */5Biosg/TCG CCC AAT GCG TTC TAT ATG | |
| CGT CTC AGC TGC GGC ATT CAA GCC GCA | |
| GCT GAG ACG CAT ATA GAA CGC ATT GGG | |
| CGA NNN NNN N | |
| *Single stranded stem-loop first adapter; | |
| underlined sequence represents loop nucleotides | |
| */5DPTA/ACT GGG TAA TCG CTC CAC ATG | |
| CAC AAT GAG CAG TCA ATT CAA TGA CTG | |
| CTC ATT GTG CAT GTG GAG CGA TTA CCC | |
| AGT NNN NNN NN | |
| *Single stranded stem-loop first adapter; | |
| underlined sequence represents loop nucleotides | |
| */5BioTEG/GTG TCG CTT GAG AAA ACG AGG | |
| GAA AGA CAG CAG ATT CAA CTG CTG TCT | |
| TTC CCT CGT TTT CTC AAG CGA CAC NNN | |
| NNN NNN | |
| *Single stranded stem-loop first adapter; | |
| underlined sequence represents loop nucleotides | |

TABLE 4
Second adapter sequences for use in the methods provided herein.

| Oligo A | Oligo B |
|---|---|
| AATCTGACGATAACCGATGAGTCATACTCG | /5BioTEG/A*GTGCATCCTAG*/3ddC/ |
| CTTGGACTATACGACTGCCTTGTTCAGT | |
| AATCTGACGATAACCGATGAGTCATACTCG | /5Biosg/A*CTGAACAAGGC*/3ddA/ |
| CTTGGACTATACGACTGCCTTGTTCAGT | |
| TTCGCATTACGTCTCGCATCTTACGATGGA | /52-Bio/G*TTCGCCAGTAT*/3ddC/ |
| GATCGTGCTGCTCTGGATACTGGCGAAC | |
| AATGATTCCCGTTGCTCAATGGGAAGGCTT | /5Biosg/T*CCGGCGGTCGC*/3ddA/ |
| CTACACGACTGCGAC CGCCGGA | |
| GCTACTCAGACGGCGACCTGCGCTTTGTGC | 5DPTA/G*ACTGGGCCACTC*/3ddG/ |
| TCTCGAAGCCGTCACGACCGAGTGGCCCAG | |
| TC | |
| CCTGATCCAGCGAGCTCATTGGAGATCTAC | /5BioTEG/T*CAAGGAGTCTG*/3ddG/ |
| ACTCTGTATGTTGGCATTGACCCAGACTCC | |
| TTGA | |
| AATGATACGGCGACCACCGAGATCTACACT | /5Biosg/A*GATCGGAAGAG*/3ddC/ |
| CTTTCCCTACACGACGCTCTTCCGATCT | |
| AATCCAACGGCGGCTGGTGAGATCTACACT | /5Biosg/T*CAAGGGTCTAA*/3ddC/ |
| GAAGGAATGCTACACGACGTTAGACCCTTG | |
| A | |
| TCGGACACGACGACTAGCGTCATGTGCTCT | /5BioTEG/A*CAAGTGCAGAT*/3ddG/ |
| CATTCCCTACACGACCATCTGCACTTGT | |
| AATGATACATCGACCTACGAGATCTACTGT | /5Biosg/A*TAAGCTACGA*/3ddC/ |
| GACGCTCCACTCGACGTCGTAGCTTAGT | |
| TTTGATACGACCTCAGTGGAGATCTACACT | /5Biosg/C*GCTAGTTTCAG*/3ddC/ |
| CTTTCCCTAGATGACGCTGAAACTAGCG | |
| ATTGTGACGATAACGGATGTGTCATACTCG | /5BioTEG/C*ATCAAGAAGCG*/3ddT/ |
| CTTTGCCTAATCGACACGCTTCTTGATG | |
| AATCTGACGATAACCGATGAGTCATACTCG | /5Biosg/A*CTGAACAAGTTCGC*/3ddA/ |
| CTTGGACTATACGACTGCGAACTTGTTCAG | |
| T | |
| TTTGATACGACCTCAGTGGAGATCTACACT | /5Biosg/C*GCTAGTTTCTCGAGAAG*/3ddC/ |
| CTTTCCCTAGATGACGCTTCTCGAGAAACT | |
| AGCG | |
| AATGATACGTTTGCGACCACCGAGATCTAC | /5Biosg/T*AGATCGGAACTC*/3ddT/ |
| ACTCTTTCCCTACACGACAGAGTTCCGATC | |
| TA | |
| TCGGACACGACGACTAGCGTCATGTGCTCT | /5BioTEG/T*CATGCTGCAGAC*/3ddA/ |
| CATTCCCTACACGACTGTCTGCAGCATGA | |
| AAGGTTTCCCGTTGCTCGATGGCAAGGCAT | /5Biosg/C*TCCGGACCGTCAC*/3ddG/ |
| GTACTCGACCGTGACGGTCCGGAG | |
| TCGTTCACGACGACTAGCCTCATGTGCTCT | /5BioTEG/T*ACTACCTACAGTT*/3ddC/ |
| CTTTGCCTACGTCTCGAACTGTAGGTAGTA | |
| TCGTTCACGACGACTAGCCTCATGTGCTCT | /5DPTA/C*GAGAGGAAGACGA*/3ddC/ |
| CTTTGCCTACGTCTCGTCGTCTTCCTCTCG | |
| TACCTTACGCCGACCACCGACTACTAGACT | /5DPTA/A*CAACTTCATCTG*/3ddA/ |
| GTATGCCTACACGACTCAGATGAAGTTGT | |

Various ligation processes and reagents are known in the art and can be useful for carrying out the methods provided herein. For example, blunt ligation can be employed. Similarly, a single dA nucleotide can be added to the 3′-end of the double-stranded DNA product, by a polymerase lacking 3′-exonuclease activity and can anneal to an adapter comprising a dT overhang (or the reverse). This design allows the hybridized components to be subsequently ligated (e.g., by T4 DNA ligase). Other ligation strategies and the corresponding reagents and known in the art and kits and reagents for carrying out efficient ligation reactions are commercially available (e.g, from New England Biolabs, Roche).

### VII. Blocking Groups

Any of the adapters and/or primers used in the methods for generating directional polynucleotide libraries as provided herein can comprise a blocking group at the 5′ and/or 3′ end. Adapters and/or primers comprising a duplex or partial duplex can comprise a block at the 5′ and/or 3′ end of one or both strands forming the duplex or partial duplex. A blocked end in any of the adapters or primers provided herein can be enzymatically unreactive to prevent adapter dimer formation and/or ligation. The blocking group can be a dideoxynucleotide (ddCMP, ddAMP, ddTMP, or ddGMP), various modified nucleotides (e.g. phosphorothioate-modified nucleotides), or non-nucleotide chemical moieties. In some cases, the blocking group comprises a nucleotide analog that comprises a blocking moiety. The blocking moiety can mean a part of the nucleotide analog that inhibits or prevents the nucleotide analog from forming a covalent linkage to a second nucleotide or nucleotide analog. For example, in the case of nucleotide analogs having a pentose moiety, a reversible blocking moiety can prevent formation of a phosphodiester bond between the 3′ oxygen of the nucleotide and the 5′ phosphate of the second nucleotide. Reversible blocking moieties can include phosphates, phosphodiesters, phosphotriesters, phosphorothioate esters, and carbon esters. In some cases, a blocking moiety can be attached to the 3′ position or 2′ position of a pentose moiety of a nucleotide analog. A reversible blocking moiety can be removed with a deblocking agent. The blocking group at a 5′ and/or 3′ end can be a spacer (C3 phosphoramidite, triethylene glycol (TEG), photo-cleavable, hexa-ethyleneglycol), inverted dideoxy-T, biotin, thiol, dithiol, hexanediol, digoxigenin, an azide, alkynes, or an amino modifier. A biotin blocking group can be photocleavable biotin, biotin-triethylene glycol (TEG), biotin-dT, desthiobiotin-TEG, biotin-azide, or dual biotin. A block at a 5′ end can comprise a nucleotide at a 5′ end that lacks a 5′ phosphate. The 5′ end can be removed by treatment with an enzyme. The enzyme can be a phosphatase. A block at a 3′ end can comprise a nucleotide that lacks a free 3′ hydroxyl. The ends (i.e. 5′ and/or 3′ ends) can further comprise phosphothioate bonds. The phosphothioate bonds can serve to protect any adapter or primer comprising the phosphothioate bond. The protection can be from nuclease degradation.

### VIII. RNA-Dependent DNA Polymerases

RNA-dependent DNA polymerases for use in the methods and compositions provided herein can be capable of effecting extension of a primer according to the methods provided herein. Accordingly, an RNA-dependent DNA polymerase can be one that is capable of extending a nucleic acid primer along a nucleic acid template that is comprised at least predominantly of ribonucleotides. Suitable RNA-dependent DNA polymerases for use in the methods, compositions, and kits provided herein include reverse transcriptases (RTs). RTs are well known in the art. Examples of RTs include, but are not limited to, moloney murine leukemia virus (M-MLV) reverse transcriptase, human immunodeficiency virus (HIV) reverse transcriptase, rous sarcoma virus (RSV) reverse transcriptase, avian myeloblastosis virus (AMV) reverse transcriptase, rous associated virus (RAV) reverse transcriptase, and myeloblastosis associated virus (MAV) reverse transcriptase or other avian sarcoma-leukosis virus (ASLV) reverse transcriptases, and modified RTs derived therefrom. See e.g. U.S. Pat. No. 7,056,716. Many reverse transcriptases, such as those from avian myeoloblastosis virus (AMV-RT), and Moloney murine leukemia virus (MMLV-RT) comprise more than one activity (for example, polymerase activity and ribonuclease activity) and can function in the formation of the double stranded cDNA molecules. However, in some instances, it is preferable to employ a RT which lacks or has substantially reduced RNase H activity. RTs devoid of RNase H activity are known in the art, including those comprising a mutation of the wild type reverse transcriptase where the mutation eliminates the RNase H activity. Examples of RTs having reduced RNase H activity are described, e.g., in US20100203597. In these cases, the addition of an RNase H from other sources, such as that isolated from E. coli, can be employed for the degradation of the starting RNA sample and the formation of the double stranded cDNA. Combinations of RTs can also contemplated, including combinations of different non-mutant RTs, combinations of different mutant RTs, and combinations of one or more non-mutant RT with one or more mutant RT.

### IX. DNA-Dependent DNA Polymerases

DNA-dependent DNA polymerases for use in the methods and compositions provided herein can be capable of effecting extension of a nucleic acid comprising a free 3′ hydroxyl. The nucleic acid comprising a free 3′ hydroxyl can be on a primer and/or adapter as provided herein. The nucleic acid comprising a free 3′ hydroxyl can be on a strand of a dsDNA (e.g. genomic DNA) generated by treatment of the dsDNA (e.g. genomic DNA) with a nicking enzyme. A DNA-dependent DNA polymerase can be one that is capable of extending a free 3′ OH along a first strand cDNA in the presence of the RNA template or after selective removal of the RNA template. Exemplary DNA dependent DNA polymerases suitable for the methods provided herein include but are not limited to Klenow polymerase, with or without 3′-exonuclease, Bst DNA polymerase, Bca polymerase, .phi.29 DNA polymerase, Vent polymerase, Deep Vent polymerase, Taq polymerase, T4 polymerase, and E. coli DNA polymerase 1, derivatives thereof, or mixture of polymerases. In some cases, the polymerase does not comprise a 5′-exonuclease activity. In other cases, the polymerase comprises 5′ exonuclease activity. In some cases, the extension of a free 3′ OH can be performed using a polymerase comprising strong strand displacement activity such as, for example, Bst polymerase. In other cases, the extension of the free 3′ OH can be performed using a polymerase comprising weak or no strand displacement activity. One skilled in the art can recognize the advantages and disadvantages of the use of strand displacement activity during any extension step in the methods provided herein, and which polymerases can be expected to provide strand displacement activity (see e.g., New England Biolabs Polymerases). For example, strand displacement activity can be useful in ensuring whole transcriptome coverage during the random priming and extension step or ensuring whole genomc coverage during the extension step following treatment of genomic DNA with a nicking enzyme.

In some cases, the double stranded products or fragments generated by the methods described herein can be end repaired to produce blunt ends for the adapter ligation applications described herein. Generation of the blunt ends on the double stranded products can be generated by the use of a single strand specific DNA exonuclease such as for example exonuclease 1, exonuclease 7 or a combination thereof to degrade overhanging single stranded ends of the double stranded products. Alternatively, the double stranded products can be blunt ended by the use of a single stranded specific DNA endonuclease for example but not limited to mung bean endonuclease or S1 endonuclease. Alternatively, the double stranded products can be blunt ended by the use of a polymerase that comprises single stranded exonuclease activity such as for example T4 DNA polymerase, any other polymerase comprising single stranded exonuclease activity or a combination thereof to degrade the overhanging single stranded ends of the double stranded products or fragments. In some cases, the polymerase comprising single stranded exonuclease activity can be incubated in a reaction mixture that does or does not comprise one or more dNTPs. In other cases, a combination of single stranded nucleic acid specific exonucleases and one or more polymerases can be used to blunt end the double stranded products of the extension reaction. In still other cases, the products of an extension reaction as provided herein can be made blunt ended by filling in the overhanging single stranded ends of the double stranded products. For example, the fragments can be incubated with a polymerase such as T4 DNA polymerase or Klenow polymerase or a combination thereof in the presence of one or more dNTPs to fill in the single stranded portions of the double stranded products. Alternatively, the double stranded products or fragments can be made blunt by a combination of a single stranded overhang degradation reaction using exonucleases and/or polymerases, and a fill-in reaction using one or more polymerases in the presence of one or more dNTPs.

In another embodiment, the adapter ligation applications described herein can leave a gap between one strand (e.g. non-ligation strand) of an adapters and a strand of a double stranded product or fragment. In these instances, a gap repair or fill-in reaction can be used to append the double stranded product or fragment with the sequence complementary to the other strand (e.g. ligation strand) of the adapter. Gap repair can be performed with any number of DNA dependent DNA polymerase described herein. In some cases, gap repair can be performed with a DNA dependent DNA polymerase with strand displacement activity. In some cases, gap repair can be performed using a DNA dependent DNA polymerase with weak or no strand displacement activity. In some cases, the ligation strand of the adapter can serve as the template for the gap repair or fill-in reaction. In some cases, gap repair can be performed using Taq DNA polymerase.

### X. Cleavage Agents

The selective removal or cleavage of a polynucleotide comprising a non-canonical dNTP generated by the methods provided herein can be achieved through the use of enzymatic treatment of the polynucleotide. Enzymes that can be used for cleavage of the marked strand generated by the methods provided herein can include glycosylases such as Uracil-N-Glycosylase (UNG), which can selectively degrade the base portion of dUTP. Additional glycosylases which can be used to generate a first strand cDNA or polynucleotides comprising one or more non-canonical nucleotides as provided herein and their non-canonical or modified nucleotide substrates include 5-methylcytosine DNA glycosylase (5-MCDG), which can cleave the base portion of 5-methylcytosine (5-MeC) from the DNA backbone (Wolffe et al., Proc. Nat. Acad. Sci. USA 96:5894-5896, 1999); 3-methyladenosine-DNA glycosylase I, which can cleave the base portion of 3-methyl adenosine from the DNA backbone (see, e.g. Hollis et al (2000) Mutation Res. 460: 201-210); and/or 3-methyladenosine DNA glycosylase II, which can cleave the base portion of 3-methyladenosine, 7-methylguanine, 7-methyladenosine, and/3-methylguanine from the DNA backbone. See McCarthy et al (1984) EMBO J. 3:545-550. Multifunctional and mono-functional forms of 5-MCDG have been described. See Zhu et al., Proc. Natl. Acad. Sci. USA 98:5031-6, 2001; Zhu et al., Nuc. Acid Res. 28:4157-4165, 2000; and Neddermann et al., J. B. C. 271:12767-74, 1996 (describing bifunctional 5-MCDG; Vairapandi & Duker, Oncogene 13:933-938, 1996; Vairapandi et al., J. Cell. Biochem. 79:249-260, 2000 (describing mono-functional enzyme comprising 5-MCDG activity). In some cases, 5-MCDG preferentially cleaves fully methylated polynucleotide sites (e.g., CpG dinucleotides), and in other cases, 5-MCDG preferentially cleaves a hemi-methylated polynucleotide. For example, mono-functional human 5-methylcytosine DNA glycosylase cleaves DNA specifically at fully methylated CpG sites, and can be relatively inactive on hemimethylated DNA (Vairapandi & Duker, supra; Vairapandi et al., supra). By contrast, chick embryo 5-methylcytosine-DNA glycosylase can have greater activity directed to hemi-methylated methylation sites. In some cases, the activity of 5-MCDG is potentiated (increased or enhanced) with accessory factors, such as recombinant CpG-rich RNA, ATP, RNA helicase enzyme, and proliferating cell nuclear antigen (PCNA). See U.S. Patent Publication No. 20020197639 A1. One or more agents can be used. In some cases, the one or more agents cleave a base portion of the same methylated nucleotide. In other cases, the one or more agents cleave a base portion of different methylated nucleotides. Treatment with two or more agents can be sequential or simultaneous.

In some cases, an abasic site in the DNA backbone of a first strand cDNA generated by the methods provided herein can be followed by fragmentation or cleavage of the backbone at the abasic site. Suitable agents (for example, an enzyme, a chemical and/or reaction conditions such as heat) capable of cleavage of the backbone at an abasic site include: heat treatment and/or chemical treatment (including basic conditions, acidic conditions, alkylating conditions, or amine mediated cleavage of abasic sites, (see e.g., McHugh and Knowland, Nucl. Acids Res. (1995) 23(10):1664-1670; Bioorgan. Med. Chem. (1991) 7:2351; Sugiyama, Chem. Res. Toxicol. (1994) 7: 673-83; Horn, Nucl. Acids. Res., (1988) 16:11559-71), and/or the use of enzymes that catalyze cleavage of polynucleotides at abasic sites. For example, an enzyme that catalyzes cleavage of polynucleotides at abasic sites can be AP endonucleases (also called “apurinic, apyrimidinic endonucleases”) (e.g., E. coli Endonuclease IV, available from Epicentre Tech., Inc, Madison Wis.), E. coli endonuclease III or endonuclease IV, E. coli exonuclease III in the presence of calcium ions. See, e.g. Lindahl, PNAS (1974) 71(9):3649-3653; Jendrisak, U.S. Pat. No. 6,190,865 B1; Shida, Nucleic Acids Res. (1996) 24(22):4572-76; Srivastava, J. Biol. Chem. (1998) 273(13):21203-209; Carey, Biochem. (1999) 38:16553-60; Chem Res Toxicol (1994) 7:673-683. As used herein “agent” encompasses reaction conditions such as heat. In some cases, the AP endonuclease, E. coli endonuclease IV, is used to cleave the phosphodiester backbone or phosphodiester bond at an abasic site. In some cases, cleavage is with an amine, such as N,N′-dimethylethylenediamine (DMED). See, e.g., McHugh and Knowland, supra.

In some cases, the polynucleotide (e.g. first strand cDNA) comprising one or more abasic sites can be treated with a nucleophile or a base. In some cases, the nucleophile is an amine such as a primary amine, a secondary amine, or a tertiary amine. For example, the abasic site can be treated with piperidine, moropholine, or a combination thereof. In some cases, hot piperidine (e.g., 1M at 90° C.) may be used to cleave a polynucleotide comprising one or more abasic sites. In some cases, morpholine (e.g., 3M at 37° C. or 65° C.) can be used to cleave the polynucleotide comprising one or more abasic sites. Alternatively, a polyamine can be used to cleave the polynucleotide comprising one or more abasic sites. Suitable polyamines include for example spermine, spermidine, 1,4-diaminobutane, lysine, the tripeptide K-W-K, DMED, piperazine, 1,2-ethylenediamine, or any combination thereof. In some cases, the polynucleotide comprising one or more abasic sites can be treated with a reagent suitable for carrying out a beta elimination reaction, a delta elimination reaction, or a combination thereof. In some cases, the methods provided herein provide for the use of an enzyme or combination of enzymes and a polyamine such as DMED under mild conditions in a single reaction mixture which does not affect the canonical or unmodified nucleotides and therefore may maintain the sequence integrity of the products of the method. Suitable mild conditions can include conditions at or near neutral pH. Other suitable conditions include pH of about 4.5 or higher, 5 or higher, 5.5 or higher, 6 or higher, 6.5 or higher, 7 or higher, 7.5 or higher, 8 or higher, 8.5 or higher, 9 or higher, 9.5 or higher, 10 or higher, or about 10.5 or higher. Still other suitable conditions include between about 4.5 and 10.5, between about 5 and 10.0, between about 5.5 and 9.5, between about 6 and 9, between about 6.5 and 8.5, between about 6.5 and 8.0, or between about 7 and 8.0. Suitable mild conditions also can include conditions at or near room temperature. Other suitable conditions include a temperature of about 10° C., 11° C., 12° C., 13° C., 14° C., 15° C., 16° C., 17° C., 18° C., 19° C., 20° C., 21° C., 22° C. ° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., or 70° C. or higher. Still other suitable conditions include between about 10° C. and about 70° C., between about 15° C. and about 65° C., between about 20° C. and about 60° C., between about 20° C. and about 55° C., between about 20° C. and about 50° C., between about 20° C. and about 45° C., between about 20° C. and about 40° C., between about 20° C. and about 35° C., or between about 20° C. and about 30° C. In some cases, the use of mild cleavage conditions can increase final product yields, maintain sequence integrity, or render the methods provided herein more suitable for automation.

In embodiments involving fragmentation, the backbone of the polynucleotide comprising the abasic site can be cleaved at the abasic site, whereby two or more fragments of the polynucleotide can be generated. At least one of the fragments can comprise an abasic site, as described herein. Agents that cleave the phosphodiester backbone or phosphodiester bonds of a polynucleotide at an abasic site are provided herein. In some embodiments, the agent is an AP endonuclease such as E. coli AP endonuclease IV. In other embodiments, the agent is DMED. In other embodiments, the agent is heat, basic condition, acidic conditions, or an alkylating agent. In still other embodiments, the agent that cleaves the phosphodiester backbone at an abasic site is the same agent that cleaves the base portion of a nucleotide to form an abasic site. For example, glycosylases of the methods provided herein can comprise both a glycosylase and a lyase activity, whereby the glycosylase activity cleaves the base portion of a nucleotide (e.g., a modified nucleotide) to form an abasic site and the lyase activity cleaves the phosphodiester backbone at the abasic site so formed. In some cases, the glycosylase comprises both a glycosylase activity and an AP endonuclease activity.

It can be desirable to use agents or conditions that can affect the cleavage of the backbone at the abasic site to generate fragments comprising a blocked 3′-end, which cannot be extendable by a polymerase when the 3′-end is hybridized to a first adapter according to the methods described herein.

Appropriate reaction media and conditions for carrying out the cleavage of a base portion of a non-canonical or modified nucleotide according to the methods provided herein are those that permit cleavage of a base portion of a non-canonical or modified nucleotide. Such media and conditions are known to persons of skill in the art, and are described in various publications, such as Lindahl, PNAS (1974) 71(9):3649-3653; and Jendrisak, U.S. Pat. No. 6,190,865 B1; U.S. Pat. No. 5,035,996; and U.S. Pat. No. 5,418,149. In one embodiment, UDG (Epicentre Technologies, Madison Wis.) is added to a nucleic acid synthesis reaction mixture, and incubated at 37° C. for 20 minutes. In one embodiment, the reaction conditions are the same for the synthesis of a polynucleotide comprising a non-canonical or modified nucleotide and the cleavage of a base portion of the non-canonical or modified nucleotide. In another embodiment, different reaction conditions are used for these reactions. In some embodiments, a chelating regent (e.g. EDTA) is added before or concurrently with UNG in order to prevent a polymerase from extending the ends of the cleavage products. In a one embodiment, the selection is done by incorporation of at least one modified nucleotide into one strand of a synthesized polynucleotide, and the selective removal is by treatment with an enzyme that displays a specific activity towards the at least one modified nucleotide. In some cases, the modified nucleotide being incorporated into one strand of the synthesized polynucleotide is deoxyuridine triphosphate (dUTP), and the selective cleavage is carried by out by UNG. UNG selectively degrades dUTP while it is neutral towards other dNTPs and their analogs. Treatment with UNG results in the cleavage of the N-glycosylic bond and the removal of the base portion of dU residues, forming abasic sites. In one embodiment, the UNG treatment is done in the presence of an apurinic/apyrimidinic endonuclease (APE) to create nicks at the abasic sites. Consequently, a polynucleotide strand with incorporated dUTP that is treated with UNG/APE can be cleaved. In another case, nick generation and cleavage is achieved by treatment with a polyamine, such as DMED, or by heat treatment.

### XI. Methods of Amplification

The methods, compositions and kits described herein can be useful to generate amplification-ready products for downstream applications such as massively parallel sequencing (i.e. next generation sequencing methods) or hybridization platforms. Methods of amplification are well known in the art. Examples of PCR techniques that can be used include, but are not limited to, quantitative PCR, quantitative fluorescent PCR (QF-PCR), multiplex fluorescent PCR (MF-PCR), real time PCR (RT-PCR), single cell PCR, restriction fragment length polymorphism PCR (PCR-RFLP), PCR-RFLP/RT-PCR-RFLP, hot start PCR, nested PCR, in situ polony PCR, in situ rolling circle amplification (RCA), bridge PCR, picotiter PCR, digital PCR, droplet digital PCR, and emulsion PCR. Other suitable amplification methods include the ligase chain reaction (LCR), transcription amplification, molecular inversion probe (MIP) PCR, self-sustained sequence replication, selective amplification of target polynucleotide sequences, consensus sequence primed polymerase chain reaction (CP-PCR), arbitrarily primed polymerase chain reaction (AP-PCR), degenerate oligonucleotide-primed PCR (DOP-PCR) and nucleic acid based sequence amplification (NABSA), single primer isothermal amplification (SPIA, see e.g. U.S. Pat. No. 6,251,639), Ribo-SPIA, or a combination thereof. Other amplification methods that can be used herein include those described in U.S. Pat. Nos. 5,242,794; 5,494,810; 4,988,617; and 6,582,938. Amplification of target nucleic acids can occur on a bead. In other embodiments, amplification does not occur on a bead. Amplification can be by isothermal amplification, e.g., isothermal linear amplification. A hot start PCR can be performed wherein the reaction is heated to 95° C. for two minutes prior to addition of the polymerase or the polymerase can be kept inactive until the first heating step in cycle 1. Hot start PCR can be used to minimize nonspecific amplification. Other strategies for and aspects of amplification are described, e.g., in U.S. Patent Application Publication No. 2010/0173394 A1, published Jul. 8, 2010, which is incorporated herein by reference. In some cases, the amplification methods can be performed under limiting conditions such that only a few rounds of amplification (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 etc.), such as for example as is commonly done for cDNA generation. The number of rounds of amplification can be about 1-30, 1-20, 1-15, 1-10, 5-30, 10-30, 15-30, 20-30, 10-30, 15-30, 20-30, or 25-30.

Techniques for amplification of target and reference sequences are known in the art and include the methods described, e.g., in U.S. Pat. No. 7,048,481. Briefly, the techniques can include methods and compositions that separate samples into small droplets, in some instances with each containing on average less than about 5, 4, 3, 2, or one target nucleic acid molecule (polynucleotide) per droplet, amplifying the nucleic acid sequence in each droplet and detecting the presence of a target nucleic acid sequence. In some cases, the sequence that is amplified is present on a probe to the genomic DNA, rather than the genomic DNA itself. In some cases, at least 200, 175, 150, 125, 100, 90, 80, 70, 60, 50, 40, 30, 20, 10, or 0 droplets have zero copies of a target nucleic acid.

PCR can involve in vitro amplification based on repeated cycles of denaturation, oligonucleotide primer annealing, and primer extension by thermophilic template dependent polynucleotide polymerase, which can result in the exponential increase in copies of the desired sequence of the polynucleotide analyte flanked by the primers. In some cases, two different PCR primers, which anneal to opposite strands of the DNA, can be positioned so that the polymerase catalyzed extension product of one primer can serve as a template strand for the other, leading to the accumulation of a discrete double stranded fragment whose length is defined by the distance between the 5′ ends of the oligonucleotide primers.

LCR can involve use of a ligase enzyme to join pairs of preformed nucleic acid probes. The probes can hybridize with each complementary strand of the nucleic acid analyte, if present, and ligase can be employed to bind each pair of probes together resulting in two templates that can serve in the next cycle to reiterate the particular nucleic acid sequence.

SDA (Westin et al 2000, Nature Biotechnology, 18, 199-202; Walker et al 1992, Nucleic Acids Research, 20, 7, 1691-1696), can involve isothermal amplification based upon the ability of a restriction endonuclease such as HincII or BsoBI to nick the unmodified strand of a hemiphosphorothioate form of its recognition site, and the ability of an exonuclease deficient DNA polymerase such as Klenow exo minus polymerase, or Bst polymerase, to extend the 3′-end at the nick and displace the downstream DNA strand. Exponential amplification results from coupling sense and antisense reactions in which strands displaced from a sense reaction serve as targets for an antisense reaction and vice versa.

Some aspects of the methods described herein can utilize linear amplification of nucleic acids or polynucleotides. Linear amplification can refer to a method that involves the formation of one or more copies of the complement of only one strand of a nucleic acid or polynucleotide molecule, usually a nucleic acid or polynucleotide analyte. Thus, the primary difference between linear amplification and exponential amplification is that in the latter process, the product serves as substrate for the formation of more product, whereas in the former process the starting sequence is the substrate for the formation of product but the product of the reaction, i.e. the replication of the starting template, is not a substrate for generation of products. In linear amplification the amount of product formed increases as a linear function of time as opposed to exponential amplification where the amount of product formed is an exponential function of time.

In some cases, the amplification is exponential, e.g. in the enzymatic amplification of specific double stranded sequences of DNA by a polymerase chain reaction (PCR). In other embodiments the amplification method is linear. In other embodiments the amplification method is isothermal.

### XII. Applications

One aspect of the methods and compositions disclosed herein is that they can be efficiently and cost-effectively utilized for downstream analyses, such as next generation sequencing or hybridization platforms, with minimal loss of biological material of interest. The methods described herein can be particularly useful for generating high throughput sequencing libraries from template DNA or RNA, for whole genome or whole transcriptome analysis, respectively.

For example, the methods described herein can be useful for sequencing by the method commercialized by Illumina, as described U.S. Pat. Nos. 5,750,341; 6,306,597; and 5,969,119. Directional (strand-specific) nucleic acid libraries can be prepared using the methods described herein, and the selected single-stranded nucleic acid is amplified, for example, by PCR. The resulting nucleic acid is then denatured and the single-stranded amplified polynucleotides can be randomly attached to the inside surface of flow-cell channels. Unlabeled nucleotides can be added to initiate solid-phase bridge amplification to produce dense clusters of double-stranded DNA. To initiate the first base sequencing cycle, four labeled reversible terminators, primers, and DNA polymerase can be added. After laser excitation, fluorescence from each cluster on the flow cell is imaged. The identity of the first base for each cluster is then recorded. Cycles of sequencing can be performed to determine the fragment sequence one base at a time.

In some cases, the methods described herein can be useful for preparing target polynucleotides for sequencing by the sequencing by ligation methods commercialized by Applied Biosystems (e.g., SOLiD sequencing). Directional (strand-specific) nucleic acid libraries can be prepared using the methods described herein, and the selected single-stranded nucleic acid can then be incorporated into a water in oil emulsion along with polystyrene beads and amplified by for example PCR. In some cases, alternative amplification methods can be employed in the water-in-oil emulsion such as any of the methods provided herein. The amplified product in each water microdroplet formed by the emulsion interact, bind, or hybridize with the one or more beads present in that microdroplet leading to beads with a plurality of amplified products of substantially one sequence. When the emulsion is broken, the beads float to the top of the sample and are placed onto an array. The methods can include a step of rendering the nucleic acid bound to the beads stranded or partially single stranded. Sequencing primers are then added along with a mixture of four different fluorescently labeled oligonucleotide probes. The probes bind specifically to the two bases in the polynucleotide to be sequenced immediately adjacent and 3′ of the sequencing primer to determine which of the four bases are at those positions. After washing and reading the fluorescence signal form the first incorporated probe, a ligase is added. The ligase cleaves the oligonucleotide probe between the fifth and sixth bases, removing the fluorescent dye from the polynucleotide to be sequenced. The whole process is repeated using a different sequence primer, until all of the intervening positions in the sequence are imaged. The process allows the simultaneous reading of millions of DNA fragments in a ‘massively parallel’ manner. This ‘sequence-by-ligation’ technique uses probes that encode for two bases rather than just one allowing error recognition by signal mismatching, leading to increased base determination accuracy.

In other embodiments, the methods are useful for preparing target polynucleotides for sequencing by synthesis using the methods commercialized by 454/Roche Life Sciences, including but not limited to the methods and apparatus described in Margulies et al., Nature (2005) 437:376-380 (2005); and U.S. Pat. Nos. 7,244,559; 7,335,762; 7,211,390; 7,244,567; 7,264,929; and 7,323,305. Directional (strand-specific) nucleic acid libraries can be prepared using the methods described herein, and the selected single-stranded nucleic acid can be amplified, for example, by PCR. The amplified products can then be immobilized onto beads, and compartmentalized in a water-in-oil emulsion suitable for amplification by PCR. In some cases, alternative amplification methods other than PCR can be employed in the water-in-oil emulsion such as any of the methods provided herein. When the emulsion is broken, amplified fragments can remain bound to the beads. The methods can include a step of rendering the nucleic acid bound to the beads single stranded or partially single stranded. The beads can be enriched and loaded into wells of a fiber optic slide so that there is approximately 1 bead in each well. Nucleotides can be flowed across and into the wells in a fixed order in the presence of polymerase, sulfhydrolase, and luciferase. Addition of nucleotides complementary to the target strand can result in a chemiluminescent signal that can be recorded such as by a camera. The combination of signal intensity and positional information generated across the plate can allow software to determine the DNA sequence.

In other embodiments, the methods are useful for preparing target polynucleotide(s) for sequencing by the methods commercialized by Helicos BioSciences Corporation (Cambridge, Mass.) as described in U.S. application Ser. No. 11/167,046, and U.S. Pat. Nos. 7,501,245; 7,491,498; 7,276,720; and in U.S. Patent Application Publication Nos. US20090061439; US20080087826; US20060286566; US20060024711; US20060024678; US20080213770; and US20080103058. Directional (strand-specific) nucleic acid libraries can be prepared using the methods described herein, and the selected single-stranded nucleic acid is amplified, for example, by PCR. The amplified products can then be immobilized onto a flow-cell surface. The methods can include a step of rendering the nucleic acid bound to the flow-cell surface stranded or partially single stranded. Polymerase and labeled nucleotides can then be flowed over the immobilized DNA. After fluorescently labeled nucleotides are incorporated into the DNA strands by a DNA polymerase, the surface can be illuminated with a laser, and an image can be captured and processed to record single molecule incorporation events to produce sequence data.

In some cases, the methods described herein can be useful for sequencing by the method commercialized by Pacific Biosciences as described in U.S. Pat. Nos. 7,462,452; 7,476,504; 7,405,281; 7,170,050; 7,462,468; 7,476,503; 7,315,019; 7,302,146; 7,313,308; and U.S. Patent Application Publication Nos. US20090029385; US20090068655; US20090024331; and US20080206764. Directional (strand-specific) nucleic acid libraries can be prepared using the methods described herein, and the selected single-stranded nucleic acid is amplified, for example, by PCR. The nucleic acid can then be immobilized in zero mode waveguide arrays. The methods can include a step of rendering the nucleic acid bound to the waveguide arrays single stranded or partially single stranded. Polymerase and labeled nucleotides can be added in a reaction mixture, and nucleotide incorporations can be visualized via fluorescent labels attached to the terminal phosphate groups of the nucleotides. The fluorescent labels can be clipped off as part of the nucleotide incorporation. In some cases, circular templates are utilized to enable multiple reads on a single molecule.

Another example of a sequencing technique that can be used in the methods described herein is nanopore sequencing (see e.g. Soni G V and Meller A. (2007) Clin Chem 53: 1996-2001). A nanopore can be a small hole of the order of 1 nanometer in diameter. Immersion of a nanopore in a conducting fluid and application of a potential across it can result in a slight electrical current due to conduction of ions through the nanopore. The amount of current that flows is sensitive to the size of the nanopore. As a DNA molecule passes through a nanopore, each nucleotide on the DNA molecule obstructs the nanopore to a different degree. Thus, the change in the current passing through the nanopore as the DNA molecule passes through the nanopore can represent a reading of the DNA sequence.

Another example of a sequencing technique that can be used in the methods described herein is semiconductor sequencing provided by Life Techology's Ion Torrent (e.g., using the Ion Personal Genome Machine (PGM)). Ion Torrent technology can use a semiconductor chip with multiple layers, e.g., a layer with micro-machined wells, an ion-sensitive layer, and an ion sensor layer. Nucleic acids can be introduced into the wells, e.g., a clonal population of single nucleic can be attached to a single bead, and the bead can be introduced into a well. To initiate sequencing of the nucleic acids on the beads, one type of deoxyribonucleotide (e.g., dATP, dCTP, dGTP, or dTTP) can be introduced into the wells. When one or more nucleotides are incorporated by DNA polymerase, protons (hydrogen ions) can be released in the well, which can be detected by the ion sensor. The semiconductor chip can then be washed and the process can be repeated with a different deoxyribonucleotide. A plurality of nucleic acids can be sequenced in the wells of a semiconductor chip. The semiconductor chip can comprise chemical-sensitive field effect transistor (chemFET) arrays to sequence DNA (for example, as described in U.S. Patent Application Publication No. 20090026082). Incorporation of one or more triphosphates into a new nucleic acid strand at the 3′ end of the sequencing primer can be detected by a change in current by a chemFET. An array can have multiple chemFET sensors.

Another example of a sequencing technique that can be used in the methods described herein is DNA nanoball sequencing (as performed, e.g., by Complete Genomics; see e.g., Drmanac et al. (2010) Science 327: 78-81). DNA can be isolated, fragmented, and size selected. For example, DNA can be fragmented (e.g., by sonication) to a mean length of about 500 bp. Adapters (Adl) can be attached to the ends of the fragments. The adapters can be used to hybridize to anchors for sequencing reactions. DNA with adapters bound to each end can be PCR amplified. The adapter sequences can be modified so that complementary single strand ends bind to each other forming circular DNA. The DNA can be methylated to protect it from cleavage by a type IIS restriction enzyme used in a subsequent step. An adapter (e.g., the right adapter) can have a restriction recognition site, and the restriction recognition site can remain non-methylated. The non-methylated restriction recognition site in the adapter can be recognized by a restriction enzyme (e.g., Acul), and the DNA can be cleaved by Acul 13 bp to the right of the right adapter to form linear double stranded DNA. A second round of right and left adapters (Ad2) can be ligated onto either end of the linear DNA, and all DNA with both adapters bound can be PCR amplified (e.g., by PCR). Ad2 sequences can be modified to allow them to bind each other and form circular DNA. The DNA can be methylated, but a restriction enzyme recognition site can remain non-methylated on the left Adl adapter. A restriction enzyme (e.g., Acul) can be applied, and the DNA can be cleaved 13 bp to the left of the Adl to form a linear DNA fragment. A third round of right and left adapter (Ad3) can be ligated to the right and left flank of the linear DNA, and the resulting fragment can be PCR amplified. The adapters can be modified so that they can bind to each other and form circular DNA. A type III restriction enzyme (e.g., EcoP15) can be added; EcoP15 can cleave the DNA 26 bp to the left of Ad3 and 26 bp to the right of Ad2. This cleavage can remove a large segment of DNA and linearize the DNA once again. A fourth round of right and left adapters (Ad4) can be ligated to the DNA, the DNA can be amplified (e.g., by PCR), and modified so that they bind each other and form the completed circular DNA template. Rolling circle replication (e.g., using Phi 29 DNA polymerase) can be used to amplify small fragments of DNA. The four adapter sequences can contain palindromic sequences that can hybridize and a single strand can fold onto itself to form a DNA nanoball (DNB™) which can be approximately 200-300 nanometers in diameter on average. A DNA nanoball can be attached (e.g., by adsorption) to a microarray (sequencing flowcell). The flow cell can be a silicon wafer coated with silicon dioxide, titanium and hexamethyldisilazane (HMDS) and a photoresist material. Sequencing can be performed by unchained sequencing by ligating fluorescent probes to the DNA. The color of the fluorescence of an interrogated position can be visualized by a high resolution camera. The identity of nucleotide sequences between adapter sequences can be determined.

In some cases, the sequencing technique can comprise paired-end sequencing in which both the forward and reverse template strand can be sequenced. In some cases, the sequencing technique can comprise mate pair library sequencing. In mate pair library sequencing, DNA can be fragments, and 2-5 kb fragments can be end-repaired (e.g., with biotin labeled dNTPs). The DNA fragments can be circularized, and non-circularized DNA can be removed by digestion. Circular DNA can be fragmented and purified (e.g., using the biotin labels). Purified fragments can be end-repaired and ligated to sequencing adapters.

In some cases, a sequence read is about, more than about, less than about, or at least about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 525, 550, 575, 600, 625, 650, 675, 700, 725, 750, 775, 800, 825, 850, 875, 900, 925, 950, 975, 1000, 1100, 1200, 1300, 1400, 1500, 1600, 1700, 1800, 1900, 2000, 2100, 2200, 2300, 2400, 2500, 2600, 2700, 2800, 2900, or 3000 bases. In some cases, a sequence read is about 10 to about 50 bases, about 10 to about 100 bases, about 10 to about 200 bases, about 10 to about 300 bases, about 10 to about 400 bases, about 10 to about 500 bases, about 10 to about 600 bases, about 10 to about 700 bases, about 10 to about 800 bases, about 10 to about 900 bases, about 10 to about 1000 bases, about 10 to about 1500 bases, about 10 to about 2000 bases, about 50 to about 100 bases, about 50 to about 150 bases, about 50 to about 200 bases, about 50 to about 500 bases, about 50 to about 1000 bases, about 100 to about 200 bases, about 100 to about 300 bases, about 100 to about 400 bases, about 100 to about 500 bases, about 100 to about 600 bases, about 100 to about 700 bases, about 100 to about 800 bases, about 100 to about 900 bases, or about 100 to about 1000 bases.

The number of sequence reads from a sample can be about, more than about, less than about, or at least about 100, 1000, 5,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, 2,000,000, 3,000,000, 4,000,000, 5,000,000, 6,000,000, 7,000,000, 8,000,000, 9,000,000, or 10,000,000.

The depth of sequencing of a sample can be about, more than about, less than about, or at least about 1×, 2×, 3×, 4×, 5×, 6×, 7×, 8×, 9×, 10×, 11×, 12×, 13×, 14×, 15×, 16×, 17×, 18×, 19×, 20×, 21×, 22×, 23×, 24×, 25×, 26×, 27×, 28×, 29×, 30×, 31×, 32×, 33×, 34×, 35×, 36×, 37×, 38×, 39×, 40×, 41×, 42×, 43×, 44×, 45×, 46×, 47×, 48×, 49×, 50×, 51×, 52×, 53×, 54×, 55×, 56×, 57×, 58×, 59×, 60×, 61×, 62×, 63×, 64×, 65×, 66×, 67×, 68×, 69×, 70×, 71×, 72×, 73×, 74×, 75×, 76×, 77×, 78×, 79×, 80×, 81×, 82×, 83×, 84×, 85×, 86×, 87×, 88×, 89×, 90×, 91×, 92×, 93×, 94×, 95×, 96×, 97×, 98×, 99×, 100×, 110×, 120×, 130×, 140×, 150×, 160×, 170×, 180×, 190×, 200×, 300×, 400×, 500×, 600×, 700×, 800×, 900×, 1000×, 1500×, 2000×, 2500×, 3000×, 3500×, 4000×, 4500×, 5000×, 5500×, 6000×, 6500×, 7000×, 7500×, 8000×, 8500×, 9000×, 9500×, or 10,000×. The depth of sequencing of a sample can about 1× to about 5×, about 1× to about 10×, about 1× to about 20×, about 5× to about 10×, about 5× to about 20×, about 5× to about 30×, about 10× to about 20×, about 10× to about 25×, about 10× to about 30×, about 10× to about 40×, about 30× to about 100×, about 100× to about 200×, about 100× to about 500×, about 500× to about 1000×, about 1000×, to about 2000×, about 1000× to about 5000×, or about 5000× to about 10,000×. Depth of sequencing can be the number of times a sequence (e.g., a genome) is sequenced. In some cases, the Lander/Waterman equation is used for computing coverage. The general equation can be: C=LN/G, where C=coverage; G=haploid genome length; L=read length; and N=number of reads.

In some cases, different barcodes can be added (e.g., by using primers and/or adapters) to polynucleotides generated from template nucleic acids by methods described herein, wherein the template nucleic acids are derived from different samples, and the different samples can be pooled and analyzed in a multiplexed assay. The barcode can allow the determination of the sample from which a template nucleic acid originated. Pooling of the libraries generated from the various samples can be performed at different stages following appending of barcode sequences, dependent on the stage of appending the barcodes

### XIII. Compositions and Reaction Mixtures

The present methods further provide one or more compositions or reaction mixtures. In some cases, the reaction mixture comprises: (a) template RNA; (b) a primer comprising a random sequence; (c) a reverse transcriptase; (d) a mixture of unmodified dNTPs and non-canonical dNTP (e.g. dUTP); (e) a first adapter comprising a long strand comprising a 3′ overhang and a known sequence A and a short strand; (f) a DNA polymerase; (g) a mixture of unmodified dNTPs; (h) a second adapter comprising a long strand comprising a 3′ overhang and a known sequence B and a short strand comprising a block at the 3′ end. In some cases, the reaction mixture further comprises (e) amplification primers directed to unique priming sites created at each end of the polynucleotides following ligation of the second adapter and, optionally, extension of the end of the polynucleotide comprising second adapter sequence as described herein. In some cases, the reaction mixture further comprises (f) sequencing primers directed against sequences present in one or more of the adapter sequences appended to the ends of the polynucleotides generated by the methods provided herein. In some embodiments the primers (b) comprise sequences selected for preferential hybridizing to a desired group of templates, such as primers that preferentially hybridized to all transcripts other than the structural RNA (such as rRNA). In some embodiments the first adapter (e) comprises a stem-loop oligonucleotide with a 3′ overhang comprising random sequences.

### XIV. Kits

Any of the compositions described herein can be comprised in a kit. In a non-limiting example, the kit, in a suitable container, comprises: an adapter or several adapters, one or more of oligonucleotide primers and reagents for ligation, primer extension and amplification. The kit can also comprise means for purification, such as a bead suspension, and nucleic acid modifying enzymes.

The containers of the kits will generally include at least one vial, test tube, flask, bottle, syringe or other containers, into which a component can be placed, and, suitably aliquotted. Where there is more than one component in the kit, the kit also will generally contain a second, third or other additional container into which the additional components can be separately placed. However, various combinations of components can be comprised in a container.

When the components of the kit are provided in one or more liquid solutions, the liquid solution can be an aqueous solution. However, the components of the kit can be provided as dried powder(s). When reagents and/or components are provided as a dry powder, the powder can be reconstituted by the addition of a suitable solvent.

The present methods provide kits containing one or more compositions described herein and other suitable reagents suitable for carrying out the methods described herein. The methods described herein provide, e.g., diagnostic kits for clinical or criminal laboratories, or nucleic acid amplification, or RNA-seq library preparation kits, or analysis kits for general laboratory use. The present methods thus include kits which include some or all of the reagents to carry out the methods described herein, e.g., sample preparation reagents, oligonucleotides, binding molecules, stock solutions, nucleotides, polymerases, enzymes, positive and negative control oligonucleotides and target sequences, test tubes or plates, fragmentation or cleavage reagents, detection reagents, purification matrices, and an instruction manual. In some cases the kit contains first strand complementary DNA primers comprising random sequences at the 3′-end. In some cases the first strand cDNA primers contained in the kits comprise sequences hybridizable to selected group of targets, such as all transcripts other than rRNA. In some cases, the kit contains a modified or non-canonical nucleotide. Suitable modified or non-canonical nucleotides include any nucleotides provided herein including but not limited to dUTP. In some cases, the kit comprises a cleavage agent. In some cases, the cleavage agent is a glycosylase and a chemical agent, or an enzyme. The glycosylase can be UNG. The chemical agent can be a polyamine. The polyamine can be DMED. The enzyme can be an endonuclease. The endonuclease can be endonuclease VIII or APE. In some cases, the kit contains a first adapter/primer comprising a first universal sequence and a 3′ overhang, wherein the 3′ overhang comprises sequence directed against sequence present at the 3′ end of a polynucleotide comprising a 3′ end block. In some cases the kit contains one of more oligonucleotide first adapters comprising a 3′-overhang wherein the 3′-overhang comprises random sequence. In some cases the first primer comprises a stem-loop oligonucleotide. In some cases the first adapter further comprises barcode sequence and universal sequence. In some cases, the kit contains a second adapter comprising a second universal sequence. In some cases, the kit contains a first primer directed against a portion of a sequence complementary to the universal sequence present in the first adapter and a second primer comprising sequence directed against the universal sequence present in the second adapter or its complement.

In some cases, the kit can contain one or more reaction mixture components, or one or more mixtures of reaction mixture components. In some cases, the reaction mixture components or mixtures thereof can be provided as concentrated stocks, such as 1.1×, 1.5×, 2×, 2.5×, 3×, 4×, 5×, 6×, 7×, 10×, 15×, 20×, 25×, 33×, 50×, 75×, 100× or higher concentrated stock. The reaction mixture components can include any of the compositions provided herein including but not limited to buffers, salts, divalent cations, azeotropes, chaotropes, dNTPs, labeled nucleotides, non-canonical or modified nucleotides, dyes, fluorophores, biotin, enzymes (such as endonucleases, exonucleases, glycosylases), or any combination thereof.

In some cases, the kit can contain one or more oligonucleotide primers, such as the oligonucleotide primers provided herein. For example, the kit can contain one or more oligonucleotide primers comprising sequence directed the adapter sequences appended to the ends of the polynucleotides generated by the methods provided herein. In some cases the kit can contain tailed primers comprising a 3′-portion hybridizable to the target nucleic acid (e.g. sequence present in a first and/or second adapter sequence) and a 5′-portion which is not hybridizable to the target nucleic acid. In some cases, the kit can contain chimeric primers comprising an RNA portion and a DNA portion. In some cases, the 5′ portion of the tailed primers comprises one or more barcode or other identifier sequences. In some cases, the identifier sequences comprise flow cell sequences, TruSeq primer sequence, and/or second read barcode sequences.

In some cases, the kit can contain one or more polymerases or mixtures thereof. In some cases, the one or more polymerases or mixtures thereof can comprise strand displacement activity. Suitable polymerases include any of the polymerases provided herein. The kit can further contain one or more polymerase substrates such as for example dNTPs, non-canonical or modified nucleotides, or nucleotide analogs.

In some cases, the kit can contain one or more means for purification of the nucleic acid products, removing of the fragmented products from the desired products, or combination of the above. Suitable means for the purification of the nucleic acid products include but are not limited to single stranded specific exonucleases, affinity matrices, nucleic acid purification columns, spin columns, ultrafiltration or dialysis reagents, or electrophoresis reagents including but not limited acrylamide or agarose, or any combination thereof.

In some cases, the kit can contain one or more reagents for producing blunt ends. For example, the kit can contain one or more of single stranded DNA specific exonucleases including but not limited to exonuclease 1 or exonuclease 7; a single stranded DNA specific endonucleases such as mung bean exonuclease or S1 exonuclease, one or more polymerases such as for example T4 DNA polymerase or Klenow polymerase, or any mixture thereof. Alternatively, the kit can contain one or more single stranded DNA specific exonucleases, endonucleases and one or more polymerases, wherein the reagents are not provided as a mixture. Additionally, the reagents for producing blunt ends can comprise dNTPs.

In some cases, the kit can contain one or more reagents for preparing the double stranded products for ligation to adapter molecules. For example, the kit can contain dATP, dCTP, dGTP, dTTP, or any mixture thereof. In some cases, the kit can contain a polynucleotide kinase, such as for example T4 polynucleotide kinase. Additionally, the kit can contain a polymerase suitable for producing a 3′ extension from the blunt ended double stranded DNA fragments. Suitable polymerases can be included, for example, exo-Klenow polymerase.

In some cases, the kit can contain one or more adapter molecules such as any of the adapter molecules provided herein. Suitable adapter molecules include single or double stranded nucleic acid (DNA or RNA) molecules or derivatives thereof, stem-loop nucleic acid molecules, double stranded molecules comprising one or more single stranded overhangs of 1, 2, 3, 4, 5, 6, 7, 8, 9, 10 bases or longer, proteins, peptides, aptamers, organic molecules, small organic molecules, or any adapter molecules known in the art that can be covalently or non-covalently attached, such as for example by ligation, to the double stranded DNA fragments. In some cases, the kit contains adapters, wherein the adapters can be duplex adapters wherein one strand comprises a known or universal sequence, while the other strand comprises a 5′ and/or 3′ block. The long-strand can also comprise a 5′ or 3′ block. In a further embodiment, the duplex adapter is a partial duplex adapter. In some cases, the partial duplex adapter comprises a long strand comprising a known or universal sequence, and a short strand comprising a 5′ and 3′ block. The long-strand can also comprise a 5′ or 3′ block. In some cases, the 3′ block is blocked with a terminal dideonucleotide.

In some cases, the kit can contain one or more reagents for performing gap or fill-in repair on the ligation complex formed between the adapter(s) and the double stranded products of the methods described herein. The kit can contain a polymerase suitable for performing gap repair. Suitable polymerases can be included, for example, Taq DNA polymerase.

The kit can further contain instructions for the use of the kit. For example, the kit can contain instructions for generating directional polynucleotide libraries or directional cDNA libraries representing the whole or a part of the transcriptome or genome useful for large scale analysis of including but not limited to e.g., pyrosequencing, sequencing by synthesis, sequencing by hybridization, single molecule sequencing, nanopore sequencing, and sequencing by ligation, high density PCR, digital PCR, massively parallel Q-PCR, and characterizing amplified nucleic acid products generated by the methods described herein, or any combination thereof. The kit can further contain instructions for mixing the one or more reaction mixture components to generate one or more reaction mixtures suitable for the methods described herein. The kit can further contain instructions for hybridizing the one or more oligonucleotide primers to a nucleic acid template. The kit can further contain instructions for extending the one or more oligonucleotide primers with for example a polymerase and/or modified dNTPs. The kit can further contain instructions for treating the DNA products with a cleavage agent. In some cases, the cleavage agent is a glycosylase and a chemical agent, or an enzyme. The glycosylase can be UNG. The chemical agent can be a polyamine. The polyamine can be DMED. The enzyme can be an endonuclease. The endonuclease can be endonuclease VIII or APE. The kit can further contain instructions for purification of any of the products provided by any of the steps of the methods provided herein. The kit can further contain instructions for producing blunt ended fragments, for example by removing single stranded overhangs or filling in single stranded overhangs, with for example single stranded DNA specific exonucleases, polymerases, or any combination thereof. The kit can further contain instructions for phosphorylating the 5′ ends of the double stranded DNA fragments produced by the methods described herein. The kit can further contain instructions for ligating one or more adapter molecules to the double stranded DNA fragments.

A kit will can include instructions for employing, the kit components as well the use of any other reagent not included in the kit. Instructions can include variations that can be implemented.

Unless otherwise specified, terms and symbols of genetics, molecular biology, biochemistry and nucleic acid used herein follow those of standard treatises and texts in the field, e.g. Kornberg and Baker, DNA Replication, Second Edition (W.H. Freeman, New York, 1992); Lehninger, Biochemistry, Second Edition (Worth Publishers, New York, 1975); Strachan and Read, Human Molecular Genetics, Second Edition (Wiley-Liss, New York, 1999); Eckstein, editor, Oligonucleotides and Analogs: A Practical Approach (Oxford University Press, New York, 1991); Gait, editor, Oligonucleotide Synthesis: A Practical Approach (IRL Press, Oxford, 1984); and the like.

### EXAMPLES

### Example 1

### Stranded Library Preparation from 100 ng Total RNA Input

The process described in FIG. 3 was employed for the generation of stranded cDNA sequencing libraries from Universal Human Reference (UHR) total RNA samples (100 ng) following a process workflow as in FIG. 3.

a.) Synthesis of first strand cDNA comprising dU: 2 ml of First Strand Primer Mix (NuGEN, 0334-32) and 2 μl of H₂O were added to 2 μl of Universal Human Reference RNA (50 ng/μl; Agilent). The mixture was incubated 65° C. for 5 min and cool on ice. The following mixture was added to the above: 2.5 ml of First Strand Buffer Mix (NuGEN, 0334-32), 0.5 μl of First Strand Enzyme Mix (NuGEN, 0334-32), 0.375 μl of 1 mM dUTP and 0.625 μl of H₂O. First strand cDNA synthesis was carried out at 40° C. for 30 min followed by incubation at 70° C. for 10 min.

b.) Fragmentation of first strand cDNA: 0.5 μl USER Enzyme (New England BioLabs) was added to the first strand cDNA synthesis reaction mixture above and the reaction mixture was incubated at 37° C. for 30 min followed by incubation at 95° C. for 10 min.

c.) RNA Hydrolysis: The RNA input was hydrolyzed by addition of 2 μl 1N NaOH to the cDNA fragmentation reaction mixture above, and incubation of the reaction mixture at 95° C. for 15 min, followed by neutralization of the reaction mixture by the addition of 2 μl 1N HCl to the cooled reaction mixture.

d.) Purification: The fragmented first strand cDNA was purified using ssDNA/RNA Clean & Concentrator (Zymo Research) following the manufacturer instruction and the purified fragmented first strand cDNA was eluted in 10 μl of H₂O.

e.) Conversion of the all fragments of first strand cDNA to dsDNA with appended first adaptor at one end: 10 μl of the purified fragmented and 3′-blocked first strand cDNA was mixed with 1.5 μl of 10×NEBuffer2 (New England BioLabs), 1.5 μl of 2.5 mM dNTPs, 0.5 μl of 10 μM First adaptor (33 bp dsDNA with 8-base 3′ overhang of random sequences) hybridizable to the blocked 3′-end of the fragmented first strand cDNA and 1 μl of H₂O. The mixture was incubated at 65° C. for 5 min, and cool on ice. Extension of the hybridized first adaptor along the first strand cDNA fragments was carried out by the addition of 0.5 μl Bsu DNA Polymerase, (Large Fragment New England BioLabs) and incubating the reaction mixture at 25° C. for 15 min, 37° C. for 15 min, followed by 70° C. for 10 min.

f.) Polishing DNA Ends: The above reaction mixture was combined with 0.5 μl T4 DNA Polymerase (Enzymatics) and the reaction mixture was incubated at 25° C. for 30 min, followed by 70° C. for 10 min g.) Ligation of Second Adaptor to the blunt end of the ds cDNA produced as above: The ligation was carried out by the addition of the following to the above reaction mixture: 6 μl of 5× Quick Ligation Buffer (New England BioLabs), 2.5 μl of 20 μM Second Adaptor, 1.5 μl of Quick Ligase (New England BioLabs), and 5 μl of H₂O. The reaction mixture was incubated at 25° C. for 30 min, followed by 70° C. for 10 min.

h.) Purification: The ligation products, dsDNA with first adaptor appended at one end, and second adaptor at the other end, were purified using 0.8 volume of Agencourt Ampure XP (Beckman Coulter), and eluted in 25 μl.

i.) PCR Amplification: The library of stranded cDNA products with appended first and second adaptors prepared as described above, was PCR amplified with primers comprising sequences specific to the first and the second adaptor, and barcodes enabling multiplex sequencing, for 17 cycles using the following PCR program: 70° C. 5 min, 17×(94° C. 30 sec, 60° C. 30 sec, 72° C. 1 min) 72° C. 5 min.

j.) Purification: The PCR products, amplified stranded cDNA library, were purified using 1 volume of Agencourt Ampure XP (Beckman Coulter) following the manufacturer instruction.

A size distribution of one directional sequencing library generated from 100 ng UHR total RNA was analyzed using BioAnalyzer (Agilent). The size distribution of the said library is shown in FIG. 6.

### Example 2

### Generation of Stranded cDNA Library from 1 ng Total RNA Input

a.) Synthesis of first strand cDNA comprising dU: 2 μl of First Strand Primer Mix (NuGEN, 0334-32) and 2 μl of H₂O were added to 2 μl of Universal Human Reference RNA (0.5 ng/μl; Agilent). The mixture was incubated 65° C. for 5 min and cool on ice. The following mixture was added to the above: 2.5 μl of First Strand Buffer Mix (NuGEN, 0334-32), 0.5 μl of First Strand Enzyme Mix (NuGEN, 0334-32), 0.375 μl of 1 mM dUTP and 0.625 μl of H₂O. First strand cDNA synthesis was carried out at 40° C. for 30 min followed by incubation at 70° C. for 10 min.

b.) Fragmentation of first strand cDNA: 0.5 μl USER Enzyme (New England BioLabs) was added to the first strand cDNA synthesis reaction mixture above and the reaction mixture was incubated at 37° C. for 30 min followed by incubation at 95° C. for 10 min.

c.) RNA Hydrolysis: The RNA input was hydrolyzed by addition of 2 μl 1N NaOH to the cDNA fragmentation reaction mixture above, and incubation of the reaction mixture at 95° C. for 15 min, followed by neutralization of the reaction mixture by the addition of 2 μl 1N HCl to the cooled reaction mixture.

d.) Purification: The fragmented first strand cDNA was purified using ssDNA/RNA Clean & Concentrator (Zymo Research) following the manufacturer instruction and the purified fragmented first strand cDNA was eluted in 10 μl of H₂O.

e.) Conversion of the all fragments of first strand cDNA to dsDNA with appended first adaptor at one end: 10 μl of the purified fragmented and 3′-blocked first strand cDNA was mixed with 1.5 μl of 10×NEBuffer2 (New England BioLabs), 1.5 μl of 2.5 mM dNTPs, 0.5 μl of 10 μM First adaptor (33 bp dsDNA with 8-base 3′ overhang of random sequences) hybridizable to the blocked 3′-end of the fragmented first strand cDNA and 1 μl of H₂O. The mixture was incubated at 65° C. for 5 min, and cool on ice. Extension of the hybridized first adaptor along the first strand cDNA fragments was carried out by the addition of 0.5 μl Bsu DNA Polymerase, (Large Fragment New England BioLabs) and incubating the reaction mixture at 25° C. for 15 min, 37° C. for 15 min, followed by 70° C. for 10 min.

f.) Polishing DNA Ends: The above reaction mixture was combined with 0.5 μl T4 DNA Polymerase (Enzymatics) and the reaction mixture was incubated at 25° C. for 30 min, followed by 70° C. for 10 min.

g.) Purification: The DNA was purified using 1.5× volume of Agencourt Ampure XP (Beckman Coplter), and eluted in 18 μl of H₂O

h.) Ligation of Second Adaptor to the blunt end of the ds cDNA produced as above: The ligation was carried out by the addition of the following to the above purified DNA product: 5 μl of 5× Quick Ligation Buffer (New England BioLabs), 0.625 μl of 20 μM Second Adaptor, and 1.5 μl of Quick Ligase (New England BioLabs). The reaction mixture was incubated at 25° C. for 30 min, followed by 70° C. for 10 min.

i.) Purification: The ligation products, dsDNA with first adaptor appended at one end and second adaptor at the other end, were purified using 0.8× volume of Agencourt Ampure XP (Beckman Coulter), and eluted in 25 μl of H2O.

j.) PCR Amplification was carried out in two steps with a purification step between the two steps.

First step PCR was carried out for 18 cycles using the following PCR program: 70° C. 5 min, 18× (94° C. 30 sec, 60° C. 30 sec, 72° C. 1 min) 72° C. 5 min.

PCR products from this step were purified using 0.8× volume of Agencourt Ampure XP (Beckman Coulter).

The purified PCR products were further amplified for 7 cycles using the following PCR program: 7×(94° C. 30 sec, 60° C. 30 sec, 72° C. 1 min) 72° C. 5 min.

This two step PCR was undertaken with the goal of diminishing the potential generation of primer-dimer artifacts.

k.) Purification: The PCR products, amplified stranded cDNA library, were purified using 1× volume of Agencourt Ampure XP (Beckman Coulter) following the manufacturer instruction.

### Example 3

### RNA Strand Retention Efficiency and Transcriptome Sequencing Quality

Strand retention efficiency using the methods provided herein was validated experimentally by assessing the strand bias of sequence reads that map to the coding exons of human mRNAs, 3′-UTR and 5′-UTR regions as well as rRNA. Directional cDNA libraries generated according to the methods and compositions provided herein were generated from 100 ng and 1 ng of total UHR RNA, as described in examples 1 and 2. Single end 40 nucleotide reads were generated using the Illumina Genome Analyzer II. The results of the sequencing data as well as strand retention efficiency summarized in FIG. 9. FIG. 9. showed greater than 95% strand retention and minimal reads generated from rRNA for libraries generated from 100 ng (Sample 1, s4_L2DR14; Sample 2 s4_L2DR15) and 1 ng of total UHR RNA (Sample 3, BC14).

The quality of transcriptome sequencing generated from directional cDNA libraries described in Examples 1 and 2, employing the methods and compositions provided herein, were further demonstrated from the sequencing data. Non biased whole transcriptome sequencing is demonstrated by analysis of 5′- to 3′ representation, as shown for libraries generated from 100 ng (Sample 1, s4_L2DR14; Sample 2 s4_L2DR15; FIG. 7) and 1 ng of total UHR RNA (Sample 3, BC14; FIG. 10). Furthermore, the choice of first strand cDNA primers utilized for the generation of the directional cDNA sequencing libraries described in Examples 1 and 2, leads to generation of libraries with minimal representation of rRNA.

The methods and compositions provided herein afford highly reproducible gene expression profiling employing directional cDNA sequencing libraries from total RNA samples as shown by the correlation of sequencing data, reads per kilobase of transcript per million (RPKM), for the libraries s4_L2DR14 and s4_L2DR15 generated as described in Example 1, as shown in FIG. 8.

### Example 4

### Stranded Library Preparation from Total RNA Isolated from a Single Cell

The process depicted in FIG. 1 is employed for the generation of stranded cDNA sequencing libraries from total RNA isolated from a single cell following a process workflow as in FIG. 3, following isolation of the RNA from a single cell.

a.) A single cell is lysed in a cell lysis buffer.

b.) Synthesis of first strand cDNA comprising dU: 2 μl of First Strand Primer Mix (NuGEN, 0334-32) and 2 μl of H₂O is added to the cell lysate. The mixture is incubated 65° C. for 5 min and cooled on ice. The following mixture is added to the above: 2.5 μl of First Strand Buffer Mix (NuGEN, 0334-32), 0.5 μl of First Strand Enzyme Mix (NuGEN, 0334-32), 0.375 μl of 1 mM dUTP and 0.625 μl of H₂O. First strand cDNA synthesis is carried out at 40° C. for 30 min followed by incubating at 70° C. for 10 min.

b.) Fragmentation of first strand cDNA: 0.5 μl USER Enzyme (New England BioLabs) is added to the first strand cDNA synthesis reaction mixture above and the reaction mixture is incubated at 37° C. for 30 min followed by incubation at 95° C. for 10 min.

c.) RNA Hydrolysis: The RNA input is hydrolyzed by addition of 2 μl 1N NaOH to the cDNA fragmentation reaction mixture above, and incubation of the reaction mixture at 95° C. for 15 min, followed by neutralization of the reaction mixture by the addition of 2 μl 1N HCl to the cooled reaction mixture.

d.) Purification: The fragmented first strand cDNA is purified using ssDNA/RNA Clean & Concentrator (Zymo Research) following the manufacturer instruction and the purified fragmented first strand cDNA is eluted in 10 μl of H₂O.

e.) Conversion of the all fragments of first strand cDNA to dsDNA with appended first adaptor at one end: 10 μl of the purified fragmented and 3′-blocked first strand cDNA is mixed with 1.5 μl of 10×NEBuffer2 (New England BioLabs), 1.5 μl of 2.5 mM dNTPs, 0.5 μl of 10 μM First adaptor (33 bp dsDNA with 8-base 3′ overhang of random sequences) hybridizable to the blocked 3′-end of the fragmented first strand cDNA and 1 μl of H₂O. The mixture is incubated at 65° C. for 5 min, and cooled on ice. Extension of the hybridized first adaptor along the first strand cDNA fragments is carried out by the addition of 0.5 μl Bsu DNA Polymerase, (Large Fragment New England BioLabs) and incubating the reaction mixture at 25° C. for 15 min, 37° C. for 15 min, followed by 70° C. for 10 min.

f.) Polishing DNA Ends: The above reaction mixture is combined with 0.5 μl T4 DNA Polymerase (Enzymatics) and the reaction mixture is incubated at 25° C. for 30 min, followed by 70° C. for 10 min g.) Ligation of Second Adaptor to the blunt end of the ds cDNA produced as above: The ligation is carried out by the addition of the following to the above reaction mixture: 6 μl of 5× Quick Ligation Buffer (New England BioLabs), 2.5 μl of 20 μM Second Adaptor, 1.5 μl of Quick Ligase (New England BioLabs), and 5 μl of H₂O. The reaction mixture is incubated at 25° C. for 30 min, followed by 70° C. for 10 min.

h.) Purification: The ligation products, dsDNA with first adaptor appended at one end, and second adaptor at the other end, is purified using 0.8 volume of Agencourt Ampure XP (Beckman Coulter), and eluted in 25 μl.

i.) PCR Amplification: The library of stranded cDNA products with appended first and second adaptors prepared as described above, is PCR amplified with primers comprising sequences specific to the first and the second adaptor, and barcodes enabling multiplex sequencing, for 17 cycles using the following PCR program: 70° C. 5 min, 17×(94° C. 30 sec, 60° C. 30 sec, 72° C. 1 min) 72° C. 5 min.

j.) Purification: The PCR products, amplified stranded cDNA library, is purified using 1 volume of Agencourt Ampure XP (Beckman Coulter) following the manufacturer instruction.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method for generating a directional cDNA library, the method comprising:
a) annealing one or more primers to a template RNA;
b) extending the one or more primers in the presence of a reaction mixture comprising dATP, dCTP, dGTP, dTTP, and dUTP, wherein the reaction mixture comprises a ratio of dUTP to dTTP, wherein the ratio permits incorporation of dUTP at a desired density, thereby generating a one or more first strand complementary DNAs (cDNAs) comprising dUTP incorporated at a desired density;
c) selectively cleaving the one or more first strand cDNAs comprising dUTPs incorporated at a desired density with uracil-N-glycosylase (UNG) and an agent capable of cleaving a phosphodiester backbone at an abasic site created by the UNG, wherein the cleaving generates a plurality of first strand cDNA fragments of a desired size comprising a blocked 3′ end;
d) annealing a first adapter comprising a partial duplex and a 3′ overhang to a 3′ end of one or more of the plurality of first strand cDNA fragments comprising a blocked 3′ end, wherein the first adapter comprises a sequence A, and wherein the annealing comprises hybridizing a random sequence at the 3′ overhang to a complementary sequence present at the 3′ end of the one or more of the plurality of first strand cDNA fragments comprising a blocked 3′ end;
e) extending the 3′ overhang hybridized to the complementary sequence with a DNA polymerase, wherein one or more double stranded cDNA fragments comprising the sequence A at one end is generated;
f) ligating a second adapter comprising a sequence B to the one or more double stranded cDNA fragments comprising the sequence A at one end, wherein the ligating generates one or more double stranded cDNA fragments comprising the sequence A at one end and the sequence B at an opposite end, thereby generating the directional polynucleotide library; and
g) optionally, amplifying and/or sequencing the directional cDNA library.

2. (canceled)

3. A method for generating a directional cDNA library, the method comprising:
a) treating a template dsDNA with a nicking enzyme, wherein the treating generates one or more breaks in a phosphodiester backbone of one strand of the template dsDNA, wherein the break produces one or more 3′ hydroxyls in the one strand;
b) extending the one or more 3′ hydroxyls, wherein the extending is performed in the presence of a reaction mixture comprising dATP, dCTP, dGTP, dTTP, and dUTP, wherein the reaction mixture comprises a ratio of dUTP to dTTP, wherein the ratio permits incorporation of dUTP at a desired density, thereby generating one or more first strand complementary DNAs (cDNAs) comprising dUTP incorporated at a desired density;
c) selectively cleaving the one or more first strand cDNAs comprising dUTPs incorporated at a desired density with uracil-N-glycosylase (UNG) and an agent capable of cleaving a phosphodiester backbone at an abasic site created by the UNG, wherein the cleaving generates a plurality of first strand cDNA fragments of a desired size comprising a blocked 3′ end;
d) annealing a first adapter comprising a partial duplex and a 3′ overhang to a 3′ end of one or more of the plurality of first strand cDNA fragments comprising a blocked 3′ end, wherein the first adapter comprises a sequence A, and wherein the annealing comprises hybridizing a random sequence at the 3′ overhang to a complementary sequence present at the 3′ end of the one or more of the plurality of first strand cDNA fragments comprising a blocked 3′ end;
e) extending the 3′ overhang hybridized to the complementary sequence with a DNA polymerase, wherein one or more double stranded cDNA fragments comprising the sequence A at one end is generated;
f) ligating a second adapter comprising a sequence B to the one or more double stranded cDNA fragments comprising the sequence A at one end, wherein the ligating generates one or more double stranded cDNA fragments comprising the sequence A at one end and the sequence B at an opposite end thereby generating a directional cDNA library; and
g) optionally, amplifying and/or sequencing the directional cDNA library.

4. A method for generating a whole genome library, the method comprising:
a) denaturing nicked and/or fragmented dsDNA template nucleic acid;
b) annealing a first adapter comprising a partial duplex and a 3′ overhang to a 3′ end of one or more of the plurality of single-stranded DNA fragments, wherein the first adapter comprises a sequence A, and wherein the annealing comprises hybridizing a random sequence at the 3′ overhang to a complementary sequence present at the 3′ end of the one or more of the plurality of single-stranded DNA fragments;
c) extending the 3′ overhang hybridized to the complementary sequence with a DNA polymerase, wherein one or more double stranded cDNA fragments comprising the sequence A at one end is generated;
d) ligating a second adapter comprising a sequence B to the one or more double stranded cDNA fragments comprising the sequence A at one end, wherein the ligating generates one or more double stranded cDNA fragments comprising the sequence A at one end and the sequence B at an opposite end thereby generating a directional cDNA library; and
e) optionally, amplifying and/or sequencing the directional cDNA library.

5. The method of claim 1, wherein the one or more primers comprise a random primer.

6. (canceled)

7. The method of claim 1, wherein the one or more primers comprise a sequence specific to a group of RNAs comprising substantially all transcripts.

8. The method of claim 1, wherein the one or more primers comprise a sequence specific to a group of RNAs which does not comprise structural RNA, wherein the structural RNA comprises ribosomal RNA (rRNA).

9. The method of claim 1, wherein the agent capable of cleaving a phosphodiester backbone comprises an enzyme, chemical agent, and/or heat.

10. The method of claim 9, wherein the chemical agent is a polyamine.

11. The method of claim 10, wherein the polyamine is N,N-dimethylethylenediamine (DMED).

12. (canceled)

13. (canceled)

14. The method of claim 1 or 3, wherein the first adaptor comprises a long strand and a short strand, wherein the long strand comprises the sequence A that forms a duplex with the short strand and a 3′ overhang.

15. (canceled)

16. The method of claim 3, wherein the first adapter comprises a plurality of first adapters, wherein the random sequence on each of the plurality of first adapters is different than the random sequence on another of the plurality of first adapters, and wherein each of the plurality of first adapters comprises the sequence A.

17. (canceled)

18. The method of claim 3, wherein the first adapter further comprises a stem loop, wherein the stem loop links a 5′ end of a long strand of the partial duplex with a 3′ end of a short strand of the partial duplex, and wherein the long strand comprises the sequence A and the 3′ overhang.

19. (canceled)

20. (canceled)

21. The method of claim 1 or 3, wherein the 3′ overhang comprises at least 6, 7, 8, or 9 nucleotides.

22. The method of claim 3, wherein the second adapter comprises a partial duplex, wherein the partial duplex comprises a long strand hybridized to a short strand, wherein the long strand comprises the sequence B and an overhang.

23. The method of claim 22, wherein the long strand comprises the sequence B and a 3′ overhang, and wherein the short strand comprises a block at a 3′ end.

24. The method of claim 23, wherein the ligating generates the one or more double stranded cDNA fragments comprising the sequence A at one end and the sequence B at an opposite end, wherein the sequence A is at a 5′ end on one end and the sequence B is at a 3′ end on the opposite end.

25. The method of claim 22, wherein the long strand comprises the sequence B and a 5′ overhang, and wherein the short strand comprises a block at a 5′ end.

26. The method of claim 25, wherein the ligating generates the one or more double stranded cDNA fragments comprising the sequence A at one end and the sequence B at an opposite end, wherein the sequence A is at a 5′ end on one end and the sequence B is at a 5′ end on the opposite end.

27. The method of claim 26, wherein a 3′ end of the opposite end is extended using the sequence B as a template, thereby generating one or more double stranded cDNA fragments comprising the sequence A at a 5′ end on one end and a sequence complementary to the sequence B, B′, at a 3′ end on the opposite end.

28.-35. (canceled)

36. The method of claim 1, further comprising degrading the template RNA following step b).

37. (canceled)

38. The method of claim 3, wherein the nicking enzyme comprises a strand specific nicking enzyme.

39. The method of claim 3, wherein the extending the one or more 3′ hydroxyls in step b) is performed with a DNA polymerase comprising strand displacement activity.

40. The method of claim 3, wherein the ligating comprises blunt end ligation, wherein the one or more double stranded cDNA fragments comprising the sequence A at one end generated in step e) are end repaired prior to step f).

41. The method of claim 3, wherein the first and/or second adapter further comprises one or more barcodes.


SEQUENCE LISTING (163 sequences)

SEQ ID NO: 1 - DNA, 63 bp, Artificial Sequence
  Description of Artificial Sequence Synthetic primer
aagcagaagacggcatacgagatgaggtggctgctgtctttccctcgttttctcaagcgacac

SEQ ID NO: 2 - DNA, 63 bp, Artificial Sequence
  Description of Artificial Sequence Synthetic primer
aagcagaagacggcatacgagatgaggtggtgatcggagtgcagaatcgtggacttctagtct

SEQ ID NO: 3 - DNA, 63 bp, Artificial Sequence
  Description of Artificial Sequence Synthetic primer
aagcagaagacggcatacgagatgaggtggcccaatgcgttctatatgcgtctcagctgcggc

SEQ ID NO: 4 - DNA, 63 bp, Artificial Sequence
  Description of Artificial Sequence Synthetic primer
aagcagaagacggcatacgagatgaggtggcttgcgtgcacgagaagcatcgcctctcgaagc

SEQ ID NO: 5 - DNA, 63 bp, Artificial Sequence
  Description of Artificial Sequence Synthetic primer
aagcagaagacggcatacgagatgaggtggtgactggagttcagacgtgtgctcttccgatct

SEQ ID NO: 6 - DNA, 63 bp, Artificial Sequence
  Description of Artificial Sequence Synthetic primer
aagcagaagacggcatacgagatgaggtggttagcactcggccgcaattctgagtaatctggc

SEQ ID NO: 7 - DNA, 63 bp, Artificial Sequence
  Description of Artificial Sequence Synthetic primer
aagcagaagacggcatacgagatgaggtggggcctgtcgcggtccgagcgataagcacgatct

SEQ ID NO: 8 - DNA, 66 bp, Artificial Sequence
  Description of Artificial Sequence Synthetic primer
aagcagaagacggcatacgagatgaggtggtgactgctcattgtgcatgtggagcgattacccagt

SEQ ID NO: 9 - DNA, 66 bp, Artificial Sequence
  Description of Artificial Sequence Synthetic primer
aagcagaagacggcatacgagatgaggtgggcttgactggagatgcgtaaagcttgacgacgatct

SEQ ID NO: 10 - DNA, 69 bp, Artificial Sequence
  Description of Artificial Sequence Synthetic primer
aagcagaagacggcatacgagatgaggtggtgatgatacccgattcgcacctgcgaaacgtgttctatg

SEQ ID NO: 11 - DNA, 72 bp, Artificial Sequence
  Description of Artificial Sequence Synthetic primer
aagcagaagacggcatacgagatgaggtggacttcatacgcaattcgaatctacgccacgtgttctttgcga

SEQ ID NO: 12 - DNA, 66 bp, Artificial Sequence
  Description of Artificial Sequence Synthetic primer
aagcagaagacggcatacgagatgaggtggtacgcaattcgaatctacgccacgtgttctttgcga

SEQ ID NO: 13 - DNA, 69 bp, Artificial Sequence
  Description of Artificial Sequence Synthetic primer
aagcagaagacggcatacgagatgaggtgggcttgactactggagatgcgtaaagcttgacgacgatct

SEQ ID NO: 14 - DNA, 69 bp, Artificial Sequence
  Description of Artificial Sequence Synthetic primer
aagcagaagacggcatacgagatgaggtggcttgcgtgcacgagattcagcatcgcctctcgaggaagc

SEQ ID NO: 15 - DNA, 66 bp, Artificial Sequence
  Description of Artificial Sequence Synthetic primer
aagcagaagacggcatacgagatgaggtggctgctgtctttccctcgttttctcaagtttgcgcac

SEQ ID NO: 16 - DNA, 66 bp, Artificial Sequence
  Description of Artificial Sequence Synthetic primer
aagcagaagacggcatacgagatgaggtggtgatcgtcttgcagaatcgtggacagctagtctgct

SEQ ID NO: 17 - DNA, 63 bp, Artificial Sequence
  Description of Artificial Sequence Synthetic primer
aagcagaagacggcatacgagatgaggtggagataccgacgcgatgaagcacgttgcaccctt

SEQ ID NO: 18 - DNA, 66 bp, Artificial Sequence
  Description of Artificial Sequence Synthetic primer
aagcagaagacggcatacgagatgaggtggtcggatgagcgaagttgcaatcccgaactttcatgc

SEQ ID NO: 19 - DNA, 63 bp, Artificial Sequence
  Description of Artificial Sequence Synthetic primer
aagcagaagacggcatacgagatgaggtggagatcggaattccacacgtctgaataacagtca

SEQ ID NO: 20 - DNA, 66 bp, Artificial Sequence
  Description of Artificial Sequence Synthetic primer
aagcagaagacggcatacgagatgaggtgggccgcagctgagacgcatatagaacgcattgggcga

SEQ ID NO: 21 - DNA, 63 bp, Artificial Sequence; identical to SEQ ID NO: 1
  Description of Artificial Sequence Synthetic primer

SEQ ID NO: 22 - DNA, 63 bp, Artificial Sequence; identical to SEQ ID NO: 2
  Description of Artificial Sequence Synthetic primer

SEQ ID NO: 23 - DNA, 63 bp, Artificial Sequence; identical to SEQ ID NO: 3
  Description of Artificial Sequence Synthetic primer

SEQ ID NO: 24 - DNA, 63 bp, Artificial Sequence; identical to SEQ ID NO: 4
  Description of Artificial Sequence Synthetic primer

SEQ ID NO: 25 - DNA, 63 bp, Artificial Sequence; identical to SEQ ID NO: 5
  Description of Artificial Sequence Synthetic primer

SEQ ID NO: 26 - DNA, 63 bp, Artificial Sequence; identical to SEQ ID NO: 6
  Description of Artificial Sequence Synthetic primer

SEQ ID NO: 27 - DNA, 63 bp, Artificial Sequence; identical to SEQ ID NO: 7
  Description of Artificial Sequence Synthetic primer

SEQ ID NO: 28 - DNA, 66 bp, Artificial Sequence; identical to SEQ ID NO: 8
  Description of Artificial Sequence Synthetic primer

SEQ ID NO: 29 - DNA, 66 bp, Artificial Sequence; identical to SEQ ID NO: 9
  Description of Artificial Sequence Synthetic primer

SEQ ID NO: 30 - DNA, 69 bp, Artificial Sequence; identical to SEQ ID NO: 10
  Description of Artificial Sequence Synthetic primer

SEQ ID NO: 31 - DNA, 72 bp, Artificial Sequence; identical to SEQ ID NO: 11
  Description of Artificial Sequence Synthetic primer

SEQ ID NO: 32 - DNA, 66 bp, Artificial Sequence; identical to SEQ ID NO: 12
  Description of Artificial Sequence Synthetic primer

SEQ ID NO: 33 - DNA, 69 bp, Artificial Sequence; identical to SEQ ID NO: 13
  Description of Artificial Sequence Synthetic primer

SEQ ID NO: 34 - DNA, 69 bp, Artificial Sequence; identical to SEQ ID NO: 14
  Description of Artificial Sequence Synthetic primer

SEQ ID NO: 35 - DNA, 66 bp, Artificial Sequence; identical to SEQ ID NO: 15
  Description of Artificial Sequence Synthetic primer

SEQ ID NO: 36 - DNA, 66 bp, Artificial Sequence; identical to SEQ ID NO: 16
  Description of Artificial Sequence Synthetic primer

SEQ ID NO: 37 - DNA, 63 bp, Artificial Sequence; identical to SEQ ID NO: 17
  Description of Artificial Sequence Synthetic primer

SEQ ID NO: 38 - DNA, 66 bp, Artificial Sequence; identical to SEQ ID NO: 18
  Description of Artificial Sequence Synthetic primer

SEQ ID NO: 39 - DNA, 63 bp, Artificial Sequence; identical to SEQ ID NO: 19
  Description of Artificial Sequence Synthetic primer

SEQ ID NO: 40 - DNA, 66 bp, Artificial Sequence; identical to SEQ ID NO: 20
  Description of Artificial Sequence Synthetic primer

SEQ ID NO: 41 - DNA, 56 bp, Artificial Sequence
  Description of Artificial Sequence Synthetic primer
aatctgacgataaccgatgagtcatactcgcttggactatacgactgccttgttca

SEQ ID NO: 42 - DNA, 56 bp, Artificial Sequence; identical to SEQ ID NO: 41
  Description of Artificial Sequence Synthetic primer

SEQ ID NO: 43 - DNA, 56 bp, Artificial Sequence
  Description of Artificial Sequence Synthetic primer
ttcgcattacgtctcgcatcttacgatggagatcgtgctgctctggatactggcga

SEQ ID NO: 44 - DNA, 50 bp, Artificial Sequence
  Description of Artificial Sequence Synthetic primer
aatgattcccgttgctcaatgggaaggcttctacacgactgcgaccgccg

SEQ ID NO: 45 - DNA, 59 bp, Artificial Sequence
  Description of Artificial Sequence Synthetic primer
gctactcagacggcgacctgcgctttgtgctctcgaagccgtcacgaccgagtggccca

SEQ ID NO: 46 - DNA, 62 bp, Artificial Sequence
  Description of Artificial Sequence Synthetic primer
cctgatccagcgagctcattggagatctacactctgtatgttggcattgacccagactcctt

SEQ ID NO: 47 - DNA, 56 bp, Artificial Sequence
  Description of Artificial Sequence Synthetic primer
aatgatacggcgaccaccgagatctacactctttccctacacgacgctcttccgat

SEQ ID NO: 48 - DNA, 59 bp, Artificial Sequence
  Description of Artificial Sequence Synthetic primer
aatccaacggcggctggtgagatctacactgaaggaatgctacacgacgttagaccctt

SEQ ID NO: 49 - DNA, 56 bp, Artificial Sequence
  Description of Artificial Sequence Synthetic primer
tcggacacgacgactagcgtcatgtgctctcattccctacacgaccatctgcactt

SEQ ID NO: 50 - DNA, 56 bp, Artificial Sequence
  Description of Artificial Sequence Synthetic primer
aatgatacatcgacctacgagatctactgtgacgctccactcgacgtcgtagctta

SEQ ID NO: 51 - DNA, 56 bp, Artificial Sequence
  Description of Artificial Sequence Synthetic primer
tttgatacgacctcagtggagatctacactctttccctagatgacgctgaaactag

SEQ ID NO: 52 - DNA, 56 bp, Artificial Sequence
  Description of Artificial Sequence Synthetic primer
attgtgacgataacggatgtgtcatactcgctttgcctaatcgacacgcttcttga

SEQ ID NO: 53 - DNA, 59 bp, Artificial Sequence
  Description of Artificial Sequence Synthetic primer
aatctgacgataaccgatgagtcatactcgcttggactatacgactgcgaacttgttca

SEQ ID NO: 54 - DNA, 62 bp, Artificial Sequence
  Description of Artificial Sequence Synthetic primer
tttgatacgacctcagtggagatctacactctttccctagatgacgcttctcgagaaactag

SEQ ID NO: 55 - DNA, 60 bp, Artificial Sequence
  Description of Artificial Sequence Synthetic primer
aatgatacgtttgcgaccaccgagatctacactctttccctacacgacagagttccgatc

SEQ ID NO: 56 - DNA, 57 bp, Artificial Sequence
  Description of Artificial Sequence Synthetic primer
tcggacacgacgactagcgtcatgtgctctcattccctacacgactgtctgcagcat

SEQ ID NO: 57 - DNA, 52 bp, Artificial Sequence
  Description of Artificial Sequence Synthetic primer
aaggtttcccgttgctcgatggcaaggcatgtactcgaccgtgacggtccgg

SEQ ID NO: 58 - DNA, 58 bp, Artificial Sequence
  Description of Artificial Sequence Synthetic primer
tcgttcacgacgactagcctcatgtgctctctttgcctacgtctcgaactgtaggtag

SEQ ID NO: 59 - DNA, 58 bp, Artificial Sequence
  Description of Artificial Sequence Synthetic primer
tcgttcacgacgactagcctcatgtgctctctttgcctacgtctcgtcgtcttcctct

SEQ ID NO: 60 - DNA, 57 bp, Artificial Sequence
  Description of Artificial Sequence Synthetic primer
taccttacgccgaccaccgactactagactgtatgcctacacgactcagatgaagtt

SEQ ID NO: 61 - DNA, 56 bp, Artificial Sequence
  Description of Artificial Sequence Synthetic primer
tgaacaaggcagtcgtatagtccaagcgagtatgactcatcggttatcgtcagatt

SEQ ID NO: 62 - DNA, 56 bp, Artificial Sequence; identical to SEQ ID NO: 61
  Description of Artificial Sequence Synthetic primer

SEQ ID NO: 63 - DNA, 56 bp, Artificial Sequence
  Description of Artificial Sequence Synthetic primer
tcgccagtatccagagcagcacgatctccatcgtaagatgcgagacgtaatgcgaa

SEQ ID NO: 64 - DNA, 50 bp, Artificial Sequence
  Description of Artificial Sequence Synthetic primer
cggcggtcgcagtcgtgtagaagccttcccattgagcaacgggaatcatt

SEQ ID NO: 65 - DNA, 59 bp, Artificial Sequence
  Description of Artificial Sequence Synthetic primer
tgggccactcggtcgtgacggcttcgagagcacaaagcgcaggtcgccgtctgagtagc

SEQ ID NO: 66 - DNA, 62 bp, Artificial Sequence
  Description of Artificial Sequence Synthetic primer
aaggagtctgggtcaatgccaacatacagagtgtagatctccaatgagctcgctggatcagg

SEQ ID NO: 67 - DNA, 56 bp, Artificial Sequence
  Description of Artificial Sequence Synthetic primer
atcggaagagcgtcgtgtagggaaagagtgtagatctcggtggtcgccgtatcatt

SEQ ID NO: 68 - DNA, 59 bp, Artificial Sequence
  Description of Artificial Sequence Synthetic primer
aagggtctaacgtcgtgtagcattccttcagtgtagatctcaccagccgccgttggatt

SEQ ID NO: 69 - DNA, 56 bp, Artificial Sequence
  Description of Artificial Sequence Synthetic primer
aagtgcagatggtcgtgtagggaatgagagcacatgacgctagtcgtcgtgtccga

SEQ ID NO: 70 - DNA, 56 bp, Artificial Sequence
  Description of Artificial Sequence Synthetic primer
taagctacgacgtcgagtggagcgtcacagtagatctcgtaggtcgatgtatcatt

SEQ ID NO: 71 - DNA, 56 bp, Artificial Sequence
  Description of Artificial Sequence Synthetic primer
ctagtttcagcgtcatctagggaaagagtgtagatctccactgaggtcgtatcaaa

SEQ ID NO: 72 - DNA, 56 bp, Artificial Sequence
  Description of Artificial Sequence Synthetic primer
tcaagaagcgtgtcgattaggcaaagcgagtatgacacatccgttatcgtcacaat

SEQ ID NO: 73 - DNA, 59 bp, Artificial Sequence
  Description of Artificial Sequence Synthetic primer
tgaacaagttcgcagtcgtatagtccaagcgagtatgactcatcggttatcgtcagatt

SEQ ID NO: 74 - DNA, 62 bp, Artificial Sequence
  Description of Artificial Sequence Synthetic primer
ctagtttctcgagaagcgtcatctagggaaagagtgtagatctccactgaggtcgtatcaaa

SEQ ID NO: 75 - DNA, 60 bp, Artificial Sequence
  Description of Artificial Sequence Synthetic primer
gatcggaactctgtcgtgtagggaaagagtgtagatctcggtggtcgcaaacgtatcatt

SEQ ID NO: 76 - DNA, 57 bp, Artificial Sequence
  Description of Artificial Sequence Synthetic primer
atgctgcagacagtcgtgtagggaatgagagcacatgacgctagtcgtcgtgtccga

SEQ ID NO: 77 - DNA, 52 bp, Artificial Sequence
  Description of Artificial Sequence Synthetic primer
ccggaccgtcacggtcgagtacatgccttgccatcgagcaacgggaaacctt

SEQ ID NO: 78 - DNA, 58 bp, Artificial Sequence
  Description of Artificial Sequence Synthetic primer
ctacctacagttcgagacgtaggcaaagagagcacatgaggctagtcgtcgtgaacga

SEQ ID NO: 79 - DNA, 58 bp, Artificial Sequence
  Description of Artificial Sequence Synthetic primer
agaggaagacgacgagacgtaggcaaagagagcacatgaggctagtcgtcgtgaacga

SEQ ID NO: 80 - DNA, 57 bp, Artificial Sequence
  Description of Artificial Sequence Synthetic primer
aacttcatctgagtcgtgtaggcatacagtctagtagtcggtggtcggcgtaaggta

SEQ ID NO: 81 - DNA, 42 bp, Artificial Sequence
  Description of Artificial Sequence Synthetic oligonucleotide
ctgctgtctttccctcgttttctcaagcgacacnnnnnnnnn

SEQ ID NO: 82 - DNA, 39 bp, Artificial Sequence
  Description of Artificial Sequence Synthetic oligonucleotide
tgatcggagtgcagaatcgtggacttctagtctnnnnnn

SEQ ID NO: 83 - DNA, 40 bp, Artificial Sequence
  Description of Artificial Sequence Synthetic oligonucleotide
cccaatgcgttctatatgcgtctcagctgcggcnnnnnnn

SEQ ID NO: 84 - DNA, 41 bp, Artificial Sequence
  Description of Artificial Sequence Synthetic oligonucleotide
cttgcgtgcacgagaagcatcgcctctcgaagcnnnnnnnn

SEQ ID NO: 85 - DNA, 41 bp, Artificial Sequence
  Description of Artificial Sequence Synthetic oligonucleotide
tgactggagttcagacgtgtgctcttccgatctnnnnnnnn

SEQ ID NO: 86 - DNA, 42 bp, Artificial Sequence
  Description of Artificial Sequence Synthetic oligonucleotide
ttagcactcggccgcaattctgagtaatctggcnnnnnnnnn

SEQ ID NO: 87 - DNA, 43 bp, Artificial Sequence
  Description of Artificial Sequence Synthetic oligonucleotide
ggcctgtcgcggtccgagcgataagcacgatctnnnnnnnnnn

SEQ ID NO: 88 - DNA, 44 bp, Artificial Sequence
  Description of Artificial Sequence Synthetic oligonucleotide
tgactgctcattgtgcatgtggagcgattacccagtnnnnnnnn

SEQ ID NO: 89 - DNA, 42 bp, Artificial Sequence
  Description of Artificial Sequence Synthetic oligonucleotide
gcttgactggagatgcgtaaagcttgacgacgatctnnnnnn

SEQ ID NO: 90 - DNA, 47 bp, Artificial Sequence
  Description of Artificial Sequence Synthetic oligonucleotide
tgatgatacccgattcgcacctgcgaaacgtgttctatgnnnnnnnn

SEQ ID NO: 91 - DNA, 50 bp, Artificial Sequence
  Description of Artificial Sequence Synthetic oligonucleotide
acttcatacgcaattcgaatctacgccacgtgttctttgcgannnnnnnn

SEQ ID NO: 92 - DNA, 44 bp, Artificial Sequence
  Description of Artificial Sequence Synthetic oligonucleotide
tacgcaattcgaatctacgccacgtgttctttgcgannnnnnnn

SEQ ID NO: 93 - DNA, 45 bp, Artificial Sequence
  Description of Artificial Sequence Synthetic oligonucleotide
gcttgactactggagatgcgtaaagcttgacgacgatctnnnnnn

SEQ ID NO: 94 - DNA, 47 bp, Artificial Sequence
  Description of Artificial Sequence Synthetic oligonucleotide
cttgcgtgcacgagattcagcatcgcctctcgaggaagcnnnnnnnn

SEQ ID NO: 95 - DNA, 45 bp, Artificial Sequence
  Description of Artificial Sequence Synthetic oligonucleotide
ctgctgtctttccctcgttttctcaagtttgcgcacnnnnnnnnn

SEQ ID NO: 96 - DNA, 42 bp, Artificial Sequence
  Description of Artificial Sequence Synthetic oligonucleotide
tgatcgtcttgcagaatcgtggacagctagtctgctnnnnnn

SEQ ID NO: 97 - DNA, 41 bp, Artificial Sequence
  Description of Artificial Sequence Synthetic oligonucleotide
agataccgacgcgatgaagcacgttgcacccttnnnnnnnn

SEQ ID NO: 98 - DNA, 42 bp, Artificial Sequence
  Description of Artificial Sequence Synthetic oligonucleotide
tcggatgagcgaagttgcaatcccgaactttcatgcnnnnnn

SEQ ID NO: 99 - DNA, 40 bp, Artificial Sequence
  Description of Artificial Sequence Synthetic oligonucleotide
agatcggaattccacacgtctgaataacagtcannnnnnn

SEQ ID NO: 100 - DNA, 43 bp, Artificial Sequence
  Description of Artificial Sequence Synthetic oligonucleotide
gccgcagctgagacgcatatagaacgcattgggcgannnnnnn

SEQ ID NO: 101 - DNA, 85 bp, Artificial Sequence
  Description of Artificial Sequence Synthetic oligonucleotide
tcgcccaatgcgttctatatgcgtctcagctgcggcattcaagccgcagctgagacgcatatagaacgcattgggcgannnnnnn

SEQ ID NO: 102 - DNA, 86 bp, Artificial Sequence
  Description of Artificial Sequence Synthetic oligonucleotide
actgggtaatcgctccacatgcacaatgagcagtcaattcaatgactgctcattgtgcatgtggagcgattacccagtnnnnnnnn

SEQ ID NO: 103 - DNA, 81 bp, Artificial Sequence
  Description of Artificial Sequence Synthetic oligonucleotide
gtgtcgcttgagaaaacgagggaaagacagcagattcaactgctgtctttccctcgttttctcaagcgacacnnnnnnnnn

SEQ ID NO: 104 - DNA, 33 bp, Artificial Sequence
  Description of Artificial Sequence Synthetic oligonucleotide
gtgtcgcttgagaaaacgagggaaagacagcag

SEQ ID NO: 105 - DNA, 34 bp, Artificial Sequence
  Description of Artificial Sequence Synthetic oligonucleotide
tagactagaagtccacgattctgcactccgatca

SEQ ID NO: 106 - DNA, 33 bp, Artificial Sequence
  Description of Artificial Sequence Synthetic oligonucleotide
gccgcagctgagacgcatatagaacgcattggg

SEQ ID NO: 107 - DNA, 33 bp, Artificial Sequence
  Description of Artificial Sequence Synthetic oligonucleotide
gcttcgagaggcgatgcttctcgtgcacgcaag

SEQ ID NO: 108 - DNA, 33 bp, Artificial Sequence
  Description of Artificial Sequence Synthetic oligonucleotide
agatcggaagagcacacgtctgaactccagtca

SEQ ID NO: 109 - DNA, 33 bp, Artificial Sequence
  Description of Artificial Sequence Synthetic oligonucleotide
gccagattactcagaattgcggccgagtgctaa

SEQ ID NO: 110 - DNA, 36 bp, Artificial Sequence
  Description of Artificial Sequence Synthetic oligonucleotide
actgggtaatcgctccacatgcacaatgagcagtca

SEQ ID NO: 111 - DNA, 36 bp, Artificial Sequence; identical to SEQ ID NO: 110
  Description of Artificial Sequence Synthetic oligonucleotide

SEQ ID NO: 112 - DNA, 36 bp, Artificial Sequence
  Description of Artificial Sequence Synthetic oligonucleotide
agatcgtcgtcaagctttagccatctccagtcaagc

SEQ ID NO: 113 - DNA, 39 bp, Artificial Sequence
  Description of Artificial Sequence Synthetic oligonucleotide
catagaacacgtttcgcaggtgcgaatcgggtatcatca

SEQ ID NO: 114 - DNA, 42 bp, Artificial Sequence
  Description of Artificial Sequence Synthetic oligonucleotide
tcgcaaagaacacgtggcgtagattcgaattgcgtatgaagt

SEQ ID NO: 115 - DNA, 36 bp, Artificial Sequence
  Description of Artificial Sequence Synthetic oligonucleotide
tcgcaaagaacacgtggcgtagattcgaattgcgta

SEQ ID NO: 116 - DNA, 39 bp, Artificial Sequence
  Description of Artificial Sequence Synthetic oligonucleotide
agatcgtcgtcaagctttagccatctccagtagtcaagc

SEQ ID NO: 117 - DNA, 39 bp, Artificial Sequence
  Description of Artificial Sequence Synthetic oligonucleotide
gcttcctcgagaggcgatgctgaatctcgtgcacgcaag

SEQ ID NO: 118 - DNA, 36 bp, Artificial Sequence
  Description of Artificial Sequence Synthetic oligonucleotide
gtgcgcaaacttgagaaaacgagggaaagacagcag

SEQ ID NO: 119 - DNA, 37 bp, Artificial Sequence
  Description of Artificial Sequence Synthetic oligonucleotide
tagcagactagctgtccacgattctgcaagacgatca

SEQ ID NO: 120 - DNA, 33 bp, Artificial Sequence
  Description of Artificial Sequence Synthetic oligonucleotide
aagggtgcaacgtgcttcatcgcgtcggtatct

SEQ ID NO: 121 - DNA, 36 bp, Artificial Sequence
  Description of Artificial Sequence Synthetic oligonucleotide
gcatgaaagttcgggattgcaacttcgctcatccga

SEQ ID NO: 122 - DNA, 33 bp, Artificial Sequence
  Description of Artificial Sequence Synthetic oligonucleotide
tgactgttattcagacgtgtggaattccgatct

SEQ ID NO: 123 - DNA, 36 bp, Artificial Sequence
  Description of Artificial Sequence Synthetic oligonucleotide
tcgcccaatgcgttctatatgcgtctcagctgcggc

SEQ ID NO: 124 - DNA, 58 bp, Artificial Sequence
  Description of Artificial Sequence Synthetic oligonucleotide
aatctgacgataaccgatgagtcatactcgcttggactatacgactgccttgttcagt

SEQ ID NO: 125 - DNA, 58 bp, Artificial Sequence; identical to SEQ ID NO: 124
  Description of Artificial Sequence Synthetic oligonucleotide

SEQ ID NO: 126 - DNA, 58 bp, Artificial Sequence
  Description of Artificial Sequence Synthetic oligonucleotide
ttcgcattacgtctcgcatcttacgatggagatcgtgctgctctggatactggcgaac

SEQ ID NO: 127 - DNA, 52 bp, Artificial Sequence
  Description of Artificial Sequence Synthetic oligonucleotide
aatgattcccgttgctcaatgggaaggcttctacacgactgcgaccgccgga

SEQ ID NO: 128 - DNA, 62 bp, Artificial Sequence
  Description of Artificial Sequence Synthetic oligonucleotide
gctactcagacggcgacctgcgctttgtgctctcgaagccgtcacgaccgagtggcccagtc

SEQ ID NO: 129 - DNA, 64 bp, Artificial Sequence
  Description of Artificial Sequence Synthetic oligonucleotide
cctgatccagcgagctcattggagatctacactctgtatgttggcattgacccagactccttga

SEQ ID NO: 130 - DNA, 58 bp, Artificial Sequence
  Description of Artificial Sequence Synthetic oligonucleotide
aatgatacggcgaccaccgagatctacactctttccctacacgacgctcttccgatct

SEQ ID NO: 131 - DNA, 61 bp, Artificial Sequence
  Description of Artificial Sequence Synthetic oligonucleotide
aatccaacggcggctggtgagatctacactgaaggaatgctacacgacgttagacccttga

SEQ ID NO: 132 - DNA, 58 bp, Artificial Sequence
  Description of Artificial Sequence Synthetic oligonucleotide
tcggacacgacgactagcgtcatgtgctctcattccctacacgaccatctgcacttgt

SEQ ID NO: 133 - DNA, 58 bp, Artificial Sequence
  Description of Artificial Sequence Synthetic oligonucleotide
aatgatacatcgacctacgagatctactgtgacgctccactcgacgtcgtagcttagt

SEQ ID NO: 134 - DNA, 58 bp, Artificial Sequence
  Description of Artificial Sequence Synthetic oligonucleotide
tttgatacgacctcagtggagatctacactctttccctagatgacgctgaaactagcg

SEQ ID NO: 135 - DNA, 58 bp, Artificial Sequence
  Description of Artificial Sequence Synthetic oligonucleotide
attgtgacgataacggatgtgtcatactcgctttgcctaatcgacacgcttcttgatg

SEQ ID NO: 136 - DNA, 61 bp, Artificial Sequence
  Description of Artificial Sequence Synthetic oligonucleotide
aatctgacgataaccgatgagtcatactcgcttggactatacgactgcgaacttgttcagt

SEQ ID NO: 137 - DNA, 64 bp, Artificial Sequence
  Description of Artificial Sequence Synthetic oligonucleotide
tttgatacgacctcagtggagatctacactctttccctagatgacgcttctcgagaaactagcg

SEQ ID NO: 138 - DNA, 62 bp, Artificial Sequence
  Description of Artificial Sequence Synthetic oligonucleotide
aatgatacgtttgcgaccaccgagatctacactctttccctacacgacagagttccgatcta

SEQ ID NO: 139 - DNA, 59 bp, Artificial Sequence
  Description of Artificial Sequence Synthetic oligonucleotide
tcggacacgacgactagcgtcatgtgctctcattccctacacgactgtctgcagcatga

SEQ ID NO: 140 - DNA, 54 bp, Artificial Sequence
  Description of Artificial Sequence Synthetic oligonucleotide
aaggtttcccgttgctcgatggcaaggcatgtactcgaccgtgacggtccggag

SEQ ID NO: 141 - DNA, 60 bp, Artificial Sequence
  Description of Artificial Sequence Synthetic oligonucleotide
tcgttcacgacgactagcctcatgtgctctctttgcctacgtctcgaactgtaggtagta

SEQ ID NO: 142 - DNA, 60 bp, Artificial Sequence
  Description of Artificial Sequence Synthetic oligonucleotide
tcgttcacgacgactagcctcatgtgctctctttgcctacgtctcgtcgtcttcctctcg

SEQ ID NO: 143 - DNA, 59 bp, Artificial Sequence
  Description of Artificial Sequence Synthetic oligonucleotide
taccttacgccgaccaccgactactagactgtatgcctacacgactcagatgaagttgt

SEQ ID NO: 144 - DNA, 13 bp, Artificial Sequence
  Description of Artificial Sequence Synthetic oligonucleotide
agtgcatcctagc

SEQ ID NO: 145 - DNA, 13 bp, Artificial Sequence
  Description of Artificial Sequence Synthetic oligonucleotide
actgaacaaggca

SEQ ID NO: 146 - DNA, 13 bp, Artificial Sequence
  Description of Artificial Sequence Synthetic oligonucleotide
gttcgccagtatc

SEQ ID NO: 147 - DNA, 13 bp, Artificial Sequence
  Description of Artificial Sequence Synthetic oligonucleotide
tccggcggtcgca

SEQ ID NO: 148 - DNA, 14 bp, Artificial Sequence
  Description of Artificial Sequence Synthetic oligonucleotide
gactgggccactcg

SEQ ID NO: 149 - DNA, 13 bp, Artificial Sequence
  Description of Artificial Sequence Synthetic oligonucleotide
tcaaggagtctgg

SEQ ID NO: 150 - DNA, 13 bp, Artificial Sequence
  Description of Artificial Sequence Synthetic oligonucleotide
agatcggaagagc

SEQ ID NO: 151 - DNA, 13 bp, Artificial Sequence
  Description of Artificial Sequence Synthetic oligonucleotide
tcaagggtctaac

SEQ ID NO: 152 - DNA, 13 bp, Artificial Sequence
  Description of Artificial Sequence Synthetic oligonucleotide
acaagtgcagatg

SEQ ID NO: 153 - DNA, 12 bp, Artificial Sequence
  Description of Artificial Sequence Synthetic oligonucleotide
ataagctacgac

SEQ ID NO: 154 - DNA, 13 bp, Artificial Sequence
  Description of Artificial Sequence Synthetic oligonucleotide
cgctagtttcagc

SEQ ID NO: 155 - DNA, 13 bp, Artificial Sequence
  Description of Artificial Sequence Synthetic oligonucleotide
catcaagaagcgt

SEQ ID NO: 156 - DNA, 16 bp, Artificial Sequence
  Description of Artificial Sequence Synthetic oligonucleotide
actgaacaagttcgca

SEQ ID NO: 157 - DNA, 19 bp, Artificial Sequence
  Description of Artificial Sequence Synthetic oligonucleotide
cgctagtttctcgagaagc

SEQ ID NO: 158 - DNA, 14 bp, Artificial Sequence
  Description of Artificial Sequence Synthetic oligonucleotide
tagatcggaactct

SEQ ID NO: 159 - DNA, 14 bp, Artificial Sequence
  Description of Artificial Sequence Synthetic oligonucleotide
tcatgctgcagaca

SEQ ID NO: 160 - DNA, 15 bp, Artificial Sequence
  Description of Artificial Sequence Synthetic oligonucleotide
ctccggaccgtcacg

SEQ ID NO: 161 - DNA, 15 bp, Artificial Sequence
  Description of Artificial Sequence Synthetic oligonucleotide
tactacctacagttc

SEQ ID NO: 162 - DNA, 15 bp, Artificial Sequence
  Description of Artificial Sequence Synthetic oligonucleotide
cgagaggaagacgac

SEQ ID NO: 163 - DNA, 14 bp, Artificial Sequence
  Description of Artificial Sequence Synthetic oligonucleotide
acaacttcatctga